(19) United States
(12) Patent Application Publication
(10) Pub. No.: US 2024/0285002 A1
(43) Pub. Date: Aug. 29, 2024

(54) SUPER M.E.N.

(71) Applicant: Dr. NakaMats Innovation Institute, Setagaya-ku, Tokyo (JP)

(72) Inventor: Sir Dr. Yoshiro NakaMats, Setagaya-ku, Tokyo (JP)

(21) Appl. No.: 17/798,404

(22) PCT Filed: Feb. 5, 2021
(86) PCT No.: PCT/JP2021/004467

§ 371 Date: Jan. 5, 2023

(30) Foreign Application Priority Data
Feb. 10, 2020 (JP) 2020-021043
Apr. 3, 2020 (JP) 2020-067952
May 13, 2020 (JP) 2020-084436
Jun. 13, 2020 (JP) 2020-102744
Jul. 21, 2020 (JP) 2020-124807
Dec. 31, 2020 (JP) 2020-219968
Feb. 4, 2021 (JP) 2021-016984

(51) Int. Cl. A41D 13/11

(52) U.S. Cl. CPC A41D 13/1192

(57) ABSTRACT

Problem: Masks are particularly needed that provide 100% protection from droplet infection by the novel coronavirus, including the eyes, and must enable clear speech, must not fog up transparent sheets or eyeglasses, must be able to be used by women without removing their makeup, and must be able to be worn for long periods of time.

Means of Solving the Problems: The invention is designed to increase rigidity by bending flat transparent sheets to improve temperature and humidity, increase internal temperature and humidity to prevent infiltration by viral particles, completely block viral droplets from contacting the eyes, nose and mouth, exhaust exhaled air to prevent fogging of the transparent sheets and eyeglasses, enable clear conversation, prevent women's makeup from being rubbed off, be able to be put in a pocket, enable eating, and support use as an eye mask. The mask is the world's first so-called face shield and has the best performance and the most applications for the novel coronavirus.

### TECHNICAL FIELD

This invention is an innovative mask that eliminates the defects of known masks for COVID-19, SARS, MERS, influenza, etc. Other reasons are described below.

### BACKGROUND TECHNOLOGY

COVID-19 is currently spreading, causing panic due to the increase in person-to-person transmission. Moreover, since there are no effective treatments for COVID-19, the only measures to combat the spread of this disease are hand washing and the wearing masks.

### SUMMARY OF THE INVENTION

### Problems the Invention Seeks to Resolve

The drawbacks of known masks are (1) the entry of viruses through the eyes. (2) Inability to hold conversations. (3) Fogging of eyeglasses. (4) Since viruses are approximately 0.1 micrometer in size, even non-woven fabrics and cloth masks allow the virus to pass through. (5) Hands come into contact with the face to remove the mask. (6) Lipstick and makeup stick to the mask surfaces which women do not like. (7) Since the mouth is not visible, conversation by lip-reading is not possible. (8) People who are in the habit of touching with their eyes and face with their hands will get the virus. (9) Masks are discarded after a single use, which represents a waste of resources are the total cost is high for long-term use. (10) Wearers experience ear pain when wearing masks for long periods of time. (11) It is troublesome to put on and remove masks from the ears. (12) Since masks are irregularly shaped, they are cumbersome because the mask must extend to fit the face and make contact with the face to be effective. (13) Infants and young children dislike masks because they come into contact with their face. among other defects. Conventional masks have a ventilated structure that allows air to pass through the fibers and non-woven fabrics, so these masks provide up to 70% protection against viruses and bacteria, with 30% of viruses and bacteria passing through the material. In addition, viruses and bacteria can enter through gaps in masks, and there is a risk of viruses and bacteria entering through the nose and mouth. Also, once the viruses or bacteria adhere to the mask, they cannot be removed, so the mask must be discarded and a new mask must be used, or the viruses or bacteria must be removed by boiling, etc. before mask reuse. Moreover, conventional masks do not cover the eyes, and if the new coronavirus or other virus flies into the eyes or if the wearer touches the eyes with their hands, the eyes are connected to the nose and the nose to the throat, so the viruses can enter the throat and reach the lungs, causing pneumonia and possibly death. Also, it is difficult to hold a conversation while wearing a conventional mask. As a result, when doctors talk with patients, they remove their masks, which is disadvantageous because viruses or bacteria can be released into the room. These factors have necessitated the invention of an innovative mask that eliminates the defects of publicly-known masks to replace publicly-known masks with an innovative mask.

### Means of Solving the Problems

This invention is a super mask that can protect not only the mouth and nose, but also the eyes, which cannot be protected by masks of the prior art by eliminating the defects outlined above; this mask is made of an impermeable material that shields 100% of bacteria droplets from patients and has a structure that allows vocalizations from the mouth to be transmitted to the other party. The meaning of the title of the invention “Super Men (M.E.N)” is derived from “men” meaning “face” [in Japanese] and also is an acronym (M.E.N.) standing for “mouth”, “eye”, and “face”, meaning an “excellent mask” that protects the “mouth”, “eyes”, and “nose” from viruses and bacteria. The mask of the claims of this invention claim includes a so-called face shield.

### Effect of the Invention

1. While masks of the prior art consist of woven fabrics that allow viruses to pass through due to respiration, thus blocking only 70% of viruses and bacteria, the present invention is a sheet and is therefore effective in blocking and protecting against 100% of viruses and bacteria.
2. Further, whereas masks of the prior art tend to muffle the wearer's voice when conversing, the present invention has the great effect of enabling completely clear conversation without muffling of the voice. For example, when a doctor talks to a patient, he or she is forced to shift the mask, which may result in a fatal infection. This invention has the effect of being safe and convenient because it allows the wearer to talk while wearing the device.
3. When a user wears eyeglasses, vapor is emitted from the top of masks of the prior art. This vapor comes into contact with cold air, fogging the eyeglasses. For example, nurses and others who wear eyeglasses may wear their masks with their nostrils exposed. viruses and bacteria may enter through the nostrils. This invention is very effective in preventing accidents when the user wears eyeglasses because the eyeglasses do not fog up. Thus, the field of vision remains clear, and accidents do not occur, Moreover, road signs can be clearly seen when driving a car, thus preventing accidents.
4. Furthermore, even if the wearer does not wear eyeglasses, the invention structured to allow the exhaled breath of the wearer's conversation and breathing to flow outward and in downward, so there is no fogging of the field of view of the transparent protective sheet and the effect is a good field of view.
5. Also, while conventional masks are only for single use, this invention can be used many times, more or less indefinitely, because it does not come into direct contact with the mouth, nostrils, or eyes, and thus it does not get dirty and remains clean.
6. Furthermore, the product is thin, lightweight, easily portable, low-cost, and takes up little space when stored and transported.
7. The inventive step of the present invention, which is flat in transport and storage but curved during use to enhance its strength, allows the use of thin, light, and inexpensive materials.
8. Moreover, since the sterilizing or disinfecting solution “NAKAMAGIC Wash” which has been announced by the inventor can be sprayed onto the surface of the device, it is east to destroy and viruses or bacteria adhering to the device, Also, it has the effect of improving the effectiveness of the sterilization procedure. This is something that cannot be done with masks of the prior art.
9. Furthermore, while publicly-known masks have an air permeability rate of 70-85%, the present invention has an air permeability rate of 100%.
10. Also, while facial recognition is difficult with masks of the prior art, the present invention is useful for dialogue and identification because an individual's face is clearly recognizable even when wearing the mask.
11. Conversely, if the transparent sheet is made of transparent material only in the vicinity of the wearer's eyes, the mask is more effective than masks of the prior art in concealing the facial features of the wearer.
12. Furthermore, while symbols and letters cannot be written on masks of the prior art, the present invention allows writing or erasure on the transparent sheet. This has the effect of increasing the utility by indicating the owner's number or conveying other information.
13. In addition to masks of the prior art, masks of the present invention are easier, lighter, less expensive, and less cumbersome than goggles.
14. Compared to publicly-known goggles, the present invention has the advantages of a wider field of view, lighter weight, low cost, and convenient handling.
15. When washing and drying hands with a jet-type hand washer or dryer, viruses and bacteria on the hands can enter the eyes. This phenomenon can be prevented by wearing the present invention.
16. Since the eyes, nose, and mouth are not in contact with the invention, it can be used many times with family and friends, resulting in a low-cost effect.
17. The invention can be rapidly made in emergency situations when embodiment 25 of this invention is used.
18. Embodiments 24 and 25 are small enough to fit in a pocket, convenient for portable storage, and effective for immediate use whenever and wherever needed.
19. Embodiment 26 of the present invention has the effect that it can be implemented very simply by utilizing an existing hat.
20. Masks of the prior art can get lipstick and makeup on them, but this invention has the effect of allowing women to wear it without worry because the device does not come into contact with lipstick or the eyes on the face.
21. The device is thin, so it can be carried in tight places such as under clothing or at the bottom of a bag, and because the device can be rolled up, it can be stored in the corner of a small space, making it effective in protecting against coronaviruses when suddenly taken out in crowded places.
22. The mask can be used many times because it can be cleaned many times, and its cost is lower than that of conventional masks.
23. Anti-fraying tape is wrapped around the end of the elastic band at right angles to its longitudinal direction, effectively preventing the elastic band from fraying.
24. Even if the wearer is in the habit of inadvertently rubbing their eyes without realizing that there is bacteria or viruses on the hands, the invention effectively prevents bacteria and viruses from entering through the eyes.
25. With masks of the prior art, people who are hearing impaired cannot see the mouths and cannot read the lips of mask-wearers, making it impossible for them to converse. This invention is transparent and allows the mouth to be seen, so even hearing-impaired people can converse.
26. In the customer service industry, the masks of the prior art do not convey the wearer's smile to other people which creates an unpleasant feeling. This invention has the effect of making a good impression on customers when service is provided, as the wearer's smile communicates a warm welcome to customers.
27. For the large number of women who have worn this invention, their faces look more beautiful than their faces actually are. This is because the transparent sheet 4 of the invention gathers light and reflects it onto the skin, concealing the woman's coarse skin, and also because the transparent sheet 4 of the invention curves laterally, making the face appear more elongated due to the lens effect. Masks of the prior art do not have these effects.
28. Since the breath accumulates within the transparent sheet 4, even if the outside air is low in temperature, the air layer in front of the transparent sheet 4 plus the face has a low coefficient of thermal conductivity, so it has the effect of making people feel warm even when they are outside in a cold winter or inside a chilly air-conditioned room. Masks of the prior art do not have these effects.
29. LEDs can be placed anywhere on the outside front of the cushion and batteries can be placed anywhere on the inside of the cushion to allow the wearer to pass more safely at night. Reflective tape can be attached to any part of the transparent sheet to improve visibility to oncoming vehicles and to enhance safety.
30. The structure of this invention has the effect of (1) being compact when stored and carried, and (2) being curved when used, thereby reinforcing the structure.
31. Normally, the bottom edge of the transparent sheet would spread out when the cushion is installed, but since an elastic band is provided at the bottom of edge of the wide cushion in this invention, the bottom edge of the transparent sheet does not spread out.
32. Since this invention does not attach to the ears, there is no ear pain.
33. When the invention is worn, the air pressure in the space between the transparent sheet and the face is higher than the exterior air pressure, so viruses, bacteria, etc. cannot enter from the outside.
34. When this invention is worn, the humidity and temperature in the space between the transparent sheet and the face increase, so any viruses or the like that may enter that space will be destroyed.
35. Staples are used to attach the Velcro (registered trademark) and the elastic band so these will not come off even when the invention is repeatedly put on and removed.
36. The end of the elastic band is secured by folding it back, which has the effect of preventing the elastic band from fraying.
37. Cushioning is provided at the bottom of the transparent sheet, and the square shape of the sheet prevents outside air from entering the space between the transparent sheet and the wearer's face.
38. The space between the transparent sheet and the face can destroy coronaviruses when the humidity is above 50% and the temperature is above 22° C.
39. By folding back the sides of the transparent sheet or by reinforcing it with other materials, the strength of the sides thereof is increased and the problem of deformation of the transparent sheet due to wind, etc. is eliminated thereby.
40. When the mask of the present invention is used for infants and toddlers, it has a small transparent sheet, the edges of which are covered with a protective material so that: (1) Even babies can breathe easily; (2) Babies do not dislike wearing the mast because it makes light contact; (3) Since the sheet is transparent, it does not give the child a strange appearance; (4) Children do not resist it because it does not make contact with the nose or mouth; (5) Mothers can clearly hear crying and other sounds that infants make and can respond immediately. (6) Even when the infant is sleeping, the mask effectively protects the infant from from droplets in the air.
41. Injuries can be prevented by rounding the corners of the transparent sheet.
42. Plasma or aluminum tape can be applied to a portion of the transparent sheet to reflect heat emitted from body, further increasing the temperature of the space between the transparent sheet 4 and the face, thus increasing pressure and preventing bacteria and viruses from entering.
43. By holding the transparent sheet with multiple elastic bands, bacteria and viruses can be prevented from entering from the underside and sides of the transparent sheet.
44. Each end of the Velcro (registered trademark) and the elastic band is folded over and secured with a staple driven in the specified direction. In so doing, the Velcro (registered trademark) and elastic band are prevented from detaching when the invention is put on and removed, the tips of the staple will not cause injury to the wearer.
45. By using an oblique elastic band which is adhered to the center of the side of the transparent sheet, the wearer's ears do not experience pain. Moreover, the upper and lower edges of the transparent sheet are evenly curved, thus further inhibiting the entry of viruses and bacteria, and the transparent sheet is less likely to shift.
46. Coating the surface of the 71 staple heads the same color as the Velcro (registered trademark) or elastic band has the effect of making the staples less noticeable and more visually appealing.
47. The device is lightweight and not fatiguing to wear even for long periods of time.
48. Sunlight can enter the space between the wearer's face and the mask, which has the effect of increasing the destruction of coronaviruses.
49. The invention has the effect of improved wearing comfort.
50. The mask is the world's lightest (measured at 17.5 grams).ms in actual measurement)
51. The transparent sheet and the hook and face fastener can be prevented from rubbing against each other and becoming damaged by inserting a sheet with explanatory insert on the transparent sheet.
52. Furthermore, a protective sheet nearly twice the size of the transparent sheet is provided across the front and rear faces of the transparent sheet, which effectively prevents scratches on the front and rear faces of the transparent sheet.
53. When transporting this mask, inserting a reinforcing sheet of the same size as the transparent sheet, in addition to the explanatory insert, has the effect of preventing breakage of the invention when force is applied from outside.
54. A cold element further raises the temperature of the space between the wearer's face and the transparent sheet to increase the temperature and pressure between the transparent sheet so that they are higher than that of the outside air, thus preventing the entry of coronaviruses, etc., while cooling the forehead, thus achieving two objectives at the same time.
55. The ability to adjust the mask to any angle while wearing the transparent sheet is effective in permitting the consumption of food and the use of cups, and other utensils inside the mask while wearing it. Moreover, it is possible to apply lipstick.
55. The invention is effective in completely protecting not only the face but also the head from viral droplets.
56. The transparent sheet covers the ears and is effective in protecting the wearer against droplets landing on the side of the head.
57. The effect is that the large transparent sheet, which also covers the head, can be folded to make it smaller and more portable.
58. When worn, the upper transparent sheet 47 can be raised to protect not only the forehead but also the head from splashes.
59. The transparent sheet is curved and fixed so that the strength of the upper transparent sheet 47 can be increased.
60. Since the surface side of the transparent sheet contaminated with droplets is superimposed and carried, contamination does not adhere to the outside and secondary contamination can be prevented.
61. The mask can be folded when it is removed by holding the elastic strap, which has the effect of preventing contamination from transferring to the hand that is holding the mask.
62. By using a durable folding, heat-reflective material along with PSA tape as the bonding portion of the two transparent sheets, it is possible to use both a booster and a bonding hinge.
63. Since multiple transparent sheets can be layered on top of one other, the transparent sheets will not bend even in strong winds creating when bicycling, etc.
64. When multiple transparent sheets are layered, the temperature between the transparent sheets increases, so does the pressure the pressure, which serves to prevent viruses from entering and destroys those that do enter. It also serves to warm the wearer's face when it is cold outside or indoors in wintertime.
65. By using two layered transparent sheets, even if the front side is contaminated with viruses or bacteria, the rear face of the transparent sheet 47 can be reused, which is effective even when the transparent sheets cannot be sterilized.
66. The effect is that the top and bottom sheets can be turned over and worn.
67. The effect is that the mask can be turned over and worn by people with long or short faces.
68. When wearing the mask after carrying it, the folded transparent sheet can be opened by holding the elastic strap. This has the effect of preventing new coronaviruses and bacteria from again contaminating the hand that is hold in the mask even if droplets have already landed on the surface of the transparent sheet.
69. By stacking two transparent sheets with spacing therebetween, the air layer in the space between the two transparent sheets has a heat-retaining effect, which raises the temperature of the space between the face and the mask and destroys viruses, etc. The pressure also rises, and the pressure difference between the external pressure under and beside the transparent sheets prevents viruses, etc. from entering the mask.
70. Stacking two transparent sheets with a space therebetween has a heat-retaining effect that prevents the release of heat from the air between the face and the transparent sheet.
71. By folding back two transparent sheets and inserting a UV-protective sheet, a light-shielding sheet, a face veil, paper with holes for eyes, an aromatic sheet, etc. into the gap between the two transparent sheets, the wearer can prevent UV rays, prevent IR rays, sleep well, conceal facial roughness, and even relax with a fragrant scent, etc. This serves to make the wearer appear to be a more beautiful woman, replaces facial coverings, and relaxes the wearer with the fragrance of the mask.
72. The two transparent sheets are folded back to form two deflector sheets, which has the effect of making it difficult to see the inside of the mask and shading out light.

73. Effective advertising can also be achieved by displaying advertisements on the head portion of the transparent sheets.

74. By folding back the two transparent sheets, the left and right corners of the bottom edge of the transparent sheet can be strengthened against wind pressure, making it suitable for bicycling or motorcycle-riding.

75. When two transparent sheets are folded back, the doctor can use the mask according to the patient's needs. For COVID-19 patients, the transparent sheet for the face is attached to the face, and for general patients, the transparent sheet for the face is lifted to the top.

76. When two transparent sheets are folded back and attached, a binding tape can be used as an identification marker, which has the effect of improving visibility from vehicles, and visibility can be further enhanced through the use of reflective material on the back of the binding tape.

77. When two transparent sheets are joined together and attached, by changing the color of the joining tape on the front and rear faces, it is possible to instantly determine whether the sheets are currently deployed or not.

78. By folding back the two transparent sheets and inserting a piece of paper therebetween, it can be used as a file folder.

79. The mask can be worn on the top of the head in place of a rain umbrella or parasol.

80. The effect of having two transparent sheets, folded and layered together is to increase strength.

81. The heat-reflective portion of the two joined transparent sheets is folded back to form a double heat-reflective part which provides twice the reflective heating of the space between the face and the mask, further improving the virus-destroying effect.

82. When side cushion parts are installed on the left and right ends of one of the transparent sheets, the effect is to achieve three enhancements of the device's efficacy by increasing the temperature, humidity, and air pressure in the space between the transparent sheets and the face.

83. By providing side cushion parts at the left and right ends of a single transparent sheet with a head attachment, the overall curvature of the transparent sheet is improved, and its strength is increased thereby. This has the effect of further improving contamination protection and sturdiness.

84. The invention is cooler than masks of the prior art.

85. By providing high cushions on the right and left ends of one transparent sheet, babies, individuals with smaller noses, and individuals who are mostly bedridden can support the side cushion of the transparent sheet with their faces, thus forming a space between the transparent sheet and their faces. This prevents the incursion of viruses or destroys viruses that have entered without making it difficult for the individual to breathe.

83. By providing side cushions 55 at the left and right ends of the transparent sheet 46 connected to the transparent sheet 47, instead of transparent sheet 47 with head cushions 59, the incursion of viruses from the left and right sides of the transparent sheet is prevented while the front of the face is protected by transparent sheet 46 and the back of the face is protected by the cushions 55 at the right and left ends of transparent sheet 46; the head is protected by the transparent sheet 47, which can prevent viruses from entering from all directions. Moreover, the temperature and humidity in the space between the face and the transparent sheet can be further increased, thus enhancing the virus-destroying effect and increasing air pressure, further preventing the incursion of viruses.

84. Cooling the wearer's forehead by installing a cooling material in this mask has two effects: first, it keeps the wearer cool and comfortable even when the mask is worn on hot summer days; second, it activates the frontal lobe of the brain and improves learning ability.

85. Cooling the wearer's temples by installing a cooling material in this mask has the effect of cooling the temples. First, this cools the area where the arteries pass through, and second, it prevents coronaviruses and other viruses from entering the mask because this cooling material serves as a barrier.

86. For example, a portable disposable body warmer or other heat-retaining material can be attached to the mask to keep the face warm in winter.

87. By installing a Fresnel lens on the transparent sheet of the mask, the mask can be used as a magnifying glass while protecting the wearer against coronaviruses, etc., making it effective for medical personnel as well.

88. By varying the number of times the cooling or warming material is wrapped around the nonwoven fabric or the direction in which it is wrapped, the mask's cooling and warming effects can be adjusted, thus preventing the wearer from frostbite or cold burns.

89. By locating the cushioning part below the top of the transparent sheet, it is possible to provide the cushioning part with insulation from heat or cold, bending the transparent sheet so that the warm or cold insulation does not detach.

90. By inclining both ends of the 90.5 mm cushion at a 45° angle, for example, both ends of the transparent sheet can cover the head or face without leaving gaps, thus preventing viruses and other contaminants from entering, and also preventing temperature or pressure leakage, humidity, and leakage of air pressure control, which are features of the invention.

91. The mask of this invention does not fog up the face even when filled with cooling material.

92. By stacking two thin transparent sheets, the transparent sheet will not bend even in strong winds, such as when riding a motorcycle.

93. Since the transparent sheet or cushion on the side of the face adheres to the side of the face and chin, it has the effect of preventing the incursion of airborne aerosol viruses such as the novel coronavirus from the side of the face and downward.

94. The strap used in effect 93 serves as a chin pad which prevents the transparent sheet from shifting upward, making the fixation of the transparent sheet to the face more secure.

95. The strap used in effect 93 is effective in preventing airborne incursion from below of viral aerosols such as the new coronavirus.

96. By separating the filter from the strap in effect 93, the filter can be installed without gaps in conformity to the shape of the wearer's face (chin), and furthermore, it is effective in preventing airborne incursion of viruses such as the new coronavirus and other viral aerosols.

97. The effect of inserting a sleeve with a filter below the transparent sheet is to allow easy attachment or replacement of the filter. (FIG. 114)

98. By providing a cushion on the strap in effect 93 the gap under the chin is eliminated and the mask is softly supported by and fitted to the lower part of the chin.

99. By integrating the cushion of the strap in effect 98 with the vertical side cushion, the gap in the chin area can be further reduced, which has the effect of making manufacturing easier.

100. By making the vertical side cushion a large sloped vertical side cushion part, it has the effect of eliminating the gap between the cheek area and the transparent sheet.

101. By providing the filter of effect 96 with the desired shape on the bottom edge of the transparent sheet, it becomes possible to increase the filter area when the mask is worn, making it easier to breathe. Moreover, it has the effect of improving appearance because it can be placed inside the clothing collar.

102. The effect 96 filter is made of a material that does not permit air to pass through it, and filters are provided only in the center of the filter, which makes it possible to design the filter material to fit any size filter. In addition, the filter can be wrapped around the neck, like a muffler, to provide protection from the cold.

102. The filter of effect 101 is made in the form of a bag, which allows the use of N95-compliant filters and maximizes the prevention of aerosol incursion of viruses such as the new coronavirus, while at the same time making breathing less uncomfortable.

103. By providing a bag-shaped (bowl-shaped) replaceable filter, it is possible to inexpensively and cleanly prevent aerosol incursion of viruses such as the new coronavirus.

103. By providing a bag-shaped (bowl-shaped) replaceable filter, it is possible to inexpensively and cleanly prevent aerosol incursion of viruses such as the new coronavirus.

105. By dividing and joining the transparent sheets to form a mask, the mask can be folded and carried.

106. By dividing the transparent sheet vertically into four sections, it can be placed in a breast pocket, making it very convenient to carry.

107. By providing a storage case having the same folded shape as in effects 103 and 104, the effect is that the mask can be carried without causing viruses such as the new coronavirus to get onto clothing and the like.

108. The cushion is a thick cushion for use with lenses, and by providing a recess for eyeglass lenses in the cushion, eyeglass lenses and scopes do not interfere with wearing the mask, and the mask can be firmly fixed to the wearer's head. Also, the effect is that the transparent sheet can be stably positioned at a right angle to the eyes so that the visual image is not shaken or distorted.

109. by providing a cooling or sweat-absorbing sheet in the thick cushion part, the sheet will absorb the wearer's perspiration and will prevent steam and fogging of the transparent sheet.

110. Since the center of the transparent sheet is provided with high cushion shaped with a diagonal V-shaped groove, the transparent sheet is supported only by the nose while the transparent sheet is separated into upper and lower sections, which has the effect of preventing viruses from entering through the eyes, nose, and mouth.

111. By pushing open the folded transparent sheet, the gap between the face and the transparent sheet is reduced, which has the effect of preventing viruses from reaching the wearer's face, and also has the effect of not requiring an elastic band for attachment, since the mask need only be attached to the ears with string or temple tips.

112. Since a door is provided in the transparent sheet where it touches the wearer's mouth, this has the effect of allowing the wearer to eat while wearing the invention.

113. This invention, which is worn when wearing masks of the prior art, is lightweight, prevents viruses from entering the eyes, allows eating and drinking, does not make the face hot, and does not shift or come off the body when the neck (face) is bent at a large angle or when looking down.

### BRIEF DESCRIPTION OF THE DRAWINGS

FIG. 1 Diagram showing wearing of mask of the prior art

FIG. 2 View of the first embodiment of the invention from the inside by expanding it. A cushion part 5 is provided at the top of a vertical transparent sheet which may be of B5 size, and a wide elastic band 6 is attached below it with the staples 7 facing outward to prevent injury to the face.

FIG. 3 Second embodiment of the invention viewed from the interior. A wide elastic band 6 is stapled 7 from the exterior to the interior of the transparent sheet 4, and a cushion part 5 is attached on top of the band to prevent the staples from injuring the face.

FIG. 4 Third embodiment of the invention viewed from the interior by expanding it. FIG. 4(A) shows a wide elastic band fixed to a transparent sheet with staples, and FIG. 4(B) shows a wide elastic band fixed to a transparent sheet with rivets. The third example uses a transparent thin B5 size or other sheet 4 which is longer in latitudinal direction to allow deeper coverage of the side of the face compared to the first and second examples.

FIG. 5 Side view of the first embodiment of the invention (FIG. 2), in which a wide elastic band 6 is fixed to a thin transparent sheet 4 with the staple tips 7 facing outward to prevent injury to the face.

FIG. 6 The second embodiment of the invention (FIG. 3) is shown from the side. A wide elastic band 6 is fixed to a thin transparent sheet 4 with the staple tips 7 facing inward, and a cushion part 5 is placed over the band to prevent injury to the face and to fill the gap between the sheet 4 and the wearer's face so that viruses and bacteria cannot enter from above and individuals who wear glasses can use the band from above.

FIG. 7 The second embodiment of the invention (FIG. 3) is worn curved and viewed from the front.

FIG. 8 A front view of a fourth embodiment of the invention, in which the transparent sheet 4 is directly worn on the forehead without the cushion part 5.

FIG. 9 Side view of the second and third embodiments of the invention (FIGS. 3 and 4(A)), examples of the invention that are curved with the transparent sheet 4 to strengthen it when worn.

FIG. 10 Side view of a fifth embodiment of the invention, in which the product is shifted and worn below the eyes.

FIG. 11 A front view of a sixth embodiment of the invention, in which the cushion part 5 is removed at the nose apex and divided into left and right cushions 53, 54.

FIG. 12 Front view of a seventh embodiment of the invention with cushion parts 5, 55 on the top, left and right sides.

FIG. 13 Seventh embodiment of the invention (FIG. 12), viewed from the side.

FIG. 14 Eighth embodiment of the invention viewed from the side of FIG. 12.

FIG. 15 Ninth embodiment of the invention, (A) side view, (B) front view, in which a hook and loop fastener (Velcro {registered trademark}) strip 8 is provided at the end of the wide elastic band 6 or band string to allow the mask to fit different head sizes.

FIG. 16 Side view of a tenth embodiment of the invention, which is tied according to the size of the head with a string 63 in place of a wide elastic band or Velcro (registered trademark).

FIG. 17 Eleventh embodiment of the invention shown from the rear, showing the 64 adjusting apparatus to adjust the length of the wide elastic band 6.

FIG. 18 Twelfth embodiment of the invention: an enlarged cross-sectional view of the side of FIG. 6, showing the structure in which the transparent sheet 4 and the wide elastic band 6 are fixed with a staple and the cushion part 5 is glued over the staple tips 72.

FIG. 19 Thirteenth embodiment of the invention, viewed from the side: an enlarged cross-sectional view of the elastic band ends, showing the means of preventing fraying and Velcro (registered trademark) peeling prevention structure of the left and right elastic band ends.

FIG. 20 Fourteenth embodiment of the invention: a top view of the invention, showing the structure of the wide elastic band 6 with both ends folded back and secured.

FIG. 21 Fifteenth embodiment of the invention, viewed from the top, with a Velcro (registered trademark) strip 8 adhered to one end of the wide elastic band 6, and Velcro (registered trademark) strip 8 also adhered and fixed to the top of the side of the transparent sheet.

FIG. 22 Sixteenth embodiment of the invention, viewed from the top, with double-sided tape 66 adhered to the front and back of the edge of the wide elastic band 6, which is fixed to the side of the transparent sheet 4 with staples 7.

FIG. 23 Seventeenth embodiment of the invention, viewed from the top of the invention, with the ends of the elastic bands 6 (6L, 6R) and a Velcro (registered trademark) strip 8 secured with staples 7.

FIG. 24 Seventeenth example (FIG. 23) of the invention, wherein the elastic bands 6R and 6L are fastened at the back of the wearer's head.

FIG. 25 Eighteenth embodiment of the invention, in which the ends of the Velcro (registered trademark) strip 8 and the ends of the elastic band 6 are folded over and glued and fixed with staples 7.

FIG. 26 Eighteenth example (FIG. 25) of the invention, wherein the elastic bands 6R and 6L are fastened at the back of the wearer's head.

FIG. 27 Twentieth example of this invention, wherein only a single wide elastic band 6 is used, and one end of the Velcro (registered trademark) strip 8 is bonded and fixed to the transparent sheet 4, and the other Velcro (registered trademark) strip 8 is glued and fixed to the end of the wide elastic band 6.

FIG. 28 21st embodiment of the invention: a front view of the mask without the upper cushion part and with a vertical side cushion part.

FIG. 28 The 22nd and 154th examples of the mask, viewed from the front, when the invention is worn, with a vertical side cushion part and a lower cushion part in addition to the upper cushion part.

FIG. 30 This figure shows the state of the invention when speaking 24 and breathing 16.

FIG. 31 The figure illustrates the principle of operation of the pressure differential caused by heat generated from the face due to body temperature.

FIG. 33 The figure illustrates the principle of operation of the invention, with the upper cushion part 5, vertical side cushion part 55, and lower cushion part 58 on the transparent sheet 4 in the 22nd example.

FIG. 33 This figure illustrates the function of the lower cushion 58 of the invention.

FIG. 34 This figure illustrates the coronavirus protection operating principle and effect of the invention due to humidity and temperature increase in a side view of the invention when it is worn.

FIG. 35 Front view of the 23rd embodiment of the invention with the invention worn by a wearer.

FIG. 36 Rear view of the 23rd embodiment of the invention (FIG. 35) with numerous round holes 11.

FIG. 37 Side view of the invention of the 24th embodiment of the invention, with multiple semicircles 111 in the back of the head.

FIG. 38 Side view of a 25th embodiment of the invention with the invention folded in half vertically, with the main part folded vertically and cut off at the ends with triangles 11. In this embodiment of the invention multiple diamond-shaped holes are formed when when the main part is deployed.

FIG. 39 Side view of a 25th embodiment of the invention wherein the fold shown in FIG. 38 can form two rhomboid holes 112 behind the head.

FIG. 40 A 26th embodiment of the invention in which the inner surface of the transparent sheet 4 is shown from the rear, with adhesive in two places on the left and right, and adhesive tape in the center.

FIG. 41 Top view of the 26th embodiment of the invention (FIG. 40) attached to the left and right sides of a hat 14 and to the brim 141 of the hat.

FIG. 42 Side view of the 26th embodiment of the invention (FIG. 40) attached to a hat 13.

FIG. 43 28th through 32nd embodiments of the invention, viewed from the front and top, with LEDs installed in the mask of this invention.

FIG. 44 33rd embodiment of the invention, viewed from the front, with a reflector 20 adhered to the top of the transparent sheet 4.

FIG. 45 34th embodiment of the invention: a front view, with the reflector 20 adhered to the upper cushion part, vertical side cushion part, and lower cushion of the transparent sheet 4.

FIG. 46 35th embodiment of the invention: a front view, with rubber or plastic material bonded to the vertical sides of the transparent sheet 4.

FIG. 47 36th embodiment of the invention: a front view, with the vertical side edges of the transparent sheet 4 folded inward into the transparent sheet.

FIG. 48 37th embodiment of the invention: a front view, with the wide cushion part 59 glued to the transparent sheet 4 and the elastic band 6 bonded and fixed at the position of the bottom edge of the wide cushion part 59.

FIG. 49 Figure illustrating the working principle and effect of the 37th embodiment of the invention. This is a top view showing the change in shape of the mask after it has been put on.

FIG. 50 Diagram illustrating the invention wherein the structure is reinforced when the invention is used.

FIG. 51 38th embodiment of the invention: a front view of a small transparent sheet with edges 21 and rounded corners for use by babies, infants and children.

FIG. 52 39th embodiment of the invention: a front view of a 44 transparent sheet with rounded corners.

FIG. 53 40th embodiment of the invention: a front view, with a plasma tape or aluminum tape 22 bonded to the top of the transparent sheet 4.

FIG. 54 41st embodiment of the invention: a front view, with the elastic band 6 fixed at an angle relative to the transparent sheet 4.

FIG. 55 42nd embodiment of the invention, with 6 elastic bands fixed at two locations on the sides of the transparent sheet 4.

FIG. 56 43rd embodiment of the invention: 6 elastic bands are fixed to the sides and underside of the transparent sheet 4.

FIG. 57 44th embodiment of the invention, wherein (A) shows a protective sheet 27, and (B) is a side view, showing the protective sheet 27 inserted inside the transparent sheet 4.

FIG. 58 Figure illustrating the state of Velcro (registered trademark) bonding, (A) when worn, (B) when bonded in the 44th embodiment of the invention.

FIG. 59 45th embodiment of the invention, wherein (A) shows a protective sheet 271, and (B) is a side view, showing the protective sheet 271 inserted inside the transparent sheet 4.

FIG. 60 46th embodiment of the invention, wherein a reinforcement sheet 28 within the transparent sheet 4, is applied to (A) the 44th example and (B) to the 45th embodiment of the invention.

FIG. 61 47th embodiment of the invention: a side view, with a Peltier element 29 installed in the cushion part and the mask of the invention.

FIG. 62 Side view of the 47th embodiment of the invention (FIG. 61), enlarging the forehead area of the wearer to illustrate heat flow.

FIG. 63 48th embodiment of the invention: a side view, in which the elastic band 6 is curved to change the angle of the transparent sheet.

FIG. 64 49th embodiment of the invention: a front view with a transparent sheet with a large size (horizontal B4 size).

FIG. 65 Side view of the 49th embodiment of the invention when worn by a user.

FIG. 66 Top view of the 49th embodiment of the invention when worn by a user.

FIG. 67 50th embodiment of the invention, showing (A) a front view and (B) a side view of the transparent sheet 46 and a transparent sheet 47 joined together.

FIG. 68 51st embodiment of the invention: (A) front view and (B) side view, showing two transparent sheets 46, 47 joined by a heat-reflective hinge 221 made of glass cloth laminated with aluminum.

FIG. 69 52nd embodiment of the invention, showing (A) a front view and (B) a side view, with a cushion part 6 installed only on one side of the transparent sheet 47 on the top edge thereof.

FIG. 70 53rd embodiment of the invention, wherein reflective tape is disposed inside the transparent sheets and (A) is a front view of two deployed transparent sheets, (B) is a front view of two transparent sheets superimposed, and (C) is a side view of the sheets when superimposed.

FIG. 71 54th embodiment of the invention wherein (A) is a side view of two transparent sheets stacked on top of each other, with documentation or the like inserted in the gap therebetween for use as file folder, and (B) is a side view of two transparent sheets separated and joined together, with the gap formed between used as a file folder.

FIG. 72 55th embodiment of the invention: a side view of two stacked transparent sheets and paper, filter, cloth, or the like inserted therebetween wherein (A) is a standing view of the mask being worn while the individual is standing and (B) shows the mask worn while the user is lying down.

FIG. 73 56th embodiment of the invention, which is worn on the head, wherein (A) is a side view when used as a rain umbrella and (B) is a side view when used as a parasol.

FIG. 74 57th embodiment of the invention where in (A) is a front view of the two transparent sheets open and unfolded and (B) is a front view of the two sheets folded against each other.

FIG. 75 58th embodiment of the invention wherein (A) is a front view and (B) is a side view.

FIG. 76 59th embodiment of the invention; a side view of the mask of this invention.

FIG. 77 60th example of this invention, wherein FIG. 77(A) shows a front view and a cross-sectional view, and FIG. 77(B) shows a front view and a cross-sectional view of the mask of this invention when worn by a user.

FIG. 78 61st example of this invention, wherein FIG. 78(A) shows a front view and a cross-sectional view, and FIG. 78(B) shows a front view and a cross-sectional view of the mask of this invention provided with a coolant. FIG. 78(C) shows an internal side view and cross-sectional view of the mask of this invention in use. The zipper or other closure 371 for the bag for cold storage materials or the like may be omitted.

FIG. 79 62nd example of this invention, wherein FIG. 79(A) is a front view and a cross-sectional view, FIG. 79(C) is a front view of this mask with the coolant installed, and

FIG. 79(C) is a side view of the mask with the coolant installed.

FIG. 80 Front view (inside), cross-sectional view, with cold storage material insertion opening on the side of the mask shown in FIG. 78.

FIG. 81 Front view (inside), cross-sectional view, with cold storage material insertion opening on the side of the mask shown in FIG. 79.

FIG. 82 63rd embodiment of the invention which is a front view (inside) with a square cold retainer provided on the side thereof, and a side view when installed.

FIG. 83 63rd embodiment of the invention which is a front view (inside) with a rectangular cold storage material on the side, and a side view when this material is installed.

FIG. 84 Front view (inside) of a 64th embodiment of the invention, with cold insulation for both the forehead and temples.

FIG. 85 65th embodiment of the invention, showing the front (inside), with the bag for cold storage material bonded to the side of the A4-size transparent sheet, and a drawing when the mask is worn.

FIG. 86 Front view (inside) and cross-sectional view of a 66th embodiment of the invention, with the cooling material for the forehead area.

FIG. 87 Side view (inside) and cross-sectional view of a 67th embodiment of the invention, with the cooling material bag for the forehead area.

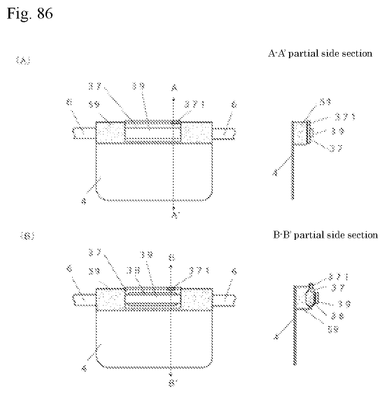

FIG. 86 Front view (inside) and cross-sectional view of a 68th embodiment of the invention, a structure with direct cold insulation for the forehead area.

FIG. 89 Front view (inside) and cross-sectional view of a 69th embodiment of the invention, with a B4-size vertical transparent sheet provided with cold insulation material.

FIG. 90 Front view (inside) and cross-sectional view of a 70th embodiment of the invention, showing the structure of a cold storage material installed with two joined transparent sheets.

FIG. 91 Front view (inside) and cross-sectional view of a 71st embodiment of the invention, showing the structure of a cold storage material installed with two joined transparent sheets.

FIG. 92 Front view (inside), cross-sectional view, and a side view when the mask is worn, showing the installation of the cold storage material directly on the transparent sheet that joins the two pieces in the 72nd example of this invention.

FIG. 93 73rd embodiment of the invention: a front view (inside) of a transparent sheet with cushions and cold insulation on the sides thereof.

FIG. 94 74th example of this invention, showing a front view (inside) and cross-sectional view of the cold storage material installation with a B4-size transparent sheet.

FIG. 95 74th example of this invention, showing a front view (inside) and cross-sectional view of the cold storage material installation with a B4-size transparent sheet.

FIG. 96 75th embodiment of the invention: a front view (inside) and a cross-sectional view of an A4 horizontal size transparent sheet with cooling materials 38, etc.

FIG. 97 FIG. 96 shows a front view (inside) and cross-sectional view of cold storage materials and the like 38, rolled up in a cold storage material bag 37.

FIG. 98 This is a front view of FIG. 96 showing an example of dimensions.

FIG. 99 76th embodiment of the invention, wherein both ends of the cushion part are sloped in (A) a top view and (B) a top view when the mask is worn.

FIG. 100 77th example, a top view of the cold storage material used in this invention.

FIG. 101 79th embodiment of the invention: Front and side views with Fresnel lens or other such lens.

FIG. 102 80th embodiment of the invention, showing the front and side views of a lens such as a Fresnel lens installed on the on the transparent sheet which consists of two pieces joined together.

FIG. 102 81st embodiment of the invention, showing the front and side views of a lens such as a Fresnel lens installed on the on the transparent sheet which consists of two pieces joined together.

FIG. 104 82nd embodiment of the invention: a front and side view of a vertical B4-size transparent sheet with a Fresnel or other such lens installed thereon.

FIG. 105 83rd embodiment of the invention which shows front and side views of the Fresnel or other such lens installed on an arm.

FIG. 105 84th embodiment of the invention which shows front and side views of the Fresnel or other such lens installed on an arm.

FIG. 107 Front view (A) of an 88th example of the invention, with a bib-shaped sheet (material: vinyl sheet, cloth, non-woven fabric, N95 filter, etc.) 1000 provided at the bottom edge of the transparent sheet 4. (B) is a front view of a bib-shaped sheet 1000 with a window in a portion of the bib and an N95 filter 1095 installed therein.

FIG. 108 Front view and partial cross-sectional view of an 89th example of this invention which is a mask for the novel coronavirus, in which the spreading of the middle and lower curvature of the transparent sheet has been reduced.

FIG. 109 Bottom view of FIG. 108.

FIG. 110 89th embodiment of the invention when worn by a user, viewed from the rear (back of the wearer's head).

FIG. 111 89th embodiment of the invention from above near the chin when the middle and lower curvature of the transparent sheet is reduced.

FIG. 112 91st embodiment of the invention with a filter 1067 provided under the chin opening of the curved portion of the transparent sheet 46, viewed from above near the jaw.

FIG. 113 91st embodiment of the invention: a front view of the invention in FIG. 112 as deployed.

FIG. 114 92nd embodiment of the invention: a front view of the strap 67 and the 1067 under the under-chin filter provided separately from each other at the bottom edge of the transparent sheet.

FIG. 115 93rd embodiment of the invention in which (A) is a horseshoe-shaped sleeve 1010 with a filter 1067 bonded to to the bottom edge of the transparent sheet in similar to dentures wherein the filter 1067 seals the bottom opening of the transparent sheet. (B) is a view of the chin area from above, with a tightened lower curvature of the transparent sheet.

FIG. 116 94th embodiment of the invention in which (A) is a front view and (B) is a side view of a vertical side cushion part 553 that serves as both a chinstrap and a chin rest cushion.

FIG. 117 FIG. 117 is bottom view of FIG. 116.

FIG. 118 95th embodiment of the invention in which (A) is a front view and (B) is a side view of a longitudinal side cushion part 551 with a sloping end face and a sloped cushion part 552 on the strap 67 which is fitted to the wearer's chin.

FIG. 119 96th embodiment of the invention, in which (A) is a front view and (B) is a side view of the invention, which is a combination of two transparent sheets 46 and 47, with a sloping end face and a sloped cushion part 552 on the strap 67 which is fitted to the wearer's chin.

FIG. 120 FIGS. 116-118 show front views of the invention when worn by a user.

FIG. 121: 97th embodiment of the invention, in which (A) is a front view of the invention when it is worn by a user. (B) is a side view of the invention when it is worn by a user.

FIG. 122 Rear view of an 98th example of the invention, with a bib-shaped sheet (material: vinyl sheet, cloth, non-woven fabric, N95 filter, etc.) 1000 provided at the bottom edge of the transparent sheet 4.

FIG. 123 Front view of the invention of FIG. 122 when worn by a user.

FIG. 124 99th embodiment of the invention, in which the vertically attached chinstrap 67 of FIG. 122 is replaced by a horizontally attached chinstrap 671, and the width of the bib-shaped sheet 1000 is the full width of the transparent sheet 4.

FIG. 125 100th embodiment of the invention, with a bib-shaped sheet bonded along its width to the bottom edge of the transparent sheet to cover the entire width of the transparent sheet 4, and a transparent sheet 47 connected to the top of the transparent sheet 46, with a bag 37 for cooling and heating which is disposed between the transparent sheet 47 and the cushion 59 in which (A) is a front view and (B) is a side view thereof.

FIG. 126 101st example of the invention, in which an N95 filter 1095 formed in a bag shape (bowl shape) is attached to the transparent sheet 4 so as to cover the opening of the transparent sheet under the chin in a bowl shape in place of the bib-shaped sheet 1000 sown in FIG. 124, wherein (1)˜(4) show the procedures for producing the bag shape (bowl shape). Drawing (5) shows the procedures for making the N95 filter into a flat shape, drawing (6) is a development (front view) of the invention, and (7) is a diagram illustrating the invention as worn by a user.

FIG. 127 102nd example of the present invention, which is a removable (disposable) bag-shaped (bowl-shaped) N95 filter 1095 made from a transparent sheet with the bottom end of the N95 filter 1095 of FIG. 126 joined with PSA double-sided tape 95 and the top end with removable PSA tape 94 and is made according to steps (1) through (4).

FIG. 128: 103rd embodiment of the invention in which the mask is fixed to the nose with a nose clip 1040. (1)˜(3) show the procedures for fabricating the product, (4) is a front view of the product attached to the face with a nose clip 1040, and (5) is a side view of (4).

FIG. 129 104th embodiment of the invention, wherein (1-1), (1-2), (2), (3-1) and (3-2) are the roughly rectangular, square or other shapes of Example 102 (FIG. 127). The figure shows how to make removable sheets (transparent, opaque, or translucent, made of opaque materials such as nylon, plastic, PE, PP, etc., or transparent materials such as filters, non-woven fabrics, pieces of cloth, N95 filters, etc.) to be adhered to the wearer's face using removable medical PSA double-sided tape 941 or a rubber string 61.

FIG. 130 105th embodiment of the invention, (1-1), (1-2), (2) and (3) are the rectangular shape of the 102nd embodiment (FIG. 127), which is folded as shown in the direction indicated by the arrow and its sides are heat-sealed 92 to form a saucer shape of the 105th embodiment (FIG. 127). The figure shows how to fabricate a removable sheet (transparent, opaque, or translucent, made of an opaque material such as nylon, plastic, PE, PP, or a transparent material such as filter, non-woven, fabric, or N95 filter) to be attached to the wearer's face with removable medical PSA double-sided tape 941 or removable medical PSA single-sided tape.

FIG. 131 104th is an example worn by a user, where the material is an N95 filter and (A) is a view of the invention of a mask with a transparent sheet worn by a user with with a head contacting cushion 59 and 55 vertical side cushions, (B) is a view of the invention worn by a user when the transparent sheet in (A) has a strap (chinstrap) 671 to tighten the curvature, (C) is a view of the invention worn by a user at the base of the user's nose, and (D) is a side view of (C).

FIG. 131 104th is an example worn by a user, where the material is an N95 filter and (A) is a view of the invention of a mask with a transparent sheet worn by a user with with a head contacting cushion 59 and 55 vertical side cushions, (B) is a view of the invention worn by a user when the transparent sheet in (A) has a strap (chinstrap) 671 to tighten the curvature, (C) is a view of the invention worn by a user at the base of the user's nose, and (D) is a side view of (C).

FIG. 133: 106th embodiment of the invention: a front view of a bib-shaped sheet (made of vinyl sheet, cloth, non-woven fabric, N95 filter, etc.) 1000 provided at the bottom edge of the transparent sheet 4, with a neck strap 672 attached at both ends of the bib-shaped sheet 1000.

FIG. 134 Rear view of FIG. 133.

FIG. 135 107th example of the present invention and is a front view of a bib-shaped sheet (made of vinyl sheet, cloth, non-woven fabric, N95 filter, etc.) 1000 with a window at the bottom edge of the transparent sheet 4 and N95 filter 1095 attached thereto.

FIG. 136 Rear view of FIG. 135.

FIG. 137 108th embodiment of the invention illustrating how to fabricate an N95 bag filter 1095 that is bonded to the bottom edge of a B4 or A4 horizontal size transparent sheet 4. (1) General view of the deployed N95 filter; (2) shows the size of the N95 filter 1095 when deployed, wherein (A) is the shortest distance when curved, (B) is the width of the transparent sheet; (C) is the direction in which the N95 filter is folded; (3) indicates the dotted line in (2) folded in the direction (C) and the amount of glue 921 on the side bonded part which is, for example, heat sealed 92; and (4) is a diagonal view of figure (3) with the mouth 93 open at the top due to the difference in length of (A) and (B); (5) is a front view of the N95 bag filter 1095 on the mask and when worn by a user; and (6) is a cross-sectional view.

FIG. 138 109th embodiment of the invention, in which transparent sheets 48 which are divided horizontally into two parts are joined together with connectors 49 comprised of, for example polyester or other transparent adhesive tape; (A) is a front view and (B) is a side view when worn by a user.

FIG. 139 109th embodiment of the invention which is a side view of the invention when folded.

FIG. 140 110th embodiment of the invention, showing a mask of the invention with transparent sheets 482 which are divided into two parts each vertically and horizontally, and divided into four parts overall, joined together by connectors 49 comprised of, for example, polyester or other transparent adhesive tape; (A) is a front view and (B) is a side view when worn by a user.

FIG. 142 110th embodiment of the invention which is a side view of the invention when folded.

FIG. 142 110th embodiment of the invention, in which transparent sheets 483 which are divided horizontally into two parts are joined together with connectors 49 comprised of, for example polyester or other transparent adhesive tape; (A) is a front view and (B) is a side view when worn by a user.

FIG. 143 111th embodiment of the invention which is a side view of the invention when folded.

FIG. 144 112th embodiment of the invention in which the invention is made to be inserted into a pocket. Specifically, the figure shows the invention, in which transparent sheets 484 divided vertically into four sections are joined by connectors 49 comprised of, for example, polyester or other transparent adhesive tape; (A) is the front view and (B) is the rear view thereof.

FIG. 145 Top view of the folding process of FIG. 144 of the 112th embodiment of the invention is shown in (A), (B), (C), and (D).

FIG. 146 The cushion of the 113th embodiment of the invention is shown in (A) a front view and (B) a rear view, which differs from FIG. 143.

FIG. 147 Top view of the folding process of FIG. 146 of the 113th embodiment of the invention is shown in (A), (B), (C), and (D).

FIG. 148 114th embodiment of the invention, which is is a front view of the bottom edge of the transparent sheet with an N95 filter 1095 or the like.

FIG. 149 115th embodiment of the invention, showing a case 261 that houses the invention of FIGS. 144 to 145 of the 112th embodiment, with (A) a side view and (B) an enlarged cross-sectional view.

FIG. 150 116th embodiment of the invention, showing a case 261 with a protruding part 263 corresponding to the folded over cushion part, which houses the invention of FIGS. 146-147 of the 113th example, in (A) a side view and (B) an enlarged cross-sectional view.

FIG. 151 117th embodiment of the invention which is an invention for the use of a dental scope. Specifically, the cushion is a thick cushion part 593, with a recess 5931 for a scope or other lens in the cushion part, and (A) is a front view, (B) is a side view, and (C) is a bottom view.

FIG. 152 118th embodiment of the invention, in which a sheet such as a cooling water absorption sheet 1030 is provided in the thick cushion part 593. (A) is a rear view (to make clear distinctions in the following drawings, the X in the circle indicates the direction in which the invention is viewed from the wearer's side, indicating that this is a rear view of the invention), (B) is a top (plan) view, and (C) is a side view.

FIG. 153 119th embodiment of the invention, which is characterized in that a cooling water absorption sheet 1030 is provided only on the side of the thick cushion part 593, which is in contact with the head. (A) is rear view, (B) is a top (plan) view, and (C) is a side view.

FIG. 154 120th embodiment of the invention, which is characterized by the fact that only cooling water absorption sheet 1030 is provided on the transparent sheet (without a cushion), which is in contact with the head. (A) is a rear view, (B) is a top view, and (C) is a side view.

FIG. 155 121st embodiment of the invention, characterized by the cushion part being in the center of the transparent sheet, and the cushion and nose contact area being indented into a V shape or the like. (A) is a rear view, (B) is a top view, and (C) is a side view.

FIG. 156 122nd example of this invention, which is characterized by wearing a transparent sheet 401 which bends in two when it is pushed open. Furthermore, in the center of the transparent sheet is a nose-rest thick cushion 501, and at the lower end of the transparent sheet is a bib-shaped sheet 1000. (A) is a rear view, (B) is a top view, (C) is a side view, and (D) is a top view showing the action of pushing open the transparent sheet to wear it, and (E) is a top view of the invention as worn on the face.

FIG. 157 123rd embodiment of the invention, in which the transparent sheet of the part which is in contact with the mouth can be opened and closed when the device is worn. The two central transparent sheets 484 are divided vertically into four sections having a door 402 consisting of a transparent sheet that can be opened and closed. (A) is a front view and (B) is a rear view.

FIG. 158 Front view of a 124th embodiment of the invention, which has a lid 4021 that opens in the center of the lower part of the transparent sheet, which is near the mouth when the device is worn by a user.

FIG. 159 125th embodiment of the invention in which another example of a transparent sheet that can be opened and closed where the mask comes into contact with the mouth when worn, wherein (A) is an invention in which the lower part of the transparent sheet 402 can be rotated upward, (B) is an invention in which one transparent sheet 402 in the center of the three vertically-divided transparent sheets has an openable/closable portion 4021, and (C) is an invention in which the lower center of one transparent sheets 4 has a horizontal openable/closable portion.

FIG. 160 126th embodiment of the invention in which the invention is provided with an opening and a lid at the bottom center of a transparent sheet which can be curved and fixed when the lid is flipped up. (A) is an explanatory front view of one transparent sheet with a lid, (B) is an explanatory front view of three thin transparent sheets connected horizontally, and (C) is a side explanatory operational view of (A) and (B).

FIG. 161 (A) is a front view of the lid of FIG. 160(A) fixed to the transparent sheet with a hinge 4024 using transparent PSA tape, etc.; (B) is a front view of the lid of FIG. 160(B) fixed to the transparent sheet with a hinge 4024; (C) is a front view of an example of a lid with a different shape to facilitate opening and closing.

FIG. 162 127th embodiment of the invention, which has a rotatable transparent sheet door with a fulcrum on an elastic band for wearing on the head provided at the bottom of the transparent sheet and is shown in a front view.

FIG. 163 128th embodiment of the invention which is provided with a sliding groove in the transparent sheet wherein the lower part of the transparent sheet is opened and closed by sliding the transparent sheet door. (A) shows a front view of the transparent sheet with a grooved and sliding transparent door 4027 at the bottom of the transparent sheet, which is provided with a pin, and (B) shows a front view of the transparent sheet 402 with a groove and a sliding and opening transparent sheet 4027 at the bottom of the transparent sheet which is provided with a pin.

FIG. 164 129th embodiment of the invention, in which (A) is a front view of the invention when unfolded, (B) is a top view, and (C) is a front view of the invention with a conventional mask as worn by a user.

FIG. 165 130th example of this invention: this is an example with a transparent sheet that can be opened and closed where it comes into contact with the wearer's mouth and has a chinstrap. The transparent sheet is provided with a cushion that is divided horizontally at about ⅓ of its length from the bottom edge and can be opened and closed toward the outside so the user can eat and drink.

FIG. 166 131st embodiment of the invention: This is a front view of an example in which the transparent sheet of the portion making contact with the mouth when worn can be opened and closed, and in which the elastic band 6 of FIG. 165 is positioned in the center of the transparent sheet, and a thick cushion 501 is provided for the nose pad.

FIG. 167 132nd embodiment of the invention: This is a front view of the transparent film transparent member 404 which is bonded to a mask of the prior art 1 wherein (A) is a front view of the transparent film transparent member 404 which is bonded and fixed to a mask of the prior art 1, (D) is a front developed view of the invention of FIG. 168(D) with the publicly-known mask 1 bonded and fixed, and (F) is a front developed view of the invention of FIG. 168(F) with the publicly-known mask 1 bonded and fixed thereto.

FIG. 168 133rd embodiment of the invention which is characterized by a nose contacting cushion part 502 being provided on the lower inside edge of a film transparent member 403 and is bonded so it is freely attachable and detachable to a publicly-known mask 1 and worn on the face. (A) is a rear view (the X in the circle) symbol indicating the inside of the invention as seen from the direction of the eyes when worn) of an invention characterized in that it is attached to a prior mask 1 in a removable manner and worn on the face and removable adhesive tape 943 is provided on the lower outer side of the film transparent member; (B) is a side view thereof; (C) is a top view thereof, (D) is a rear view thereof, with a V-shaped groove provided in the center of the rear face of the film transparent member. (E) is a side cross-sectional view of (D), (F) is a rear view, and (G) is a side view of (F) in the form of using adhesive tape 944 shared for bonding the nose cushion 502 and film transparent member 403.

FIG. 169 FIGS. 167 and 168 of the 132nd and 133rd examples are shown with the inventions of FIGS. 167 and 168 attached thereto; (A-1) and (A-2) are front and side views with inventions in the form of FIGS. 167(A) and 168(A); (D-1) and (D-2) are front and side views with inventions in the form of FIGS. 167(D) and 168(D); (F-1) and (F-2) are front and side views with inventions in the form of FIGS. 167(F) and 168(F).

FIG. 170 134th embodiment of the invention: The top view shows the form of the nose cushion provided at the bottom of the film transparent member 403, (A) is a nose cushion 502 formed with a cutout 511 in the center thereof, (B) is a nose cushion 502 formed with an indentation for the nose (a V-shaped groove or the like); (C) is a nose cushion 502 formed with deep indentations for the nose and an incline 513; (D) is a nose cushion 502 form with a rounded indentation and incline for the nose; (E) is a nose cushion 502 formed with an incline where the cushion is separated into two parts at the nose; (F) is a nose cushion 502 formed with a rounded cushion in the form of (E); (F) is a nose pad cushion 502 with the rounded incline in (E); (G) is a nose pad cushion 502 that becomes smaller toward the tip of the nose according to the shape of the nose as in (F); and (H) is a nose pad cushion 515 made of soft fabric such as a non-woven fabric to improve the feel of the cushion material upon the nose.

FIG. 171 135th embodiment of the invention: This is an example of a transparent body with a V-shaped top end, designed especially for wearers who use scopes, such as dentists and the like wherein (A) is a side view showing the distances X, Y from the top end of the mask to the strap 911 of the scope when wearing a mask of the prior art, and (B) is a front view of a mask with a film transparent body 405 with a V-shaped top end of the invention.

FIG. 172 136th embodiment of the invention: This is an example of a partial nose cushion part inside the lower edge of the film transparent member 403 wherein (A) is a front view before joining the invention and the mask of the prior art 1; (B) is a front view of the invention and the publicly-known mask 1; (C) is a side view when the publicly-known mask 1 is worn; and (D) is a side view when the invention is worn by a user.

FIG. 173 137th embodiment of the invention: This is an example of a film transparent member on a transparent sheet with a nose cushion. (A) and (B) show a developed front view and a side view as worn by a user.

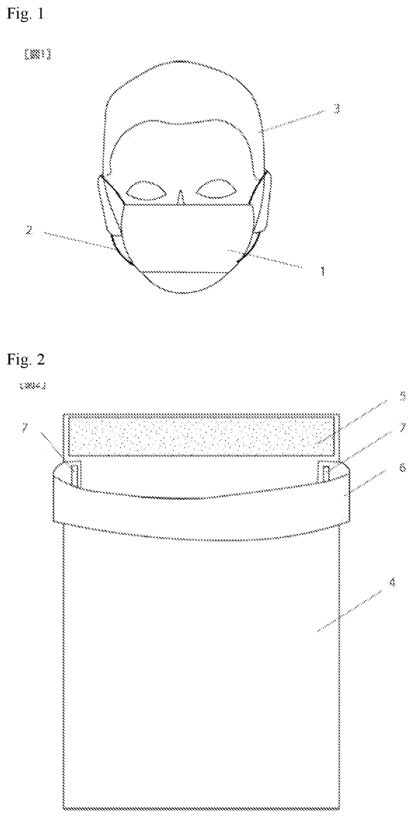

FIG. 174 138th embodiment of the invention: This is an example of a non-woven fabric on the inside of the transparent sheet or mask corresponding to the position of the mouth and nose when worn by a user. (A) is a developed front view of non-woven fabric 1095 which is inserted into the invention forms of FIGS. 169(A-1) (A-2); (B) is a side view with (A) installed; (C) is a developed front view of the non-woven fabric 1095 inserted into the form of the invention in FIG. 173(B); (D) is a side view with (C) as worn by a user.

FIG. 175 139th embodiment of the invention: Embodiment 138 (FIG. 174) in the form of a bag 1094 with a non-woven fabric inserted therein. (A) and (C) are front views with the bag deployed; (B) and (D) are side views with the bag attached.

FIG. 176 140th embodiment of the invention: (A) shows a side cross-sectional view of a transparent mask that is supported by the ears and a transparent mask with a film transparent member 403; (B) shows a side cross-sectional view of a mask without a chin pad and supported by temple tips; (C) shows a side cross-sectional view of a mask with a film transparent member on the outside of a mask 1; (D) shows a side cross-sectional view of the mask with the film transparent member installed inside the mask 1 by means of a cushion; and (E) and (F) show side cross-sectional views of the mask with the film transparent member installed outside the mask 1 by means of a cushion.

FIG. 177 141st embodiment of the invention: This is an example of a thickness cushion that is not provided with a groove in the nosepiece cushion 502 and does not interfere with wearing the invention while wearing eyeglasses. (A) is a side cross-sectional view of a mask 1 with a film transparent member 403 using the cushion in FIG. 170(F), worn by a wearer who is not wearing eyeglasses; (B) is an developed top view of the invention in (A); (C) is an example of a mask 1 with a cushion in (B) as worn by a wearer of eyeglasses; (C) is a side cross-sectional view worn by a user wearing glasses; (D) is a developed top view of the invention in (C); and (E) is a top view of the invention in (C) when the temple tips 1090 or other nose fitting of the mask is bent to conform to shape of the nose when worn by a user. (F) shows a top view of the mask 1 with cushions in the front and back (inside and outside).

FIG. 178 142nd embodiment of the invention: Example of a transparent sheet with a head attachment is a film-like transparent 403 made of a coronavirus-blocking material such as a transparent film, etc., which can be curved and attached, and when eating, the film-like transparent 403 can be lifted upwards (see arrows).

FIG. 179 143rd embodiment of the invention: In embodiment 142 (FIG. 178), multiple transparent sheets or transparent s are provided so that they partially overlap. (A) is a front view of two transparent film s 403 that is 100 microns in thickness, for example, which overlap one another, and (B) is a front view of two transparent sheets 300 microns in thickness, for example, at the left and right ends of the cushion part 5 and a transparent film 403 100 microns in thickness in the center.

FIG. 180 144th embodiment of the invention: In the example where the head contacting part is a shallow-curved sheet or bar-shaped transparent sheet support 1060, (A) is a front view where the transparent sheet is a film transparent member 403, and (B) is a front view with a bent transparent sheet 484 on the left and right-side faces of the film transparent member 403 which is bonded to the shallow-curved transparent sheet support 1060.

FIG. 181 145th embodiment of the invention: This is an embodiment in which the head contacting part consists of a shallow-curved transparent sheet support and a cushion part. (A) is a front view of the film transparent member 403 bonded to the slightly curved sheet support 1060, with the transparent sheet bonded to the cushion on the left and right sides of the wearer's face, and (B) is a top view thereof.

FIG. 182 146th embodiment of the invention: This is an example having an opening with a film transparent member 403 at the bottom of the transparent sheet, and the head contacting part consists of a shallow-curved transparent sheet support and a cushion part with an indentation; (A) is a front view and (B) is a top view.

FIG. 183 147th embodiment of the invention: This is an example of a head fixture in the form of an eyeglass frame with temple tips to support a transparent sheet 486 and a film transparent member 403. (A) is a front developed view of the transparent sheet; (B) is a perspective view of the transparent sheet bonded to an eyeglass frame 1070 with temple tips, and (C) is a top view.

FIG. 184 148th embodiment of the invention: In embodiment 147 (FIG. 183), this is an example in which the method of joining the eyeglass frame with the temple tips to the transparent sheet and the film transparent member is a hook; (A) is a perspective view and (B) is a top view.

FIG. 185 149th embodiment of the invention in which the joining method of the embodiment 148 is used in which holes are made in the upper part of the transparent sheet and hooks are passed through them. (A) is a front view of the deployed transparent sheet, (B) is a perspective view of the transparent sheet fixed to the eyeglass frame 1070 with the hooks, and (C) is a top view.

FIG. 186 150th embodiment of the invention: This is an example of a slit-shaped hole 4061 in a transparent sheet 406 with an opening for a mask attachment and a through hole. (A) is a front view thereof.

FIG. 187 151st embodiment of the invention: In this embodiment, the head attachment is made in the form of an eyeglass frame with temple tips and a curved, transparent sheet with an opening in the lower center and a film transparent member 403. (A) and (B) are perspective views, (C) is a top view, and (D) shows a front view of an example in which the head attachment is a single elastic band with a transparent sheet and film transparent 403 having an opening in the center of the bottom.

FIG. 188 152nd embodiment of the invention: (A) is a front view of a film transparent member 403 with a cushion 5 as a head contact area at the top thereof; (B) illustrates placing the rolled invention of (A) into a case; (C) is a front view of the invention of (A) with a hook and loop fastener; (D) is a side cross sectional view of the rolled invention of (C); (E) is a side cross sectional view of the rolled invention of (C); (F) is a side cross sectional view of the rolled invention of (E); (E) is a view of the removable PSA tape made of tetrafluoroethylene resin, (F) is a side cross-sectional view of (E) rolled up, and (G) is a view of the invention of (E) when the tape is attached, with the removable PSA tape made of tetrafluoroethylene resin provided on the transparent film 403 attached to the fingertip. (G) is a view of the invention of (E) when it is attached thereto.

FIG. 189 153 embodiment of the invention: (A) is a perspective view of the head attachment in the form of a plastic or resin head support frame to which a transparent sheet can be attached and detached, and (B) is a top view thereof.

FIG. 190 154th embodiment of the invention: The mask 1 is joined under the film transparent member 403 through the cushion 502 and (A) is a rear view of an example in which tetrafluoroethylene PSA tape 1100 which is 25 mm wide, and 70 mm long is attached to the inside of the mask; (B) is a rear view of an example in which tetrafluoroethylene tape 1101 is attached to the inner edge of the mask and one place in the center is also covered with tetrafluoroethylene tape 1100. (C) is a rear view of an example in which the aforementioned tetrafluoroethylene tape is attached in two places on the inside of the mask; (D) is a rear view of an example in which a heart-shaped tetrafluoroethylene sheet is attached to the inside of the mask; and (E) is a rear view of an example in which a tetrafluoroethylene sheet is attached to the center of the inside of the mask and is approximately the width of the mask.

FIG. 191 As shown in FIG. 177(C) of the 141st embodiment above, this side cross-sectional view shows that the transparent film 403 is cushioned away from the face when worn, so that glasses can also be worn.

FIG. 192 155th embodiment of the invention: The cushion covers the height of the nose, the nose is positioned above the cushion on top of the mask 1, and the transparent film 403 covers the nose, etc. The cushion and transparent film keep exhaled air from escaping and viruses from entering.

FIG. 193 156th embodiment of the invention: This is an example in which a mask made of non-woven fabric, cloth, etc., that is light-shielding or a mask partially made of a material such as tetrafluoroethylene, etc., to a transparent film 403 is connected and in which a portion of the mask that is light-shielding is placed over the eyes and the transparent film 403 is positioned in front of the mouth; (A), (C), and (D) are side cross-sectional views of the mask when worn by a user, and (B) is a developed rear view of a mask provided with a partial material such as tetrafluoroethylene.

### EMBODIMENTS OF THE INVENTION

FIG. 1 is a front view of an individual wearing a mask of the prior art 1. In FIG. 1, a mask 1 is used in which the mouth and nose are covered with mask material. The mask is placed over the ears with an elastic band or temple tips 2. Masks of the prior art can only exclude 70% of viruses. The publicly-known has such defects as as fogging of eyeglasses when breathing, inability to converse, inability to prevent viruses from entering through the eyes, etc. Furthermore, since the publicly-known mask materials are woven or non-woven fabrics of fine resin fibers, the concept of removing viruses with such fiber-based masks makes it difficult to prevent viruses with masks of the prior art since viruses that enter the fiber material of these masks can themselves become a source of viruses, or there is a possibility of very small viruses entering through the mouth. Also, publicly-known masks only cover the mouth and nose and offer no protection for the eyes whatsoever. If viruses enter through the eyes, the virus can enter the lungs through the nose, mouth, and throat because the eyes, the nose and mouth, and the mouth and throat are all interconnected. Masks of the prior art that do not protect the eyes do not provide protection against viruses.

To prevent this, goggles are worn over the eyes in addition to publicly-known masks, but goggles are heavy, their field of vision is narrow, and using goggles and mask mask separately is cumbersome, time-consuming, and costly.

In contrast, the present invention covers the face with a material that is transparent and non-permeable, (specifically acrylic, plastic, vinyl, OHP sheets, etc.).

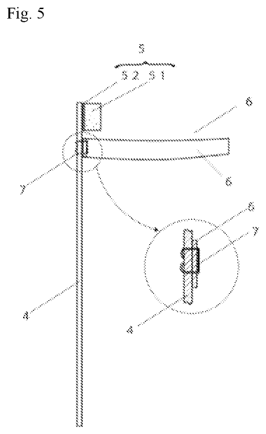

FIGS. 2 and 5 describe a first embodiment of the invention. FIG. 2 shows a view of the invention from the inner surface (the side on which it is worn by a user). A thin transparent sheet (transparent sheet) 4 is used vertically, such as B5 size (182×257 mm), of a size that is large enough to cover the face. A cushioning foam tape is bonded with adhesive to the inside of the top of this thin transparent sheet 4 (i.e., the side on which the face is in close proximity). The ends of one wide elastic band (including buttonhole rubber, round rubber, etc.) 6 are fixed or glued to the left and right sides of the thin transparent sheet 4. The wide elastic band 6 is fixed in the lower position of the cushion part 5. In FIG. 2, the wide elastic band 6 is secured by staples 7 (so-called “Hotchkiss” (registered trademark)) which are driven in from the inside to the outside.

FIG. 5 shows a side view of the first embodiment of the invention, in which staples 71 are driven in from the inside toward the outside to secure one wide elastic band 6 to a thin transparent sheet 4. This prevents injury to the face because the points of the staples do not face the wearer's face.

The material of the transparent thin sheet 4 is a transparent and deformable material. This may be, for example, a flat, bendable sheet made of transparent material such as acrylic, polyester, polyvinyl chloride resin, polypropylene, polyethylene (PE), polystyrene, polyethylene terephthalate (PET), or OHP sheet. The surface and inner surface of the sheet (sheet) are smooth and can be cleaned and sterilized by spraying. A thickness of between 50 microns and 3 mm is preferable. This transparent sheet also includes sheets those with a film-like transparent of about 100 microns. Film transparencies should be 50 to 200 microns thick, especially in FIGS. 157-193, and transparent films of 100 or 75 microns are preferred. The film is preferentially treated with antifog and antireflection (low reflection) treatment. Antifogging is achieved by techniques such as hydrophilic treatment on the film surface, e.g., by coating or blending into the material. To lower the refractive index, a film with a mousseline structure, for example, is layered onto the surface. The film should be thick enough to easily conform to the shape of the face and leave a gap near the mouth and nose to prevent suffocation, e.g., a gap of about 0.2 mm. Covering the front and sides of the face, it can protect not only the mouth and nose, but also the eyes, which is impossible with conventional masks. The size of the thin transparent sheet 4 can be anything other than B5 or A5 and may be used vertically or horizontally. The transparent portion of the thin transparent sheet 4 may be transparent only in the area corresponding to the location of the eyes. This allows for use in applications where the user needs to conceal their face. This thin sheet 4 may also have a curved left-right or up-down curved surface shape.

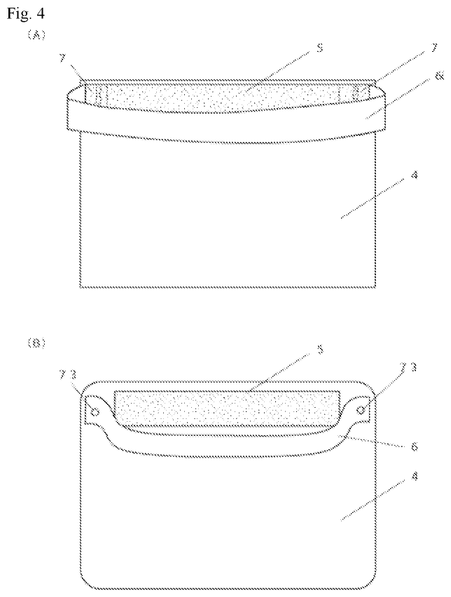

The cushion part consists of a cushion material 51 and an adhesive material 52, which are bonded to the transparent sheet 4 to improve the degree of contact with the face and to prevent viruses and bacteria from entering from the top of the mask. As shown in FIGS. 4 and 5, the cushion material 51 is made of a material such as polyurethane foam that is pleasant to the touch, even after prolonged contact with the forehead. The cushion is, for example, cushioning material 51 that is about 15 mm wide and 10 mm thick.

Also, LEDs can be placed anywhere on the outside in front of the cushion and batteries can be placed anywhere on the inside of the cushion. This makes it useful for reading in the dark or walking in the dark and improves safety because it it renders the user visible to other people. In addition, by applying reflective material to the outside front of the cushion or any other desired location, the mask will stand out to oncoming traffic at night, thus improving safety.

The first embodiment of this invention is a transparent thin sheet 4, which has a very simple structure, is lightweight, requires little storage space, and is light and thin enough to be portable and can be quickly taken out in crowded places to provide complete protection against viruses. Wearing the device does not block the view of the wearer, and even if an individual who is a carrier of the virus is directly in front a wearer of the mask and speaks to the wearer, the mucous membrane areas such as the eyes, nose, and mouth will not be exposed to any droplets or breath, so the device has the effect of 100% protection against viruses and bacteria. Moreover, since the forehead and the cushion part 5 are in close contact to the wearer's face, droplets cannot enter the mask from above and make contact with the eyes. The transparent thin sheet 4 can be used repeatedly by disinfection and sterilization by wiping, so that, for example, if a publicly-known mask costs 20 yen, it will cost about 600 yen per month and about 1,800 yen for three months, since the mask is thrown away after each use. Furthermore, when the mask is worn, the lower part is open so it is possible to engage in normal conversation. Even through the front of the face is covered with a transparent sheet 4, one's view is not obscured because there is an air inlet below. The mask can also be worn with eyeglasses, and the eyeglasses will not fog up. Microbial incursion from below the product is suppressed for the following reasons: (1) Since coronavirus infections are carried by droplets and are not airborne infections, droplets hit the transparent sheet 4 directly, and entry from below the sheet is prevented. (2) Even in the case of airborne infection, in the present invention, the temperature of the surface of the face surface causes the air to expand in between the face and the transparent sheet 4, thus increasing the air pressure above that of the outside air. Furthermore, since the exhaled air has a higher temperature, this further raises the temperature inside the transparent sheet 4, in addition to the temperature of the face. The cushion 5 is in contact with the forehead and the air between the transparent sheet 4 and the face surface will become warmer and expand. In other words, the effect is positive pressurization against external air.

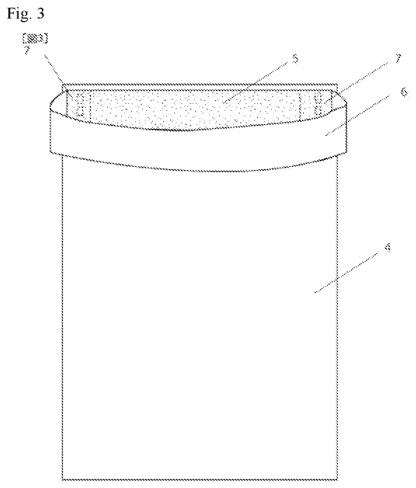

Next, a second embodiment of the invention is described in FIGS. 3, 6, 7, and 9.

FIG. 3 is a view of the invention from the user's side. The transparent thin sheet 4 is long enough (high enough) to cover the face and thin enough to protect, at least, the mouth, nose, and eyes. It offers good visibility because of its transparent. It is provided with a band to hold it onto the wearer's head. The wide elastic band 6 is fixed or bonded near the left and right edges of the thin transparent sheet 4 at its ends. Fixing or bonding can be done on the front or back of the transparent thin sheet 4. If the band is stapled from the outside, the staple points will come out on the face side, which is dangerous and may injure the wearer's face. The staples can be of any size as long as the wide elastic band 6 can be secured to the thin transparent sheet 4. For example, size 3 (with a shoulder width of 11.5 mm, staple length of 6 mm) is preferred. The cushion part 5 is then affixed over the staples. The cushion part consists of a cushion 51 and an adhesive 52. One side of the adhesive 52 is applied to the thin transparent sheet 4 with the staple points sticking out, and the other side is applied to the cushion material 51. The wide elastic band 6 is fixed in the same position as the cushion part 5.

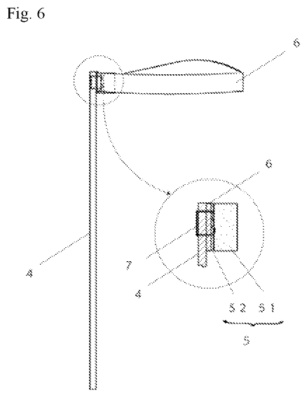

FIG. 6 is a side view of FIG. 3 of the second embodiment, wherein the wide elastic band 6 is set in the same position as the cushion part 5, the staples 7 are driven in from the outside toward the inside, and the wide elastic band 6 is fixed to the thin transparent sheet 4, on which the adhesive 57 and cushion material 56 of the cushion part 5 are attached. This eliminates protrusions on both the outside and inside of the transparent sheet 4, preventing injuries, etc.

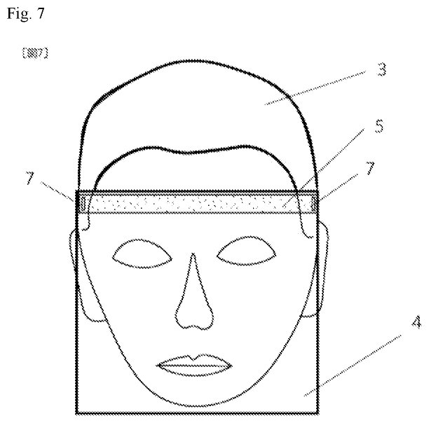

FIG. 7 shows a front view of the second embodiment of the invention worn on the wearer's head face. The transparent thin sheet 4 is a thin sheet that can be deformed to fit the curvature of the face and provides 100% protection against viruses and bacterial droplets. The lower part of the mask is open, and it is through the bottom that the sound waves of conversation are communicated from the outside. The cushion part 5 is shaped and sized to fit snugly against the wearer's forehead to prevent viruses from entering the eyes from over the forehead. The cushioning prevents face pain, and the wide elastic band 6 is wrapped around the head 3 so that it is positioned above the ears. The rubber is strong enough, thick enough, and the temple tips are sized large enough to prevent the thin sheet 4 from slipping off the face.

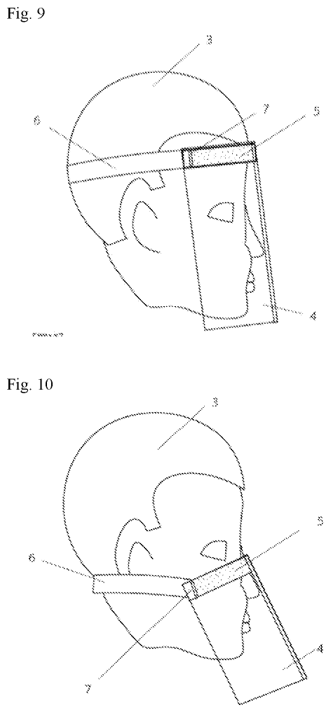

FIG. 9 shows a side view of the second embodiment of the invention attached to the head 3. The thin transparent sheet 4 is on the face and a loop of a wide elastic band 6 is placed on the head 3. Alternatively, the wide elastic band 6 can be attached as a rubber loop and hooked over the ears like masks of the prior art. The thin transparent sheet 4 has a space in front of the mouth, under the nose, and in front of the mouth due to the space created by the cushion 5 and the nose, allowing eyeglasses to be worn in the space in front of the eyes, breathing in the space created in front of and under the mouth, and maintaining a space in front of the eyes, under the nose, and in front of the mouth so that the eyes, mouth, and nostrils do not contact the transparent sheet 4. The lower part below the mouth is open, so nasal and oral breathing is possible, and vapor from the mouth is discharged downward, so neither the transparent sheet 4 nor eyeglasses fog up. Also, since the mask does not come in contact with the face, women can wear it with makeup, so women will be willing to use the present invention in preference to publicly-known masks. The wide elastic band 6 is positioned above the head of the nose, and the top of the transparent thin sheet 4 is bonded to the upper half of the thin sheet 4 so that the top of the thin sheet 4 is closer to the forehead. With a wide elastic band 6, the left and right edges of the thin transparent sheet 4 are drawn toward the back of the head 3, curving it along part of the head, so that there is no gap between the wearer's forehead and the cushion part 5.

According to the second embodiment of the invention, the wide elastic band 6 is fixed in the same position as the cushion part 5, so the cushion part 5 is firmly bonded to the wearer's forehead. Also, since the 72 staples are driven in from the outside toward the inside, neither the outside nor the inside staple points protrude, so there is no risk of injury.

FIGS. 3 and 4 describe a third embodiment of the invention.

FIG. 4 shows an embodiment in which the thin transparent sheet 4 is B5 size (182×257 mm) and is used with the long side to the side. The thin transparent sheet 4 deforms and protects the wearer even in the lateral direction, thus completely preventing splashes from the side without obstructing the lower part from the mouth. In FIG. 4(A), staples 7 are driven in from the outside of the transparent sheet 4 toward the inside, and both ends of a wide elastic band 6 are fixed on top of it and covered with a cushion. In FIG. 4(B), both ends of a wide elastic band 6 are fixed with rivets so that the riveted side 73 is inside the transparent sheet 4.

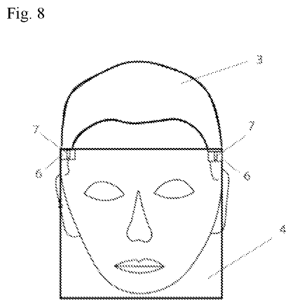

FIG. 8 describes a fourth embodiment of the invention.

FIG. 8 omits the cushion part 5 at the top of the thin transparent sheet 4, and instead is provided with straps, elastic bands, etc. at the top, middle, bottom, or any position of the transparent sheet 4 to attach it to the ear or other part of the head. This makes the invention thinner and lighter, and it can be rolled flat, vertically or horizontally, which is advantageous for storage and transportation, and also reduces costs.

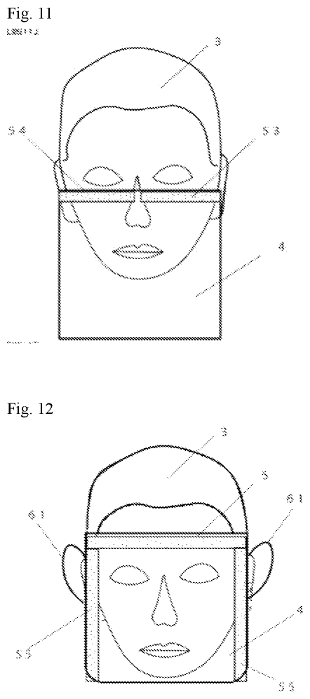

FIGS. 10 and 11 describe a fifth embodiment of the invention.

FIG. 10 is an embodiment of the invention as worn by a user and viewed from the side, worn below the eyes to protect only the nose and mouth. This form is to be used when there is no danger of splashing into the eyes, when large goggles must be worn, or when large eyeglasses need to be worn. In the fifth embodiment, the vertical length of the transparent sheet 4 may be shortened. The transparent sheet 4 may be translucent or opaque. The length of the wide elastic band 6 can be adjusted so that it can be used either to protect the eyes or to cover only the nose and mouth.

FIG. 11 shows a sixth embodiment of the invention as worn by a user and viewed from the front. In the form worn below the eyes, it is necessary to eliminate the gap between the nose and cheeks and the transparent sheet 4 when viewed from above, so the sponge for the height part of the nose is omitted (indented into a V-shape, for example) or divided and provided as a horizontal left cushion part 53 and horizontal right cushion part 54 to improve the adhesiveness between the nose and invention.

The sixth embodiment of the invention can also be used in a form that covers only the nose and mouth. Moreover, the effect of splitting the sponge is that entry of droplets through the gap between the nose and cheeks and the transparent sheet 4 is virtually eliminated.

FIGS. 12-14 describe a seventh embodiment of the invention.

The seventh embodiment of the invention, shown in FIG. 12, is an embodiment in which a vertical side cushion part 55 is provided in three directions inside the top and left and right edges of the thin transparent sheet 4. In FIG. 12, the cushion part 5 at the top of the transparent sheet (transparent thin sheet) 4 is provided inside the transparent sheet to the left and right edges thereof, and the vertical side cushion part 55 is provided inside the transparent sheet to the side of the cushion part 5 at its top edge and to the bottom edge of the transparent sheet at its bottom edge. This yields the world's first mask for infants. The transparent sheet 4 is small, for example, B6 size, and as described in paragraph number [0084], the corners are rounded, and cushions are provided on the left and right edges of the transparent sheet. Since an infant's nose is not developed and is small, the transparent sheet 4 cannot be supported by the infant's nose, and since the infant is almost always looking up, the baby cannot breathe on the transparent sheet 4. Thus, to separate the transparent sheet 4 from the face, a space is created between the face and the transparent sheet 4 by the vertical side cushions 55 on the left and right ends of the transparent sheet 4 and the 5 cushions at the top. For masks for infants, people with smaller noses and people who are sleeping, the cushions 5 and 55 should be thicker, for example 20 mm. As an example of wearing the device on the face, a looped elastic band 61 is attached to the left and right ears, and the left and right edges of the transparent thin sheet 4 are pulled, thus curving the transparent thin sheet 4. The vertical side cushions 55 prevent viruses and bacteria from entering from the top and sides of the mask.

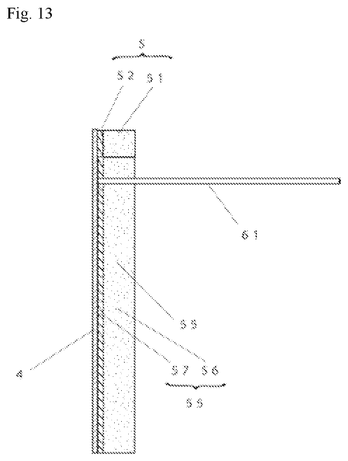

FIG. 13 is a seventh embodiment of the invention viewed from the side. The longitudinal side cushion part 55 is attached so that it contacts the bottom of the top cushion part 5 and consists of cushioning material 56 and adhesive 57. The length of the vertical side cushion part 55 may be the same as the vertical length of the thin transparent sheet 4 with the addition of the top cushion part 5, or it may be of a length to touch the corners of the eyes and cheeks, depending on the size of the user's face. The looped elastic band 61 may be made of commercially available elastic bands.

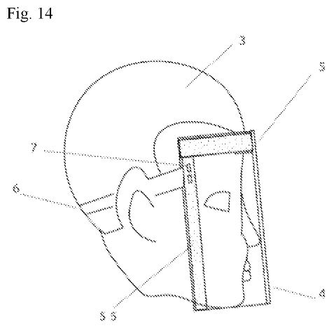

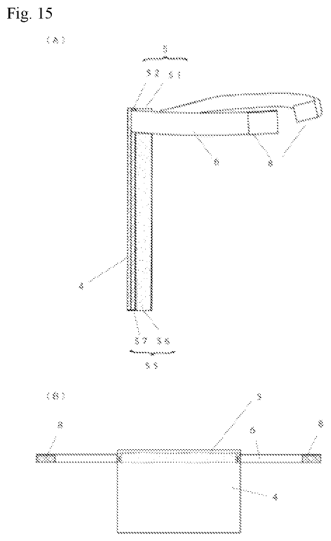

FIG. 14 is an eighth embodiment of the invention viewed from the side. In FIG. 12, the method of attachment to the user is an example of retention by means of a wide elastic band 6. The forehead, temples, and cheeks of the wearer should all be in contact with the cushions, which is just as effective in protecting against splashed particles as the indicated above.

According to the seventh and eighth embodiments of the invention, a longitudinal side cushion part 55 is also provided on the side of the wearer's face, so there is no breath or air that can be entrained from the side, thus further protecting against infection.

FIG. 15 describes a ninth embodiment of the invention. FIG. 15 shows a ninth embodiment of the invention, (A) with a cushion part 5 and a vertical side cushion part 55, viewed from the side, and (B) with a cushion part 5, viewed from the front, with two wide elastic bands on either side of the transparent sheet 4, instead of one wide elastic band 6, each end having a Velcro (registered trademark) (hook and loop fastener or other binding part) strip 8.

In the ninth embodiment of the invention, the headband can be adjusted to the size of the wearer's head by using elastic bands and hook and loop fasteners, etc., so that the wearer can freely adjust the headband without feeling a sense of tightness, and the headband can be easily removed without disturbing the wearer's hair when putting on and taking off the headband.

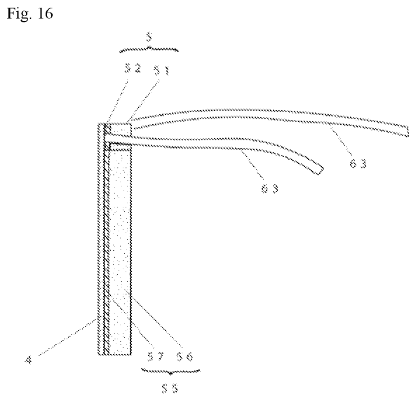

FIG. 16 describes a tenth embodiment of the invention. FIG. 16 shows a side view of the tenth embodiment of the invention, in which the band is made of string (including loops) instead of a wide elastic band 6, allowing the wearer to attach the transparent sheet 4 to the appropriate tightness, regardless of the size of the user's head.

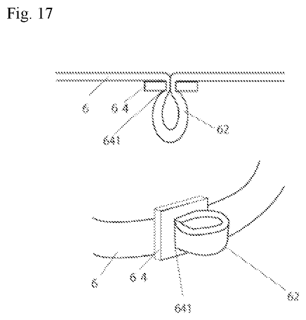

FIG. 17 is an 11th embodiment of the invention. The wide elastic band 6 should be long enough to be longer than the size of a typical head, and the length of the wide elastic band 6 can be adjusted by pinching the middle 62 of the wide elastic band 6, inserting the middle 62 of the wide elastic band 6 into the slit 641 of a length adjusting device 64, provided separately with a slit 641 in the middle thereof made of elastic or the like and then pulling out the wide elastic band 62. The slit 641 can tighten the end of the pulled-out wide elastic band 62 and adhere to the length of the wide elastic band 6. This allows the invention with wide elastic bands 6 of the same length to be used by people with various head sizes. In this case, a band or string can be used in this 11th embodiment in place of a wide elastic band 6.

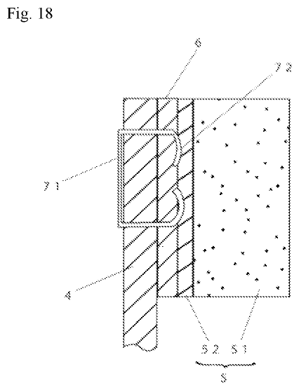

FIG. 18 is a 12th embodiment of the invention, showing the adhesive fixing structure of the transparent sheet 4, the wide elastic band 6, and the cushion part 5. The end of the wide elastic band 6 is placed on the inside side of the transparent sheet 4, the side facing the user's face, and secured with a staple 7. The staples 7 are driven in vertically from the outside of the transparent sheet so that the staple point 71 is on the outside of the transparent sheet 4 and the staple point 72 is on the wide elastic band 6. The cushioning material 51 is bonded with adhesive 52 to the end of the wide elastic band 6 and on the staple point 72. Thus, the staple point 72 is sandwiched between the sponge part 7 and the elastic band 6. The end of the wide elastic band 6 installed on the inner side of the transparent sheet 4 may be about 20 mm wide and is installed about 2 mm below the upper edge of the side of the transparent sheet 4 and about 5-20 mm inside the side edge of the transparent sheet 4. The staple points 7 should be driven into the approximate center of the contact area between the wide elastic band 6 and the transparent sheet. For example, their position should be 1-10 mm from the edge of the 4 transparent sheet sides, but not limited to this. The installation position of the end of the wide elastic band 6 and the staples should be close to the side edge of the transparent sheet side, otherwise the elastic band is likely to detach or the transparent sheet may crack. It is undesirable for the staple to be inserted too far from the side edge of the transparent sheet (too far to the inside), because the stapple could block the wearer's view, or the transparent sheet cannot be curved sufficiently, leaving many gaps between the side of the transparent sheet and the sides of the wearer's head. It would also increase the cost of the elastic band. Note that the elastic band 6 may be installed on the outside of the transparent sheet 6. As described above, the wide elastic band 6 is securely fixed to the transparent sheet, and the staple points 72 are sandwiched between the sponge part 7 and the elastic band 6, so that the staple points are safe and do not cause injury to the wearer's face.

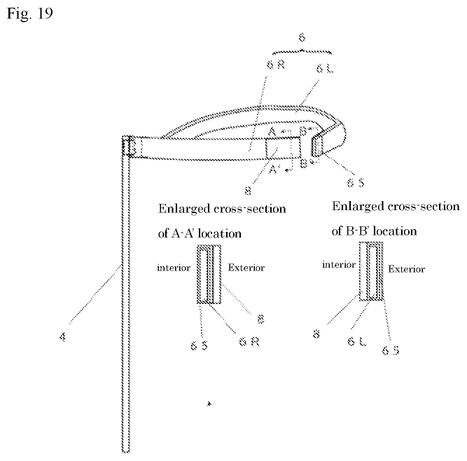

FIG. 19 is the 13th embodiment of the invention, showing an anti-fraying tape 65 that is wrapped around the ends of the wide elastic band (right) 6R and the wide elastic band (left) 6L attached to the left and right sides of the transparent sheet 4, and at the other ends of the two wide elastic bands 6L, 6R described above, at right angles to their length direction. The reason for wrapping anti-fraying tape 65 is that the ends of a long wide elastic band 6 will fray if they are cut short in the manufacturing process. The anti-fraying tape 65 may be masking tape, paper, or other material, and may be about 10 mm wide. The wide elastic band (right) 6R and the wide elastic band (left) 6L, which are prevented from fraying by the aforementioned elastic band anti-fraying tape 65, and the Velcro (registered trademark) strip 8, which is about 40 mm long and 20 mm wide, are attached to the anti-fraying tape 65, as shown in the enlarged cross section. The Velcro (registered trademark) strip 8 is affixed to the outside of the end of one wide elastic band (right) 6R, which is attached to the left and right sides of the transparent sheet 4, and Velcro (registered trademark) strip 8 is attached to the inside of the end of the other wide elastic band (left) 6L. The ends of the wide elastic band and Velcro (registered trademark) may be stapled together so that the staples are bent closed facing outward. This prevents the Velcro (registered trademark) and the wide elastic band from detaching due to repeated use.

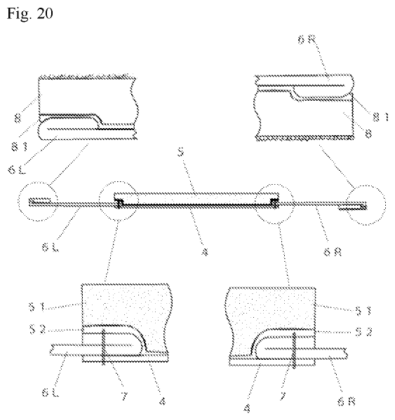

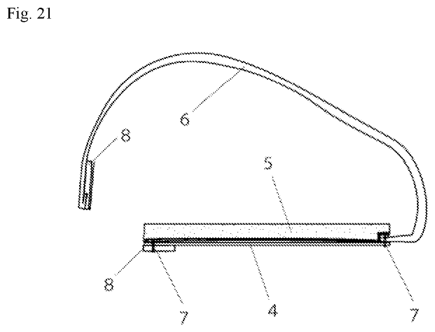

FIG. 20 is a 14th embodiment of the invention and shows the structure of the wide elastic band 6 (6L, 6R) with the edge of the wide elastic band fixed to the transparent sheet 4 and/or the edge of the wide elastic band to which a Velcro (registered trademark) strip 8 is bonded and folded back to prevent fraying of the wide elastic band 6. Specifically, the end of the wide elastic band (left) 6L, which is fixed to the transparent sheet 4, is folded back about 2˜7 mm and fixed to the transparent sheet 4 with a staple 7, and the folded end of the wide elastic band is bonded to the cushion material 51 with adhesive 52 in the cushion part 5. The end of the wide elastic band (left) 6L, which is bonded to the Velcro (registered trademark) strip 8, is also folded back by about 2˜7 mm, and the folded back wide elastic band end is bonded to the Velcro (registered trademark) strip 8 with adhesive 81. Similarly, the end of the wide elastic band (right) 6R is also fixed to the transparent sheet 4, bonded to the cushion part 5, and bonded to the Velcro (registered trademark) strip 8. Fraying of the ends of the wide elastic band can be further prevented without compromising appearance by folding back the wide elastic band 6.

FIG. 21 is a 15th embodiment of the invention. While the ninth embodiment was an example in which two wide elastic bands 6 were attached to the left and right sides of the transparent sheet 4, the fifteenth embodiment uses only a single wide elastic band 6. As shown in FIG. 21, one end of one wide elastic band 6 is fixed to the transparent sheet 4 with staples 7, etc., and a Velcro (registered trademark) strip 8 is provided at the other end of the elastic band, and a Velcro (registered trademark) strip 8 corresponding to this Velcro (registered trademark) strip 8 is provided at the other end of the transparent sheet 4 that is not the part provided with the wide elastic band 6. This allows the Velcro (registered trademark) strip 8 to be fastened at the side of the head when worn, making it easier to use. Furthermore, there is no need to divide the wide elastic band 6 into two parts as in the ninth embodiment, simplifying the manufacture of the band.

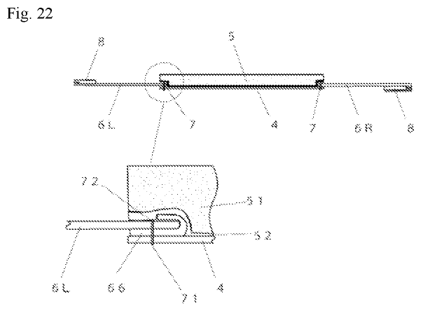

FIG. 22 shows 16th embodiment of the invention, in which the end of the wide elastic band 6 (6L, 6R) fixed to the transparent sheet 4 in the 14th embodiment is not folded back, but the structure is such that the double-sided tape 66 is attached to the end of the wide elastic band 6 (6L, 6R). Specifically, the back side from the surface of the end of the wide elastic band 6L may be covered with double-sided tape 66 so as to wrap the end cut surface of the wide elastic band 6L, and the surface of the end of the wide elastic band 6L is bonded to the transparent sheet 4. A staple 7 is then inserted from the transparent sheet side to fix the edge of the wide elastic band 6L and the transparent sheet 4. Further, adhesive 52 is used to bond the end of the wide elastic band 6L and the staple tips 72 to the cushioning material 51. Double-sided tape 66 on the side (surface) of the wide elastic band 6 end that contacts the transparent sheet 4 is approximately the same width as the elastic band and may be 5-20 mm long, and it is bonded to the surface of the wide elastic band. Double-sided tape 66 on the side (surface) of the wide elastic band 6 end that contacts the transparent sheet 4 is approximately the same width as the elastic band and may be 5-20 mm long, and it is bonded to the surface of the wide elastic band. By applying double-sided tape 66 to the front of the elastic band along its length and the back along its short length and wrapping the cut ends, the end of the wide elastic band can be securely fastened to the transparent sheet without fraying, and the bond with the cushion becomes stronger and more attractive.

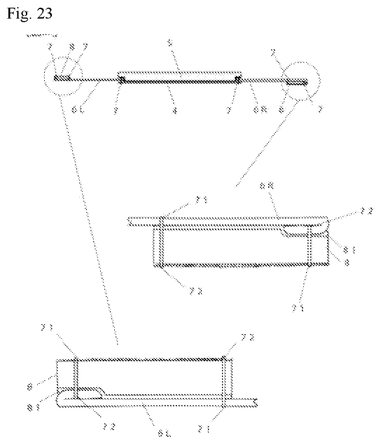

FIG. 23 shows a 17th embodiment of the invention, in which both ends of the Velcro (registered trademark) strip 8 are secured with staples to prevent the Velcro (registered trademark) strip 8 from peeling off from the wide elastic band 6. The following is a detailed description made with reference to the enlarged cross-sectional view of the stapled part shown in FIG. 23. The wide elastic band 6R is folded back at the end. The elastic band at the folded back portion is bonded to the Velcro (registered trademark) strip 8 with Velcro (registered trademark) adhesive 81. At one end of the Velcro (registered trademark) strip 8, a staple 7 is inserted so that the head of the staple 71 is on the surface of the Velcro (registered trademark) strip 8. The tips 72 of the staple are secured to the folded back portion of the wide elastic band 6R. Specifically, the edge of Velcro (registered trademark) strip 8 and the edge of the elastic band may be bonded with adhesive 81, the staple is inserted into the bonded Velcro (registered trademark) strip 8 edge, the elastic band 6R edge is folded over, and the Velcro (registered trademark) strip 8, staple points, and elastic band 6R are bonded with adhesive 81 to create the structure shown in this enlarged cross-sectional view. At one end of the Velcro (registered trademark) strip 8, a staple 7 is inserted so that the head of the staple 71 is on the surface of the Velcro (registered trademark) strip 8. This has the effect of preventing the adhesive from peeling between the wide elastic band 6 and the Velcro (registered trademark) strip 8 due to the opening and closing of the Velcro (registered trademark), preventing the wearer's head or hands from being injured by the staple points as the staple is driven in from the specified direction, and preventing the elastic band from fraying at the edge of the wide elastic band 6R. The structure of the elastic band 6R and the Velcro (registered trademark) strip 8 is described above, and the structure of the elastic band 6L and Velcro (registered trademark) strip 8 is similar thereto. Securing the other end of the Velcro (registered trademark) strip 8 with a staple can be omitted. The Velcro (registered trademark) and a wide elastic band may be stapled together in one or more places.

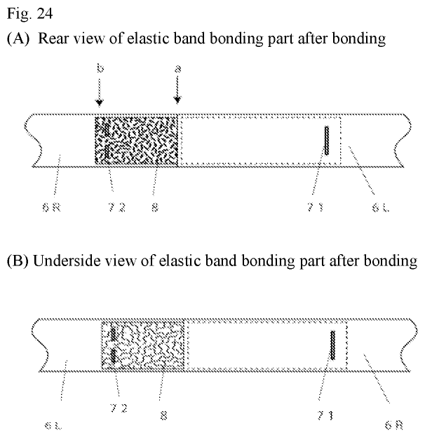

FIG. 24 shows the 17th embodiment (FIG. 23) when the elastic bands 6R and 6L are fastened at the back of the wearer's head. FIG. 24(A) shows a view of who the elastic bands 6R and 6L are joined at the back of the wearer's head from the rear, and FIG. 24(B) shows a view of the join of the elastic bands 6R and 6L from the back of the wearer's head (viewed from inside of where the elastic bands are joined). A Velcro (registered trademark) strip 8 is fixed to the elastic bands 6R and 6L, respectively. The dotted line indicates the Velcro (registered trademark) strip 8 fixed to 6L. The tips of the elastic bands 6R, 6L are also secured with Velcro (registered trademark) with staples as shown in FIG. 23. To separate the 6R and 6L elastic bands by peeling off the Velcro (registered trademark) strip 8 on the 6R and 6L elastic bands, the user pulls the 6L elastic band at location “a” to peel it off. Here, the respective pieces of Velcro (registered trademark) strip 8 are stapled to the elastic bands 6L and 6R, so they do not come off. Also, since the staples are located at both ends of the Velcro (registered trademark) strip 8, the Velcro (registered trademark) strip 8 will not peel off from the elastic band even if the Velcro (registered trademark) is joined so that the a and b positions are nearly in the same location.

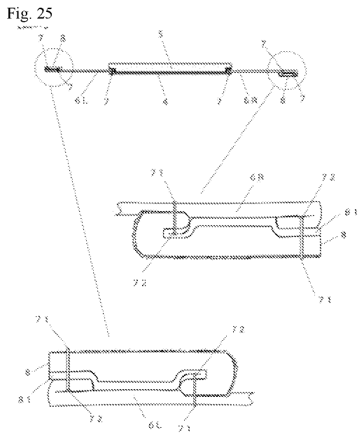

FIG. 25 shows an 18th embodiment of the invention, in which Velcro (registered trademark) strip 8 is stapled to prevent it from peeling off from the wide elastic band 6, and the edge of the Velcro (registered trademark) strip 8 and the edge of the elastic band 6 are each folded back and bonded. The following is a description of an enlarged cross-sectional view of the portion where the elastic band 6R and the Velcro (registered trademark) strip 8 are fixed with staples. The structure of one end of the Velcro (registered trademark) strip 8 strips is identical to that described in FIG. 23 and is therefore omitted here. The structure of the other end of the Velcro (registered trademark) strip 8 strip is folded back at the other end of the Velcro (registered trademark) strip 8, and the folded part is fixed with staples 7. The staple 71 is driven to level of the surface of the elastic band 6. The points 72 of the staple are fastened to the folded portion of the Velcro (registered trademark) strip 8.

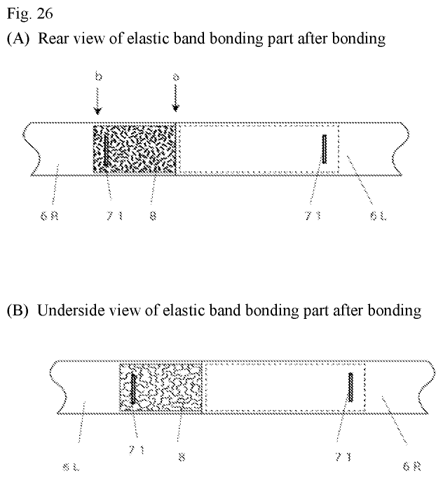

FIG. 26 shows a view of the first embodiment (FIG. 25) of the invention wherein the elastic bands 6R and 6L are joined at the back of the wearer's head with a Velcro (registered trademark) strip 8. FIG. 26(A) shows a view of who the elastic bands 6R and 6L are joined at the back of the wearer's head from the rear, and FIG. 26(B) shows a view of the join of the elastic bands 6R and 6L from the back of the wearer's head (viewed from inside of where the elastic bands are joined). In the 18th embodiment of the invention, the stapling direction at the other end of Velcro (registered trademark) strip 8 is different than that shown in FIG. 24 of the 17th embodiment of the present invention, as shown in FIG. 26, which is the staple head 71 on the surface of the Velcro (registered trademark) strip 8. Therefore, in location “b”, not only do the Velcro (registered trademark) strip 8 strip and the elastic band 6 not peel off, but the staples on the surface of the Velcro (registered trademark) strip 8 have the additional effect of preventing injury to the wearer.

The 19th embodiment of this invention is to color the surface of the staple head 71 to match the color of the Velcro (registered trademark) strip 8 surface and the color of the elastic band surface. For example, if the Velcro (registered trademark) strip 8 strip and the elastic band 6 are black, black epoxy resin is applied to the surface of the staple 7 which is then driven in. This makes the staple 7 black in color, which is the same as the Velcro (registered trademark) and the elastic band, so it looks good and the staple is inconspicuous. In addition, the use of epoxy resin means that there is virtually no color fading.

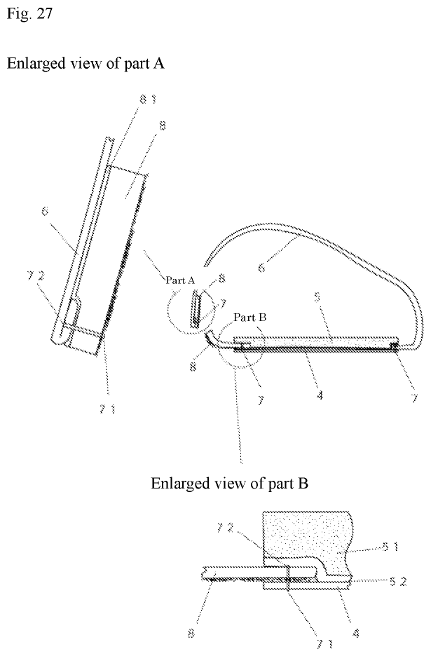

FIG. 27 shows a 20th embodiment of the invention, in which one Velcro (registered trademark) strip 8 strip is bonded to the transparent sheet 4 and the other a Velcro (registered trademark) strip 8 strip is bonded to the end of the wide elastic band 6 to prevent the Velcro (registered trademark) strip 8 strip from peeling off from the wide elastic band 6. The 20th embodiment uses only a single wide elastic band 6. One end of the wide elastic band 6 is fixed to the transparent sheet 4 with staples 7 or the like, and a Velcro (registered trademark) strip 8 strip is provided at the other end of the elastic band, and the end of the Velcro (registered trademark) strip 8 corresponding to this Velcro (registered trademark) strip 8 strip which is fixed with staples to the inside of the transparent sheet 4 at the other end that is not the part with the wide elastic band 6 of the transparent sheet 4. The enlarged view of part A in FIG. 27 shows a cross-sectional view at the location where the staple penetrates. A Velcro (registered trademark) strip 8 is fixed to the elastic band 6 with staples and adhesive 81 so that the strip faces the wearer's head, and the edge of the elastic band 6 is folded back so that the staple points do not protrude on the surface thereof.

The enlarged view of part B in FIG. 27 shows a cross-sectional view at the location where the staple penetrates. The Velcro (registered trademark) strip 8 has no adhesive 81 provided on it and is fixed to the transparent sheet 4 with staples, and the staple points and Velcro (registered trademark) strip 8 are also attached to the cushion material 51 with adhesive 52. The lengths of the elastic band 6 and the Velcro (registered trademark) strip 8 are adjusted so that the Velcro (registered trademark) strip 8 on the elastic band and the Velcro (registered trademark) strip 8 fixed to the transparent sheet 4 can be joined at the side head of the person wearing the invention. This constitution has the effect that when removing this mask by peeling off the bonded Velcro (registered trademark) strip 8, neither the Velcro (registered trademark) strip 8 on the elastic band 6 nor the Velcro (registered trademark) strip 8 which is affixed to the transparent sheet 4 is peeled off from the elastic band or the transparent sheet because they are secured with staples, etc. Furthermore, when wearing the mask, the Velcro (registered trademark) strip 8 can be fastened on the side of the head, making it easier to use. Furthermore, there is no need to divide the wide elastic band 6 into two parts as in the ninth embodiment, simplifying the manufacture of the band.

FIG. 8 shows the 21st embodiment of the invention, in which there is no cushion part 5 on the top of the transparent sheet 4, but only on the side with a vertical side cushion part 55. This makes it easier to curve the transparent sheet 4 in the lateral direction. This allows the vertical side cushion part 55 to adhere more closely to the face at the sides of the head, preventing viruses and bacteria from entering from the sides.

FIG. 29 is the 22nd embodiment of the invention, showing the left and right cushions 55 or the lower cushion part 58 of the transparent sheet 4 in addition to the head pad 5 of the transparent sheet 4. This increases the temperature and pressure in the space between the face and the transparent sheet 4, thus preventing viruses from entering. Moreover, the 154th embodiment of the invention is one in which the cushion part is provided with a material such as tetrafluoroethylene PSA tape that prevents makeup from adhering to the cushion part to prevent makeup from coming off.

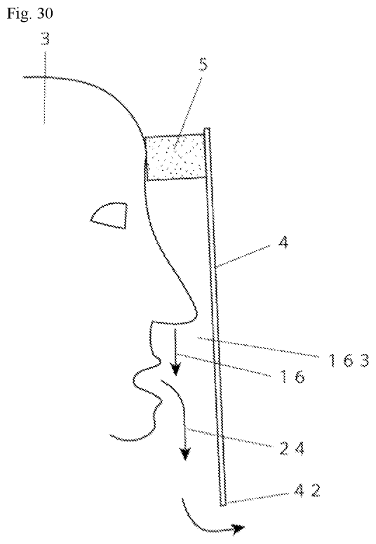

FIG. 30 figure shows the invention when speaking 24 and breathing 16. Breathing 16 and speech 24 are transmitted to the outside through the bottom 42 of the transparent sheet 4, which indicates that respiration is also possible.

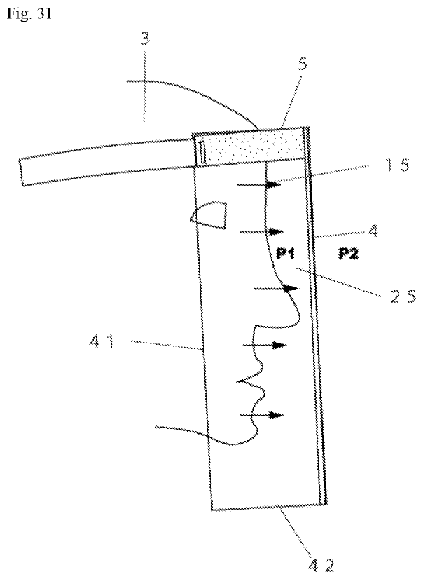

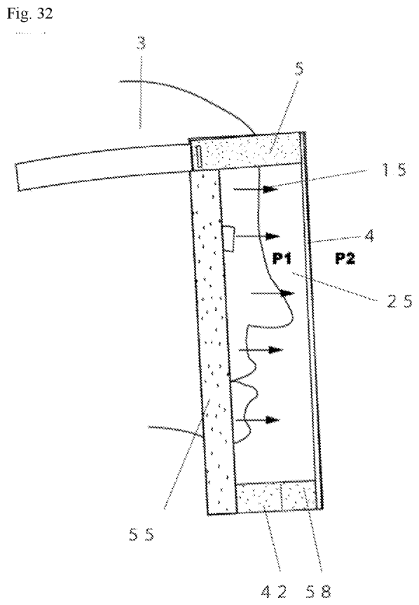

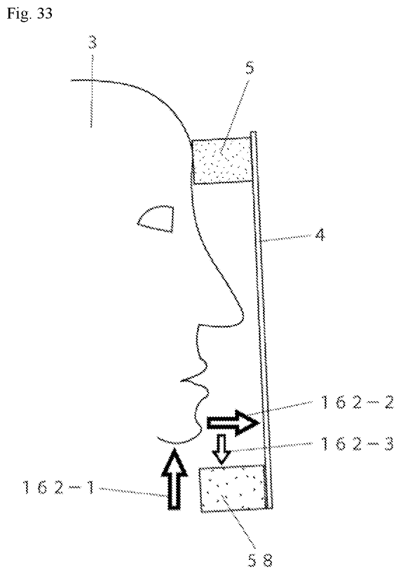

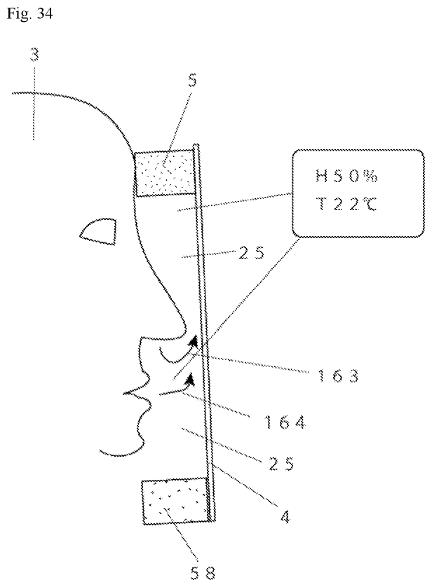

FIG. 31 illustrates the working principles of the invention. It would seem that viruses and bacteria, such as coronaviruses, could enter through the side 41 and the bottom 42 of the transparent sheet 4, but this invention is designed precisely to prevent that from happening. The rationale is that the invention elevates the air temperature in the space 25 formed between the transparent sheet 4 and the face due to the heat 15 generated from the face by body heat. This makes the air pressure P1 in space 25 higher than the air pressure P2 outside the transparent sheet 4, thus preventing coronaviruses and other viruses and bacteria from entering from the side 41 and bottom 42 of the transparent sheet 4.

FIG. 32 illustrates the principle of operation of the invention. The upper cushion part 5, vertical side cushion part 55, and lower cushion part 58 are provided on the transparent sheet 4 in the 22nd embodiment, and air outflow from the side 41 and bottom 42 of the transparent sheet 4 is suppressed, and the temperature in this space rises. The pressure in the space between the transparent sheet 4 and the face is increased beyond that in the second (FIG. 3) and third (FIG. 4) embodiments of the invention, and the pressure difference between P1 and P2 can be increased, further preventing bacteria and viruses from entering the space.

FIG. 33 illustrates the function of the lower cushion 58. The flow of outside air between the lower cushion 58, the transparent sheet 4, and the face is blocked by the square shape of the sheet which changes the direction of flow three times as shown by the white arrows. 1. Hitting the chin (162-1); 2. Hitting the transparent sheet 4 (162-2); 3. Hitting the lower cushion part 58 (162-3)

This can prevent the incursion of viruses and bacteria.

FIG. 34 illustrates the coronavirus protection operating principle and effect of the invention due to humidity and temperature increase in a side view of the invention as worn by a user. In FIG. 34, the humidity of the space 25 formed by the transparent sheet 4 and the face increases due to the humidity 163 contained in the exhaled air, and the temperature increases due to the heat 15 generated from the face by the body temperature. The inventor's experiments have confirmed that the humidity and temperature can be above 50% and 22° C., respectively (with a body temperature of 36° C.). Since it has been found that coronaviruses are destroyed at humidity of 50% or higher and temperatures of 22° C. or higher, even if coronaviruses get in under the transparent sheet 4, they will be destroyed before they reach the nasal cavity or retina of the individual, which is the working principle of the invention. Moreover, the destruction of coronaviruses is further increased by sunlight entering the space between the face and the transparent sheet.

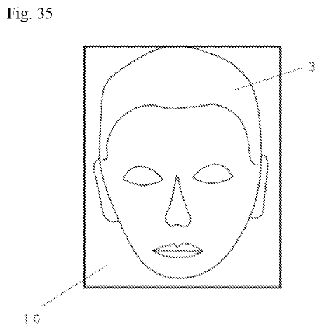

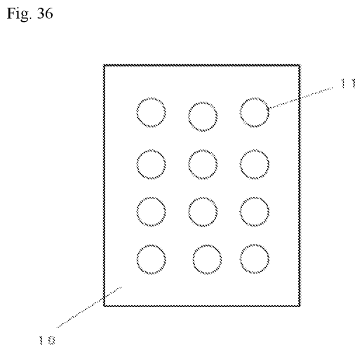

FIGS. 35 and 36 illustrate the second and third embodiments of the invention.

FIG. 35 shows a front view of a 23rd embodiment of the invention worn on the head 3. A transparent bag 10 that allows breathing from the bottom and back of the head is placed completely over the user's head 3. The transparent bag 10 is wider than the user's head 3 and the bottom edge comes below the chin when worn. The material of the transparent bag 10 can be vinyl or polyethylene, as long as the transparent surface is made of a material that is impervious to air and water. There are no limitations on the thickness of the transparent bag 10, but it should be thick enough not to obstruct the mouth and nose, e.g., 30-300 microns in thickness. For example, commercially available bags having a thickness of 100 microns can also be used.

In FIG. 3, 6 is a rear view of the transparent bag 10 as placed over the head 3 from the rear of FIG. 35. The transparent bag 10 has many holes on the back side of the wearer's head to allow air to enter. There are no limitations on the number or size of the holes. For example, 3 rows×4 columns of circular holes of about 20 mm diameter can be provided.

In the 23rd embodiment of the invention, the entire head is completely covered by a transparent bag, which can be rapidly and easily put on and removed, and which completely shuts out the spray of droplets from the front and sides. The bag is lightweight, easy to carry, store, and transport, simple, inexpensive, and can be reused by sterilization.

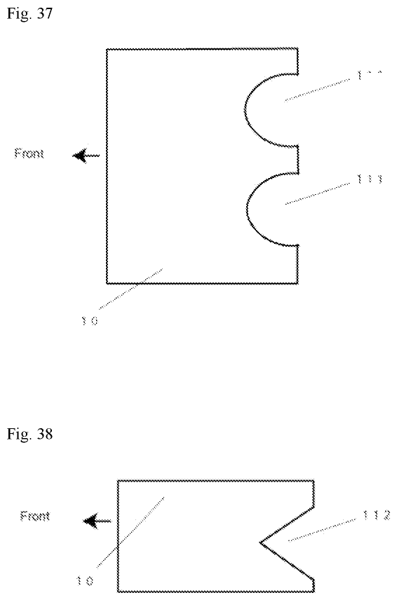

The second and fourth embodiments of the invention are illustrated in FIG. 37. FIG. 37 shows a side view of the invention. The back part of the transparent bag 10 (on the back of the head when worn) has two large, semicircular holes 111. Holes can be made in a single step by folding and cutting the center of the transparent bag 10. The transparent bag 10 is then placed over the user's head 3 so that the unopened side (left side in FIG. 37) covers the eyes, nose, and mouth. There will be two holes on the rear of the head when the transparent bag 10 worn by the user.

In the second and fourth embodiments of the invention, the opening for breathing is formed by cutting a transparent bag by utilizing the folded portion of the bag, so it can be easily made from commercially available transparent bags.

FIGS. 35 and 36 illustrate the second and third embodiments of the invention. FIG. 38 is a side view of the transparent bag 10, with the top and bottom of the bag 10 folded to produce the 25th embodiment. The rear of the transparent bag 10 (on the back of the head when worn) is folded and incised to form a straight rhombus 112. In the case of embodiment 25, there is no need to make a round shape, so the shape is simple and can also be made on site without a mold by cutting it with scissors.

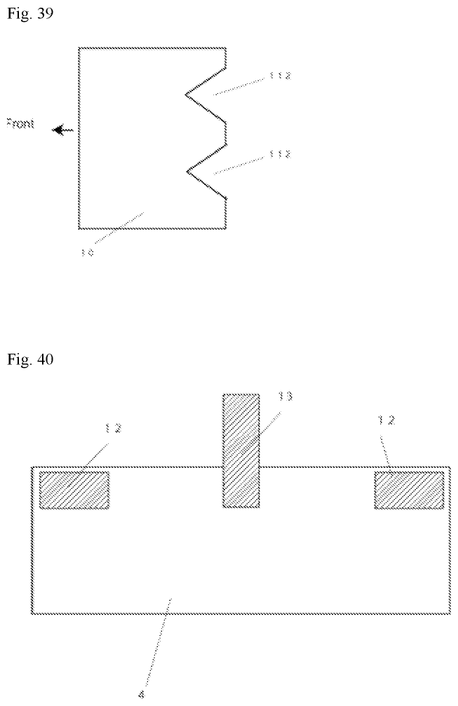

FIG. 39 is a side view of the completed invention by opening the fold in FIG. 38.

In FIG. 38, it is deleted into a rhombus shape, so that two large rhomboid openings are formed at the back of the transparent bag 10. The transparent bag 10 is then placed over the user's head 3 so that the unopened side of the folded portion (left side in FIG. 39) covers the eyes, nose, and mouth.

In the notch approach, the bag is folded once up and down in this embodiment, but it can be folded many times or to the left or right to form apertures in more numerous and different positions, which is also included in this embodiment.

In the 25th embodiment of the invention, the effect is obtained by overlapping and cutting the bag in a straight line so it is possible to easily provide multiple even openings in the back portion of the transparent bag 10 (on the back of the head when worn). The head can be securely held in place, and holes are provided for proper air circulation. Moreover, the lightweight and foldable design of the device also allows it to be carried in a pocket or stored, and it can be used in a crowded place in a hurry.

FIGS. 40, 41, and 42 illustrate the second and sixth embodiments of the invention. FIG. 40 shows an unfolded transparent sheet of the 26th embodiment of the invention. A plurality of adhesive areas 12 is provided at the top edge of the thin transparent sheet 4. In addition, adhesive tape 13 is provided at the top center thereof. This is, for example, a single-sided adhesive tape 13 of 10 mm×50 mm foam. The transparent thin sheet 4 is used horizontally, for example, B4 size.

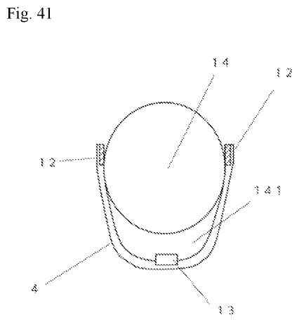

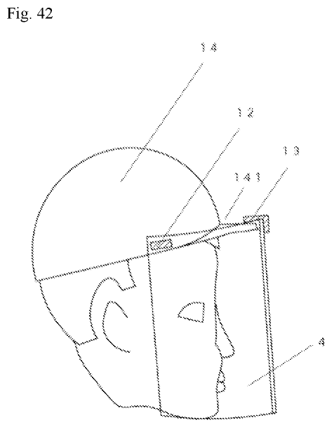

FIGS. 41 and 42 show the transparent sheet of FIG. 40 bonded to a conventional hat, sun visor, etc. and viewed from the top, and FIG. 40 from the side. For bonding, the double-sided adhesive tape 12 in FIG. 40 is bonded to the transparent sheet on one side and to the left and right sides of the hat 13 on the other side, and the tape 13 in FIG. 40 is bonded to the center of brim 141. The bond in the center of the brim 141 is made by bonding the top of the brim to the L-shaped tape 12 shown in FIG. 42. The wearer's face is protected by the transparent sheet 4 by wearing a hat 14 or other garment.

The hat 13 may be a sun visor, helmet, or the like. Any object that can be worn over the head 3 and can support a transparent thin sheet 4 is included in the invention.

The 26th embodiment of the invention is to be worn without the wide elastic band 6, and can be worn by utilizing an existing hat, sun visor, etc. 14 or by making this part of a specially-made hat. The wearer can easily put it on and remove it, and it can be simplified by using existing hats.

The 27th embodiment of this invention is to form it three-dimensionally like a toy mask and transform it so that the eyes are transparent and there are no holes in the eyes, nose, and mouth parts.

FIG. 43 shows the 28th˜32nd embodiments of the invention, in which LEDs are installed therein.

FIG. 43 (A) is a front view of the 28th embodiment of the invention, in which an LED is installed in the upper center of the transparent sheet 4 and a battery is installed next to the LED. The LED 17, battery 18, and switch 181 are connected by wiring 19. The LED and battery are provided and secured on the adhesive surface of the wide cushion part 59 and the transparent sheet 4. The light from the LED 17 is emitted through the transparent sheet 4. This allows the wearer's front to be illuminated from the top of the transparent sheet 4.

FIG. 43 (B) is a front view of the 29th embodiment of the invention, with LEDs on the top of both sides of the transparent sheet 4 and a battery 18 in the center of the cushion part 5. The LED 17, battery 18, and switch 181 are connected by wiring 19. The light from the LED 17 is emitted through the transparent sheet 4. This affords wide illumination of the front, including the sides.

FIG. 43 (C) is a top view of the 30th embodiment of the invention, in which LED 17 is mounted on the front of transparent sheet 4 and battery 18 is provided on the adhesive surface of the cushion part 5 and transparent sheet. Wiring 19 runs through the transparent sheet 4 to the LED 17, the battery, and a switch. This has the effect of obtaining more illumination since light is emitted directly instead of through the transparent sheet 4 in FIG. 43 (A).

FIG. 43 (D) is a front view of the 31st embodiment of the invention, with LED 17 on the top of the upper surface of the transparent sheet 4. The cushion part 5 is then bonded to the top of the transparent sheet 4, and the LED 17 is bonded to the center of the top edge of the cushion part 5. Batteries and switches may be located in any position. More than one LED 17 may be installed. This allows for direct illumination and illumination from the top, which provides strong illumination over a wide area.

FIG. 43 (E) is a top view of the 28th embodiment of the invention, in which the LED 17 is located inside the transparent sheet 4 in the cushion part 5. Light is emitted through the transparent sheet 4. This means that even if the mask is subjected to vibration or shock, the LED 17 will not malfunction because it is within the cushion part 5.

FIG. 43 (F) is a front view of the 32nd embodiment of the invention, in which LED 17 is placed under the cushion on the upper surface of the transparent sheet 4. Batteries and switches may be located in any position. More than one LED 17 may be installed.

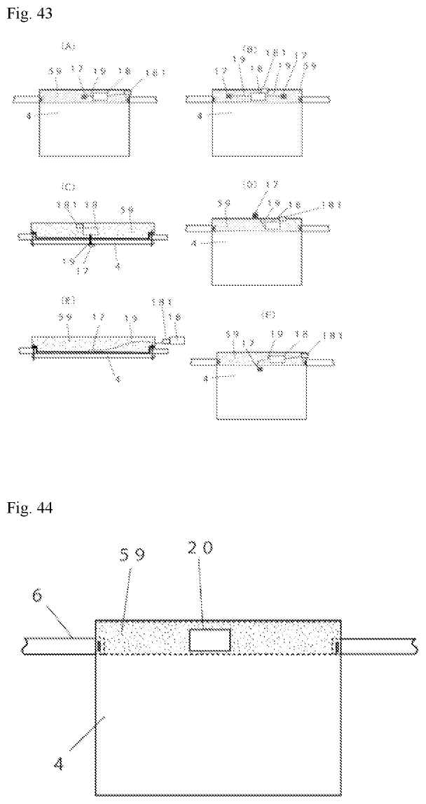

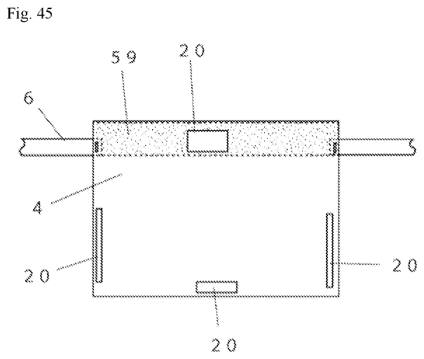

FIG. 44 is a front view of the 33rd embodiment of the invention, with reflective or phosphorescent material 20 bonded to the top of the transparent sheet 4. This makes it safe to wear the mask in the dark because the reflector shines due to headlights of cars, etc.

FIG. 45 is a front view of the 34th embodiment of the invention, with the reflective or phosphorescent material 20 bonded to the outside of the transparent sheet 4 in the upper cushion, vertical side cushion and/or lower cushion locations.

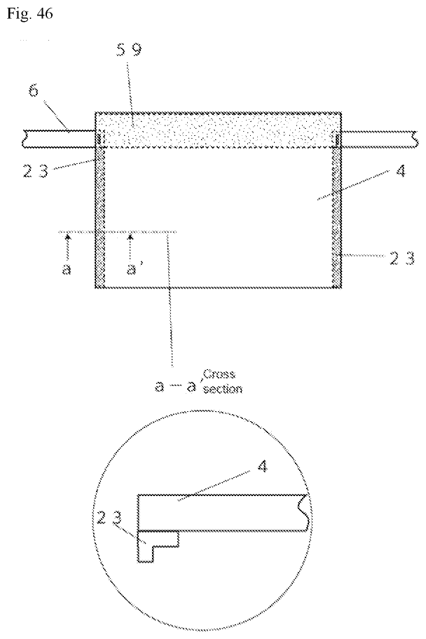

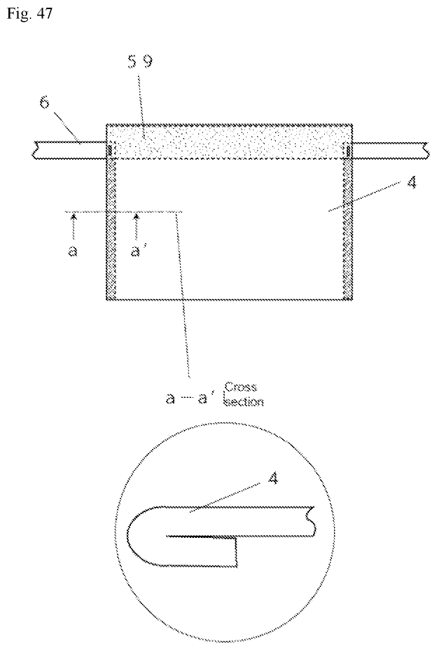

FIG. 46 is an embodiment of the 35th embodiment of the invention. The front view shows an L-shaped member 23, as shown in the a-a′ cross section, on the inside of the transparent sheet 4 at the edge of the vertical side. The L-shaped member 23 may be made of rubber or plastic. The L-shaped member 23 is bonded to the transparent sheet 4. the L-shaped member 23 of the invention is provided 5-20 mm of the edge of the transparent sheet. The L-shaped member 23 is inserted at the edge of the side to prevent deformation, thus increasing the strength of the curved transparent sheet 4 and preventing deformation of the transparent sheet 4 due to wind and other factors. In addition, at the bottom and sides of the transparent sheet 4, the gap between the wearer's face and the transparent sheet 4 becomes narrower, which increases the pressure between the transparent sheet 4 and the face, further protecting against viruses and bacteria.

FIG. 47 is the 36th embodiment of the invention, a cross-sectional view, where the end faces of the edges of the transparent sheet 4 are bent. The edge of the transparent sheet 4 is folded inward. The width of the fold may be 3 mm to 10 mm. As a result, this is inexpensive, increases the strength of the sides of the transparent sheet 4, prevents deformation of the transparent sheet 4, and narrows the gap between the wearer's face and the transparent sheet 4 at the bottom and sides thereof, increasing the pressure between the transparent sheet 4 and the face, and further protecting against viruses and bacteria. The invention also includes bending the edges of the transparent sheet 4 into an L-shape or a round shape.

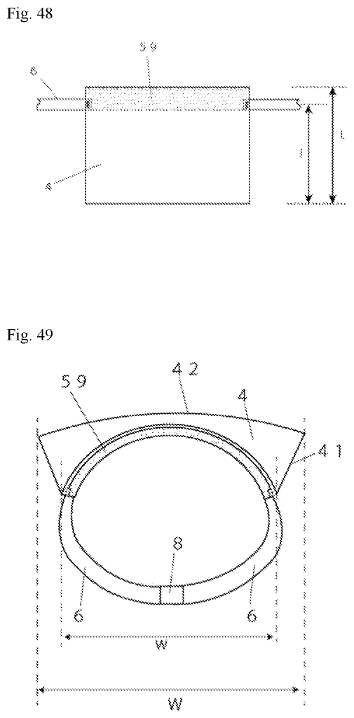

FIG. 48 is the 37th embodiment of the invention: a front view, with the wide cushion part 59 glued to the transparent sheet 4 and the elastic band 6 bonded and fixed at the position of the bottom edge of the wide cushion part 59. The wide cushion part 59 should be, for example, 30 mm wide and 20 mm thick. The elastic band is 20 mm wide. In FIG. 48, l represents the length from the bottom edge of the transparent sheet 4 to the center of the elastic band, and L represents the vertical length of the transparent sheet 4.

FIG. 49 is an illustration related to FIG. 48, showing a top view of the transparent sheet 4 when it is attached and smoothly curved. When the transparent sheet 4 is placed on the wearer's head, w is the width of the transparent sheet 4 when it is curved to follow the shape of the head at the upper end of the transparent sheet 4, and W is the width at the lower end 42 of the transparent sheet 4.

In FIG. 48, the length 1 to the center of the elastic band 6 should be approximately ½ of L to ensure that both the top and bottom of the transparent sheet 4 are evenly curved. By doing so, W in FIG. 49 becomes approximately equal to w. However, there are problems such as the wearer's nose coming into contact with the transparent sheet 4 or the elastic band contacting the wearer's ear. Therefore, placing the elastic band 6 at the bottom end of the wide cushion 59 in FIG. 48, rather than making the elastic band 6 in the middle of the wide cushion 59, contributes to making W smaller (i.e., reducing the spread of the bottom edge of the transparent sheet 4). This is the 37th embodiment of the invention. The 37th embodiment of the invention further protects against viruses and bacteria by narrowing the gap between the transparent sheet 4 and the wearer's face at the bottom and sides of the transparent sheet 4.

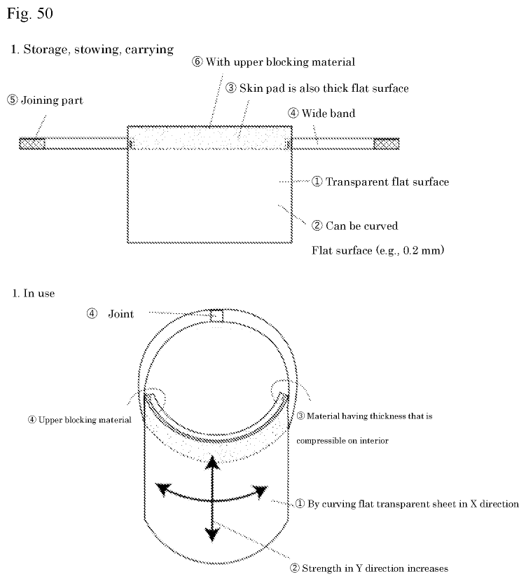

FIG. 50 shows the invention wherein the structure is reinforced when the invention is used. The elements to strengthen the structure are: (1) a transparent flat sheet (2) a thin surface that can be curved (e.g., 0.2 mm thick sheet) (3) a flat surface that is also thick against the skin (4) a wide band (5) a bonded part (6) an upper blocking material; (2) during use (1) a flat transparent sheet curved in the X direction to (2) increase strength in the Y direction (3) thick material that can be compressed inside (4) a bonded part (5) an upper blocking material. This optimal configuration can enhance the strength of the mask.

When stored, stowed, or carried, the mask is flat and easy to carry. When used, it is curved and wrapped around the circumference of the wearer's head (X direction), increasing the strength of the transparent sheet in the vertical direction (Y direction). This prevents the transparent sheets from being deformed or broken by wind or contact. Masks that combine one or more of the above elements are also included in this invention.

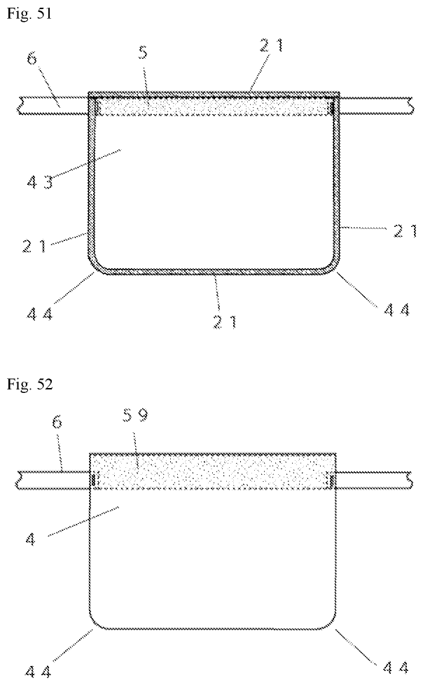

FIG. 51 is the 38th embodiment of this invention, which is for babies, infants, and children. This is a small-sized transparent sheet 43 that is not available in any masks for babies, infants, or children, including currently known masks, with safety edges 21 on the sides of the transparent sheet. The small transparent sheet 43 should be the following small size, for example, B6 size. The safety edges 21 may have urethane or rubber edges or may be covered with tape. The transparent sheets 44 have rounded corners for safety. In addition, the transparent sheet 44 with rounded corners are provided with urethane edging 21 for safety. In the 38th embodiment, the mask can be used for infants under 1.5 years old because ordinary masks are painful to wear and are immediately taken off, but the mask of the present invention has open sides 42 and bottom 41 of the transparent sheet, allowing easy breathing. 2. The elastic band or cushion only makes light contact with the head and forehead, so the baby will not be troubled by it. 3. The transparent sheet allows an infant wearing the device to see what is going on around him or her, and there is no strangeness about the appearance of the device. 4. Children do not resist it because it does not make contact with the nose or mouth. 5. The child can cry freely, and at the same time, the mother can hear the child's voice well and can respond to the crying immediately. 6. Even when the infant is sleeping, the mask effectively protects the infant from from droplets in the air.

FIG. 52 is a front view the 39th embodiment of the invention, with the bottom corners of the transparent sheet 4 of the 37th embodiment (FIG. 48) rounded. In this way, injures can be prevented by rounding the corners of the transparent sheet.

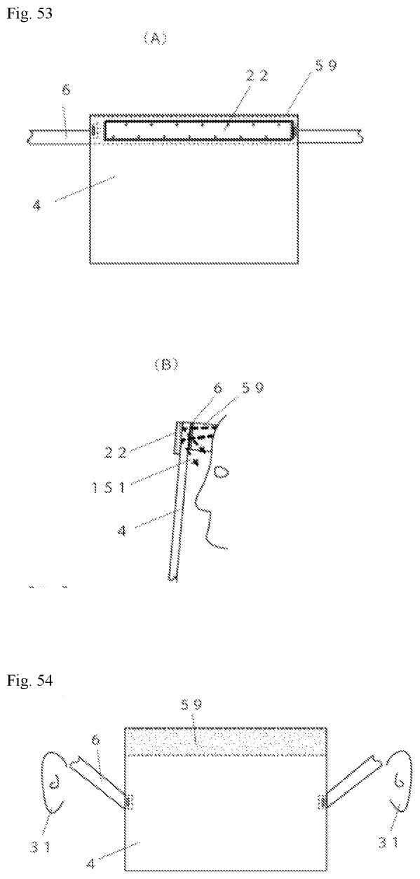

FIG. 53 is a front view of the 40th embodiment of the invention with a plasma tape or aluminum tape 22 bonded to the top of the transparent sheet 4. As shown in FIG. 53(B), the plasma tape or aluminum tape reflects the heat 59 emitted from the face and functions as a booster, further increasing the temperature and pressure in the space between the transparent sheet 4 and the face, which has the effect of further protecting against bacteria and viruses.

FIG. 54 is a front view of an embodiment of the 41st embodiment of the invention and is a transparent sheet 4 with an elastic band 6 angled diagonally in the center of the side of the transparent sheet 4 and fixed by bonding. The elastic band 6 is angled diagonally because if the elastic band is attached straight to the center of the side of the transparent sheet 4, it will make contact with the ear 31 and also the transparent sheet 4 will be likely to shift, so the elastic band is angled and fastened at the back of the head over the upper part of the ear 31. The angle of inclination may be 45 degrees relative to the side of the transparent sheet 4. The angle of inclination should be the angle at which the elastic band is above the wearer's ear. This allows the top and bottom edges of the transparent sheet 4 to curve uniformly, making it less like that the transparent sheet 4 would shift, and also increases the pressure between the transparent sheet and the surface of the face, further preventing bacteria and viruses.

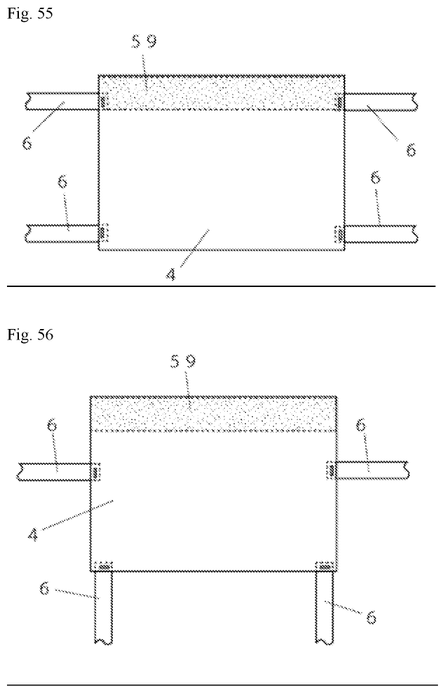

FIG. 55 shows the 42nd embodiment of the invention, in which at least two elastic bands 6 are bonded and secured to one side of the transparent sheet 4 and an equal number of elastic bands are fixed and bonded to the other side. A pair of elastic bands 6 is bonded and secured to the bottom of the sides of the transparent sheet 4. A pair of elastic bands 6 is bonded and secured to the bottom of the sides of the transparent sheet 4. Another set of 6 elastic bands is bonded and secured to the bottom edge of the wide cushion 59 at the side of the transparent sheet 4. Also, two sets of elastic bands secure the transparent sheet 4 to the head so that it does not shift and can be stably worn on the face.

FIG. 56 shows a 43rd embodiment of the invention: elastic bands are bonded to the sides and underside of the transparent sheet 4. One set of elastic bands 6 is bonded and secured at a location near the center of the side of the transparent sheet 4 where the elastic bands do not contact the ears, and the other set of elastic bands 6 is bonded and secured at both ends of the underside of the transparent sheet 4. By securing the underside with an elastic band, the wearer's chin can also be covered by the transparent sheet 4, further reducing the gap between the transparent sheet and the face and preventing the transparent sheet from deforming or curving even in wind or other conditions.

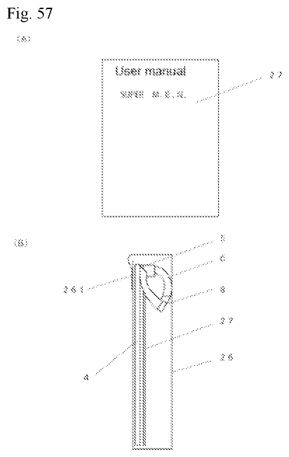

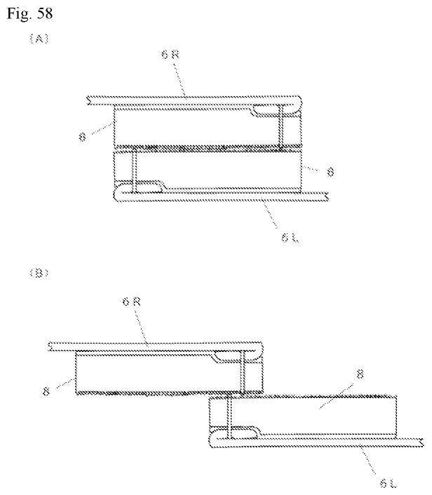

FIGS. 57-58 illustrate the 44th embodiment of the invention and show the invention when it is being transported. In FIG. 57, a hook and loop fastener 8 which is bonded to the end of the elastic band 6 which is bonded to the transparent sheet 4, hangs down toward the bottom of the transparent sheet inside the transparent sheet 4 during transport and carrying, and may make contact with the interior surface of the transparent sheet 4, possibly causing damage thereto. Therefore, as shown in FIG. 57, this 44th embodiment is characterized by the insertion of a protective sheet 27 between the inner surface of the transparent sheet 4, the hanging elastic band 6, and the hook and loop fastener 8 to prevent scratches on the transparent sheet. The protective sheet 27 is sized to cover the transparent sheet 4. The material of the protective sheet 27 should be softer than that of the transparent sheet 4, such as paper, nylon, or soft plastic. The protective sheet 27 may be used in conjunction with the instruction manual and may also be added to appeal to or advertise the product to users, by using pictorial diagrams or the like. This embodiment is also applicable not only when transporting, but also when storing or carrying. This protective sheet 27 may be smaller than the sizes listed above.

FIG. 58(A) shows almost the entire width of the mutual hook and loop fastener 8 set as they are joined together. To securely fasten the mask of this invention to the wearer's head 3, the hook and loop fasteners 8 are joined over nearly their entire length. FIG. 58(B) shows a 1-15 mm portion of the hook and loop fastener 8 partially joined without strong pressure. This is the bonding method used in the 44th embodiment of the invention. This allows the transparent sheet 4 to be opened and closed easily without damaging it, getting in the way, or placing a load on the hook and loop fastener 8 or elastic band 6. It may be used in transportation in a packaging bag or in carrying the invention when it is removed.

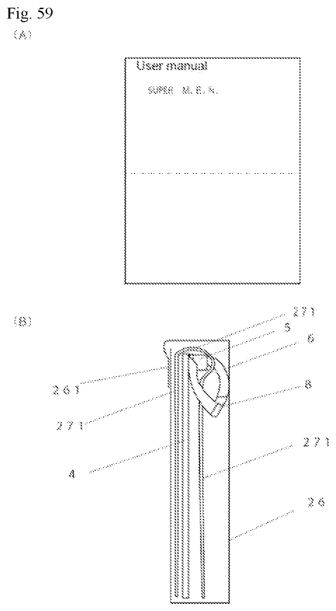

FIG. 59 shows the 45th embodiment of the invention, which is characterized by doubling the size of the protective sheet of the 44th embodiment (FIG. 57), folding it almost in the center, and providing protective sheets 271 that straddle both sides of the transparent sheet for packaging. The 8 hook and loop fasteners are partially joined as shown in FIG. 58(B). This ensures that the inner and outer surfaces of the transparent sheet 4 are completely covered by the protective sheet 271 and are not damaged.

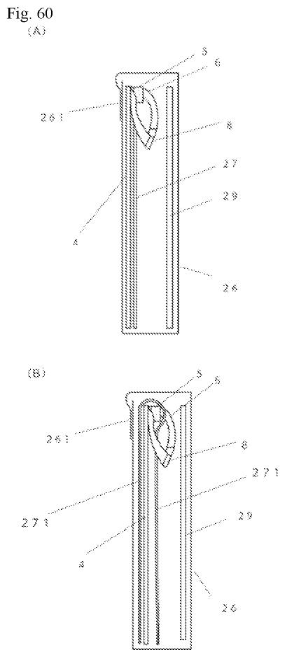

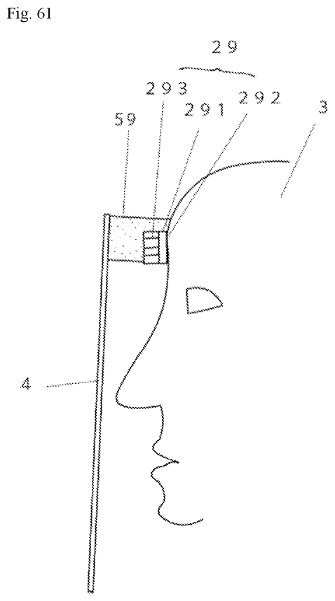

FIG. 60 shows a 46th embodiment of the invention, characterized by the provision of a reinforcing sheet 28 between the protective sheet 27 and the packaging bag 26 in the 44th embodiment (FIG. 57(B)) or the 45th embodiment (FIG. 59). The 8 hook and loop fasteners are partially joined as shown in FIG. 58(B). The reinforcing sheets 28 are made of corrugated cardboard, thin wood sheets, or other materials that are difficult to deform. As a result, even if the mask is subjected to external forces during transport, the transparent sheet 4 will not be easily deformed or subject to further damage. The form of the 44th to 46th embodiments is suitable not only for transport, but also for storing the mask of the invention when it is removed by the wearer.

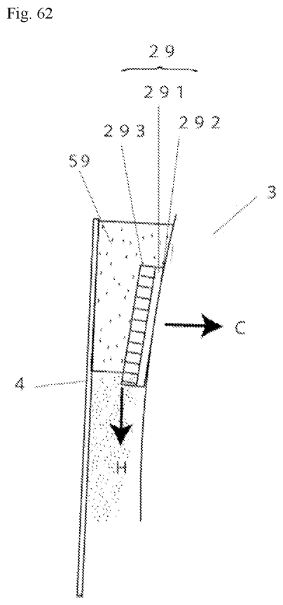

FIGS. 61-62 show a 47th embodiment of the invention: a side view, with a Peltier element 29 installed in the cushion part and the mask of the invention. In FIG. 61, the low-temperature side 292 of the Peltier element 291 is in direct contact with the wearer's forehead, while the heat-dissipating fins 293 on the high-temperature side of the Peltier element are closed at the top by a cushion and open at the bottom to the air in the space between the transparent sheet and the wearer's face. The Peltier element 29 is embedded in the lower part of the wide cushion part 59. The battery that powers the Peltier element can be a rechargeable storage battery or a button cell, which can be placed inside the cushion part for compactness. A switch is disposed outside of the cushion. FIG. 62 illustrates how the heat generated from the high-temperature side of the heat-dissipating fins 293 warms the air in the space between the transparent sheet and the wearer's face in FIG. 61. In the 47th embodiment of this invention, the temperature of the space between the transparent sheet 4 and the face is further increased in addition to the face temperature by the Peltier element, which makes the space 25 between the transparent sheet 4 and the face even more pressurized than the outside air, preventing the entry of coronaviruses and other viruses and also destroying any coronavirus that may have entered the space between the transparent sheet and the face by means of the increased temperature. In addition, the forehead is cooled and remains cool even in summer.

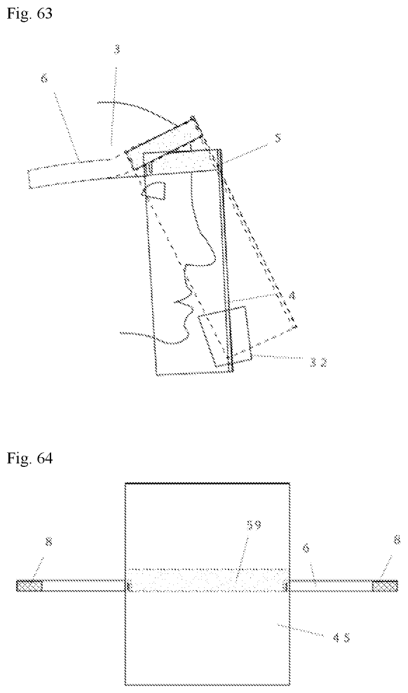

FIG. 63 shows the 48th embodiment of the invention, which is characterized by shifting or curving the elastic band that holds the mask to the head, shifting the part of the cushion that contacts the forehead above the head, and allowing the support part to change the angle of the transparent sheet 4 as desired. The angle of the transparent sheet 4 can be changed, and by opening the transparent sheet 4 wide, the effect is that food and eating utensils such as cups 32 can be placed inside the mask. Moreover, it is possible to apply lipstick.

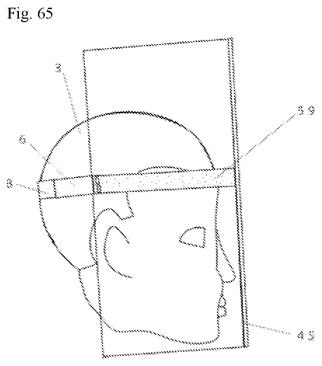

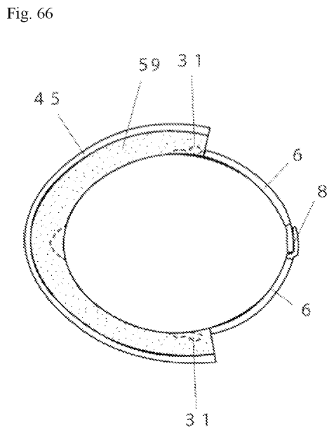

FIGS. 64-66 show the 49th embodiment of the invention, in which a transparent sheet 4 covers the head. For example, if the transparent sheet in other embodiments of the invention is B5 size, this embodiment uses a B4-sized transparent sheet, which is twice the size of B5, to protect the head and ears from droplets. FIG. 64 shows a B4-sized transparent sheet 45 with a cushion part 5 in the center thereof, and elastic bands 6 secured to the transparent sheet 45 are placed at both ends of the cushion part. As shown in FIGS. 65 and 66, the transparent sheet is large enough to protect the head and the sides of the ears. For example, in the case of a transparent sheet 4 consisting of a single A4 size sheet disposed vertically, the standard distance between the top edge of the transparent sheet and the head or face contact area may be 7 cm. This provides 100% protection against droplets from the front from the head to the chin, and protection against droplets from the sides hitting the ears, making the mask especially useful for doctors.

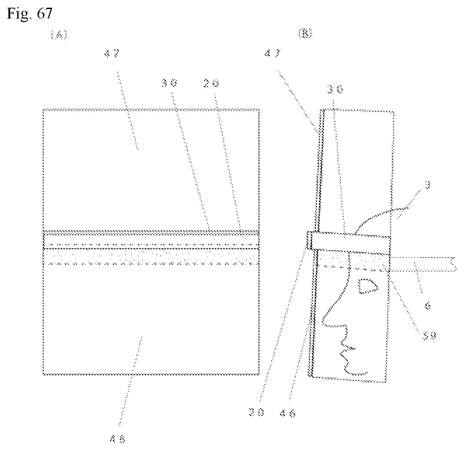

FIG. 67 shows the 50th and 58th embodiments of the invention. The 50th embodiment is without the reflective material 20 shown in FIG. 67. Instead of using a transparent sheet twice as large as the one mentioned above, the 50th embodiment is characterized by joining two transparent sheets together to make a large transparent sheet, with another transparent sheet 47 joined to the upper end of the transparent sheet 46 in such a way that it can be rotated and folded. The size of the transparent sheet may be B5 size, but if two sheets are combined, together they become B4 size. The cushion part 59 and elastic band 6 are attached to the transparent sheet 46, for example, as in embodiment 37 of the present invention, and the bottom edge of one other transparent sheet 47 and the top edge of the transparent sheet 46 are fixed with PSA tape or similar 30 adhesive so that they can be rotated. When not worn by the user, the two transparent sheets 46 and 47 are folded over each other on the surface side, making them ½ the size for easy carrying, and the two transparent sheets are stacked on top of each other for high strength. When worn, the upper transparent sheet 47 can be raised up to protect not only the face but also the top of the head from droplets, making it extremely useful for doctors and the like. This is a significant innovation that allows two transparent sheets to be curved at the same time, making the weak and disconnected transparent sheets 46 and 47 stronger and made into the same cross section. Moreover, since the surface side of the transparent sheet contaminated with droplets is superimposed and carried, contamination does not adhere to the outside and secondary contamination can thus be prevented. 61. The mask can be folded when it is removed by holding the rubber strap, which has the effect of preventing contamination from transferring to the hand that is holding the mask. The two transparent sheets can be of different sizes, can be made of different materials such as deflector sheets, and can be made of multiple sheets. This 58th embodiment, as shown in FIG. 67, consists of reflective material 20 which is bonded on top of 30 PSA tape or the like.

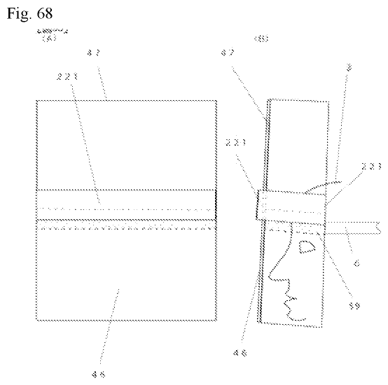

FIG. 68 is the 51st embodiment of the invention, in which two transparent sheets are joined by a booster 221. In the 50th embodiment of this invention, the two transparent sheets are joined by a booster 221 that increases the temperature of the space between the face and the transparent sheet.

The booster can, for example, be laminated with an aluminum layer, a glass cloth layer, and coated with a PSA layer. Plasma tape can also be used. By laminating it with glass cloth, the heat-reflective material is given repeated bending strength, so the transparent sheet will not break no matter how many times it is folded. It can also be laminated with a heat-reflective material, which acts as a booster to further increase the temperature and pressure in the space between the face and the transparent sheet. The PSA also serves as a hinge adhesive for the transparent sheet.

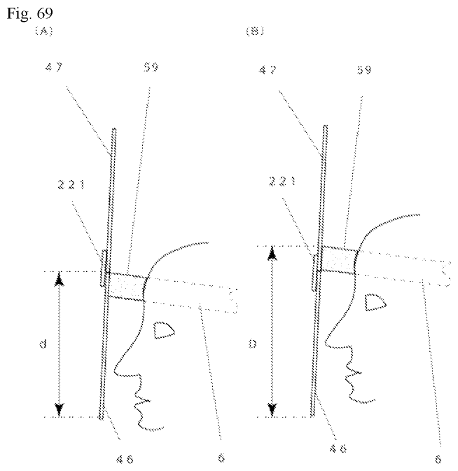

FIG. 69(A) is a side cross-sectional view of the 51st embodiment (FIG. 68), where d is the length from the top of the cushion part 59 to the bottom of the transparent sheet 46. FIG. 69(B) is the 52nd embodiment of the invention, characterized by the provision of a cushion part on one of the two transparent sheets 47 which may be, for example, of the same size, joined by a hinge. Specifically, a wide cushion part 59 and an elastic band 6 (represented by dotted lines) may be attached to the lower end of the transparent sheet 47, which is the upper part when worn by a wearer, as in the 37th embodiment, and the lower end of the transparent sheet 47 and the upper end of the transparent sheet 46 are attached with a booster (for example, heat reflective tape laminated with glass cloth and aluminum) 221 to allow for rotation. The bottom of the transparent sheet is not provided with a fastening device such as an elastic band. FIG. 69(B) is a side cross-sectional view of this embodiment, where D is the length from the top of the cushion part 59 to the bottom of the transparent sheet 46. In other words, when FIG. 69(A) is turned upside down and attached as shown in FIG. 69(B), even if the two transparent sheets are the same size, d<D, the position of the fastening device is shifted to one side, allowing the length of the transparent sheet covering the face to be extended to accommodate individuals with longer faces. Conversely, if the sheets are reversed and worn as shown in FIG. 69(A), the size of the face protection transparent sheet will be suitable for people with shorter faces. Furthermore, when putting the mask on again after carrying it, the folded transparent sheet can be opened by holding the elastic band 6, which prevents coronaviruses, bacteria, etc. from getting onto the hand holding the mask even if droplets of coronaviruses and the like are already adhering to the surface of transparent sheets 46, 47.

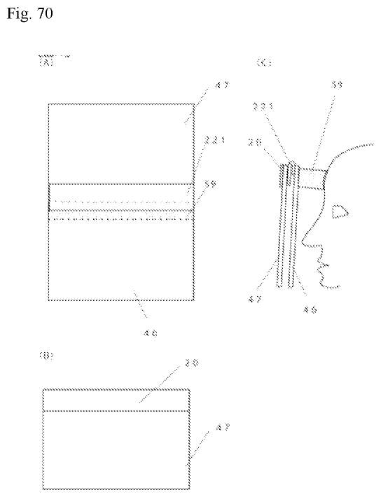

FIG. 70 shows a 53rd embodiment of the invention, characterized by the placement of 20 reflective materials at the joint of the two transparent sheets. FIG. 70(A) is a front view of the two transparent sheets unfolded; FIG. 70(B) is a front view of the sheets folded and overlapped; FIG. 70(C) is a cross-sectional view of the sheets folded and overlapping. Reflective material is attached to the back of the joint of one of the two transparent sheets, the sheet that does not have a cushion part. For example, a booster (e.g., heat-reflective tape laminated with glass cloth and aluminum) 221 applied to the join of two transparent sheets is applied to the back of the corresponding transparent sheet 47 on the top half thereof. The reason is that if the 20 reflective material is affixed to the front side of the sheet, it will conceal the label and the booster 221, which is not the case if it is affixed to the back side of the transparent sheet 47 for the wearer's head. This allows the reflective material 20 to be revealed when the transparent sheet 47 is folded back, improving drivers' ability to see it at night. The reflective material can be applied to the entire rear of the horizontal width of the joint of the transparent sheet 47, which has the effect of increasing the reflective effect. A luminescent material may be used instead of a reflective material.

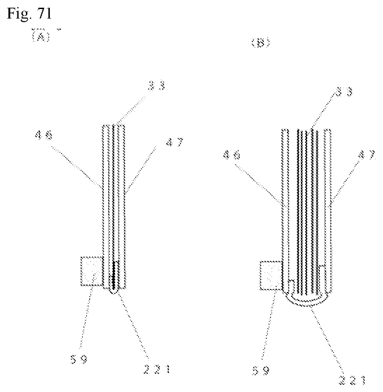

FIG. 71 is the 54th embodiment of the invention and is characterized by the storage of paper and other materials in the gap between the two transparent sheets. FIG. 71(A) shows two transparent sheets 46, 47 folded and paper 33 stored in the gap therebetween. This has the effect of allowing papers, etc. to be organized and stored or moved between the two folded transparent sheets. FIG. 71(B) shows two transparent sheets 46, 47 spaced apart and joined with bonding booster heat reflective tape 221, so that when the two transparent sheets are folded, the gap is wider, and paper 33, etc. can be stored therebetween. This allows large quantities of paper, etc. to be stored, and since the joints are rounded, the strength of the fold is increased, and there is a significant booster effect when the mask is unfolded and worn.

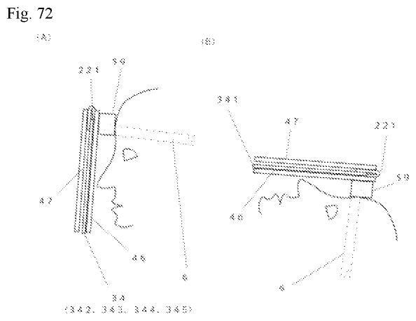

FIGS. 72(A) and 72(B) show a side cross-sectional view of a 55th embodiment of the invention, characterized in that a shielding material 34 such as paper, filter, or cloth can be inserted into the gap between the two overlapping transparent sheets 46 and 47. In FIG. 72(A), by inserting a filter 342 that does not permit ultraviolet rays to pass through the gap between the two transparent sheets, the mask can provide strong protection from ultraviolet rays from the sun outside, and has the effect of serving as a sun visor. If a filter 343 that does not permit infrared rays to pass through is inserted, the mask can also be used as a mask for work in welding shops, glass processing, and other such applications. In addition, the mask can also be used for general household uses to protect the user from heat from stoves and sunlight. Furthermore, inserting a face veil, lace, or other fabric 344 has the effect of making a woman's face more beautiful at parties and other events. The face can also be masked by inserting a paper mask 345 with holes for the wearer's eyes. Furthermore, by inserting an opaque light-blocking material such as paper (341) and wearing the mask at bedtime as shown in FIG. 72(B), the mask becomes an eye mask that prevents outside light from entering and allows for sound sleep.

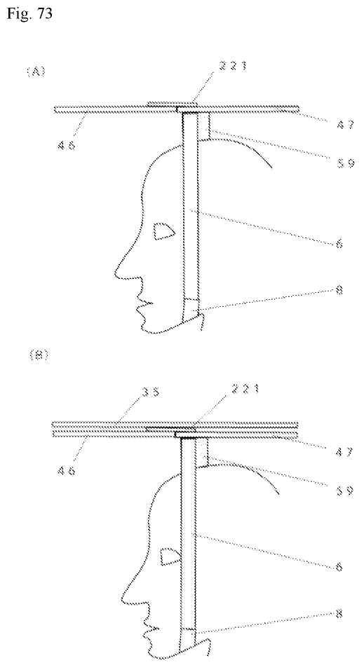

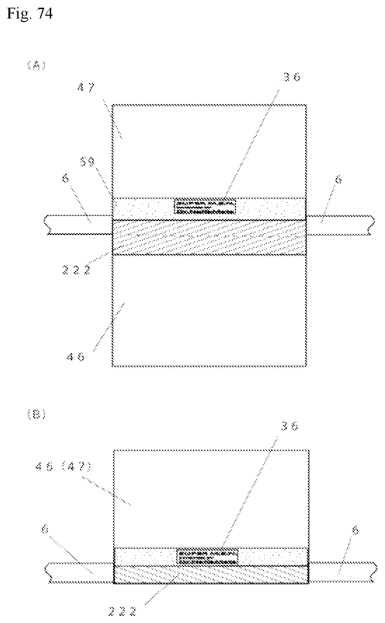

FIG. 73 shows the 56th embodiment of the invention, characterized in that the transparent sheets 46 and 47 are turned upward and worn on the head. FIG. 73(A) shows a rain umbrella with a transparent sheet placed on the head and secured to the chin with an elastic band 6 and hook and loop fasteners 8. FIG. 73(B) is a parasol by placing a cloth or paper shielding sheet 35 or the like outside or inside a transparent sheet, placing the mask of the invention on the head, and securing it to the chin with an elastic band 6 and hook and loop fasteners 8. This means that by carrying this lightweight and compact mask, one can prevent getting wet in sudden rain without carrying an umbrella or hat and can also protect against ultraviolet rays in place of a hat.

FIG. 74 is the 57th embodiment of the invention, featuring a different color on the front and back of the booster (e.g., heat-reflective tape laminated with glass cloth and aluminum) that joins the two transparent sheets 46 and 47, so that it can be immediately determined whether the two transparent sheets overlap or unfold in two pieces. For example, if the booster (heat-reflective tape) 222 that joins the two transparent sheets has a silver surface and white on the reverse side thereof, the silver stripe is visible when the two transparent sheets are open and unfolded (FIG. 74(A)) and the white stripe is visible when the two transparent sheets are folded and doubled up (FIG. 74(B)), making it possible to instantly judge whether the two transparent sheets are open and unfolded or two folded together to form a single piece.

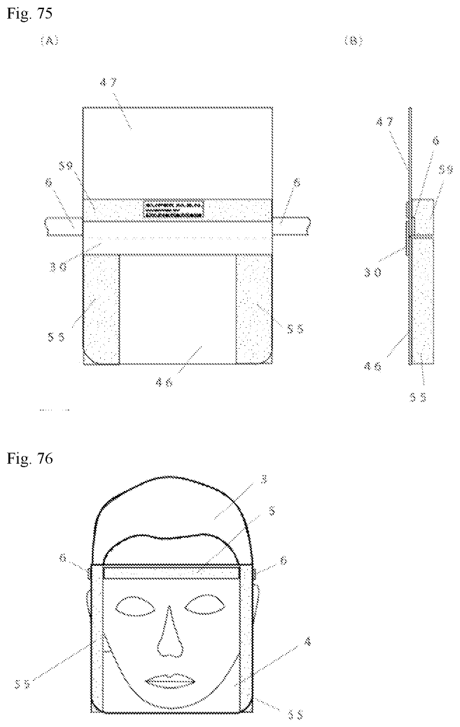

FIG. 75 shows the 58th embodiment of the invention, which, as shown in FIG. 75, has side cushion parts 55 on the left and right ends of the transparent sheet 46 which is connected to a transparent sheet 47, instead of a transparent sheet 47 with a head cushion 59. This allows the vertical side cushions 55 to prevent the novel coronavirus and other viruses from entering from either side of the transparent sheet 46. In addition, this configuration protects the front of the face from the novel coronavirus, etc. from the front of the face by means of the transparent sheet 46, and the front of the head can be protected by the transparent sheet 47, making it possible to obtain a perfect professional mask that can stop the entry of the novel coronavirus, etc. from all directions.

In the 59th embodiment of the invention, as shown in FIG. 76, the vertical side cushions 55 at the left and right ends of the transparent sheet (transparent thin sheet) 4 are provided on the transparent sheet extending to the top and bottom ends of the transparent sheet, and the left and right ends of the cushion part 5 are provided up to the sides of the vertical side cushion part 55. The elastic bands (6, 6R, 6L, 61, 63) are secured to the transparent sheet 4 at the location of the cushion part 5 at the upper end of the transparent sheet 4 and at the appropriate position of the vertical side cushion sheet 55. In FIG. 76, the transparent sheet and elastic bands are secured at the upper end of the transparent sheet 4, below the vertical side cushion part. In the 59th embodiment of the invention, the side cushion parts are installed on the left and right ends of the transparent sheet, the effect is to achieve three enhancements of the device's efficacy by increasing the temperature, humidity, and air pressure in the space between the transparent sheets and the face. Secondly, the head fitting is attached to the three-point enhancement device described above, which has the effect of increasing the overall curvature of the transparent sheet and improving its strength. Thirdly, in attaching the mask to the head in this way, the device's ability to protect against contamination and its strength are enhanced, and it is effective in protecting medical personnel. Fourth, this configuration is cooler than masks of the prior art and it is easier to use.

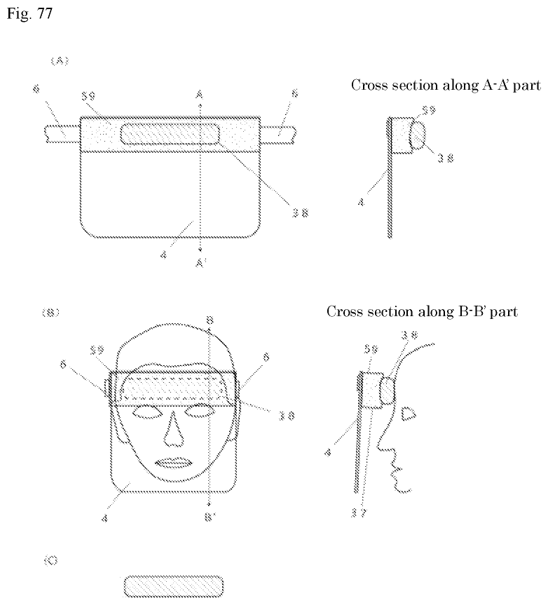

FIG. 77(A) shows a view of the transparent sheet from the inside, in which the cushion 59 at the upper end of the transparent sheet 4 is provided with cooling material 38. As shown in the side cross-sectional view along the A-A′ line, the surface of the wide cushion part 59 is provided with a cooling material. FIG. 77(B) shows that when the wearer wears the mask, the cooling material 38 contacts the wearer's forehead, and the cooling material 38 is provided so that it makes contact the wearer's forehead. FIG. 77(C) shows the shape of the cooling material 38 to be installed in the mask of this invention, for example, a rectangular gel-like cooling material with a length of 14 cm and a width of 5 cm. The cushioning part of the cooling material 38 is secured according to known methods. A gap may be formed in the cushion part and cooling material may be provided therein. If frostbite is a problem, a cloth or other material may be wrapped around the cooling material in advance. The effect of the 60th embodiment of the invention is that it be worn in cool comfort even in the heat of summer. It also has the effect of activating the frontal lobe and increasing learning ability. Furthermore, it can be used as a simple face cooling device. A portable disposable body warmer can be used in cold weather in place of the cooling material 38.

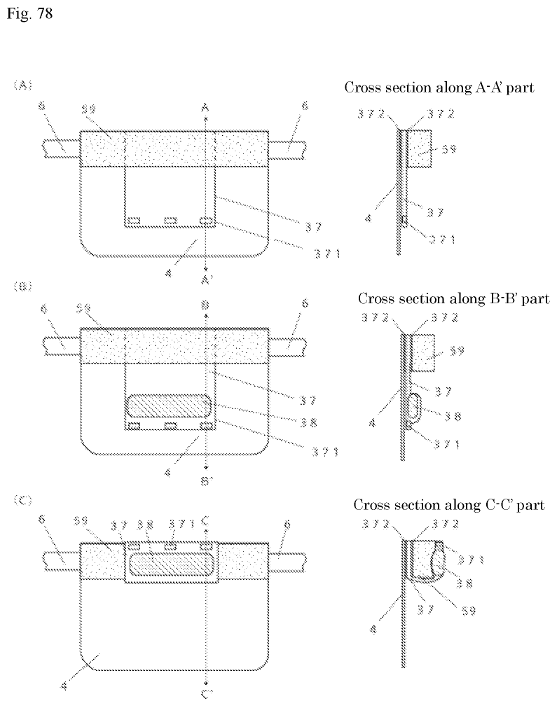

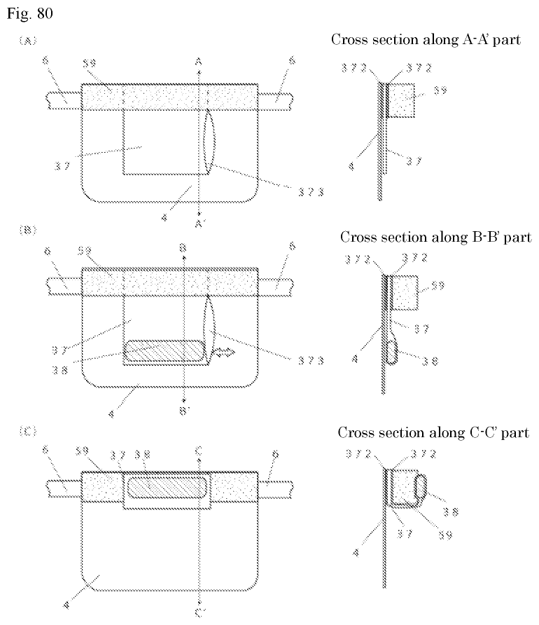

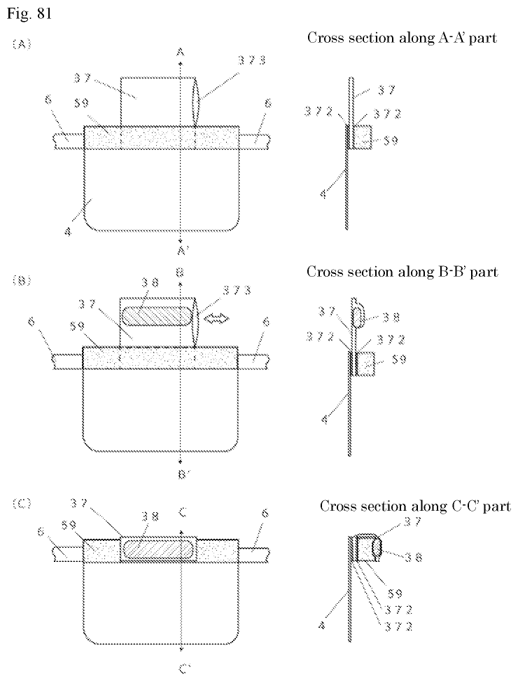

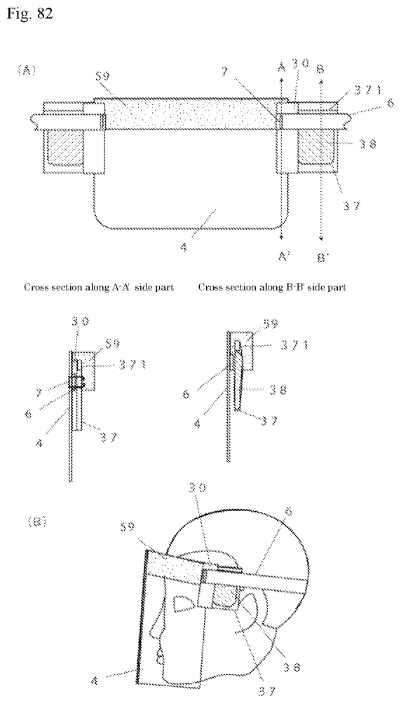

The 61st embodiment of this invention features a cooling material bag 37 on the transparent sheet to bring the coolant into contact with the forehead. As shown in FIG. 78(A), the cooling material bag 37 is secured to the transparent sheet 4 and cushion part 59 with double-sided adhesive tape 372 inside the transparent sheet 4, allowing cooling material 38 to be inserted into the cooling material bag 37 facing downward. As shown in FIG. 78(B), when the mask is worn, the cooling material bag 37 is bent toward the portion of the cushion part 59 that is in contact with the forehead so that the cooling material 38 is disposed between the forehead and the cushion part, and the mask is fixed to the head with an elastic band 6. This has the effect that the forehead can be cooled by the cooling material, and the cooling material can be easily removed from the mask. In addition, the cooling material is barely noticeable and looks good when viewed from the front of the wearer. There is no need to provide an opening stop 371 such as a zipper, hook, button, etc. for the cooling material 37 bag. (Such as in FIGS. 80, 81)

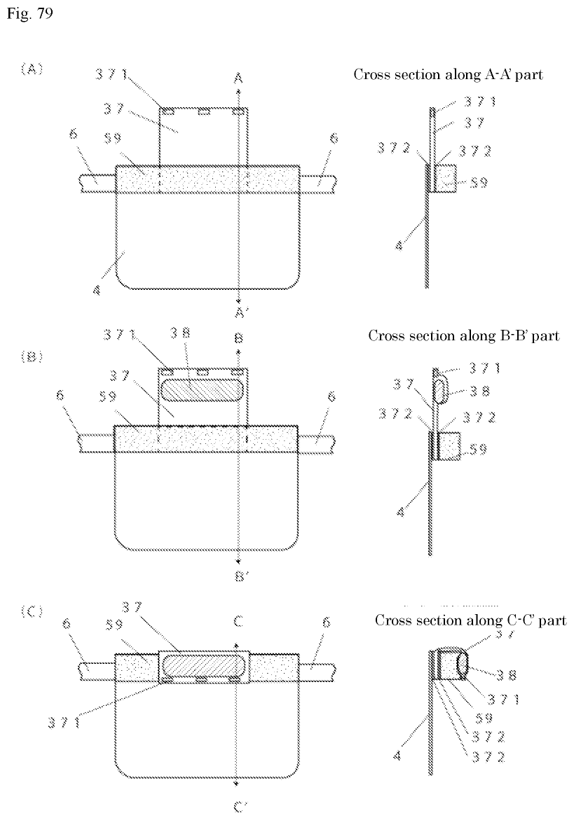

A 62nd embodiment of the invention is shown in FIG. 79, with the cooling material bag 37 placed above.

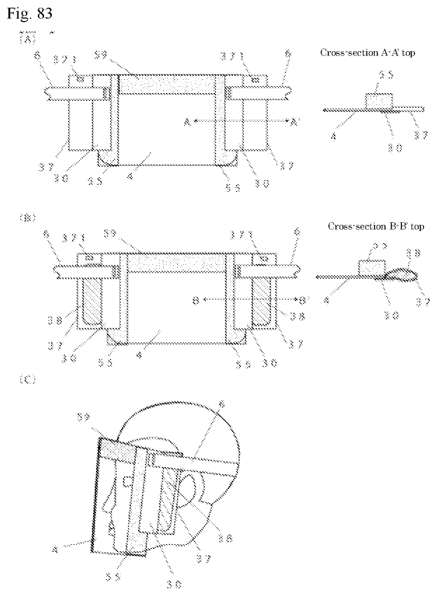

The 63rd embodiment of the invention is shown in FIGS. 82 and 83(A), where a cooling material 37 bag is provided on the vertical sides of the left and right ends of a transparent sheet and are joined together with PSA tape. As shown in FIGS. 82(B) and 83(C), when the mask is worn, the temple area is cooled with the cooling material 38 which has been inserted into the cooling material bag 37. FIG. 82 shows square cooling material and FIG. 83 shows a long, thin cooling material. This configuration also cools the wearer's temple areas, making the invention still cooler to wear even in the summer heat and prevents viruses from entering from the side.

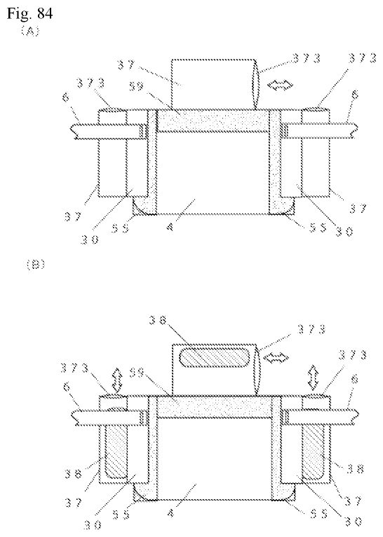

The 64th embodiment of this invention cools both the forehead and the temples, as shown in FIG. 84. The arrows are in the direction of insertion of the cooling material. Body warmers or other heating material can be used in place of the cooling material.

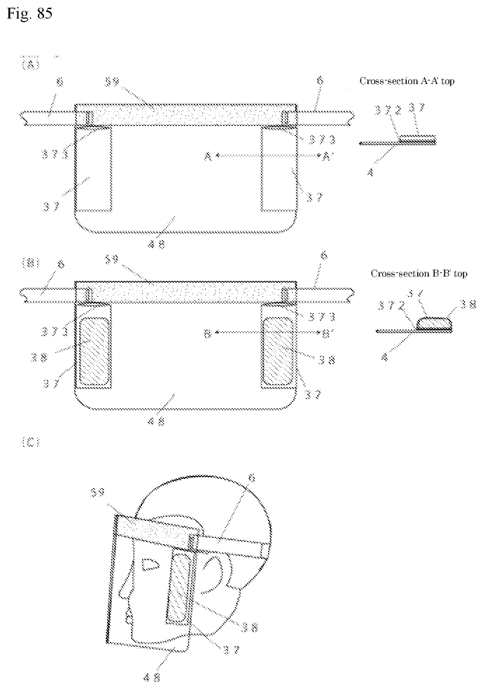

A 65th embodiment of the invention is shown in FIG. 85 with the cooling material bag 37 bonded directly to the transparent sheet 48.

In is the 66th embodiment of the invention as shown in FIG. 86, a nonstick material 39 such as tetrafluoroethylene is disposed between the cold storage material and the forehead. Specifically, a tetrafluoroethylene PSA tape 39 is attached to the cooling material bag 37 holds the cooling material 38. This inhibits cold air from hitting the forehead directly, preventing frostbite and preventing viruses from adhering to the forehead.

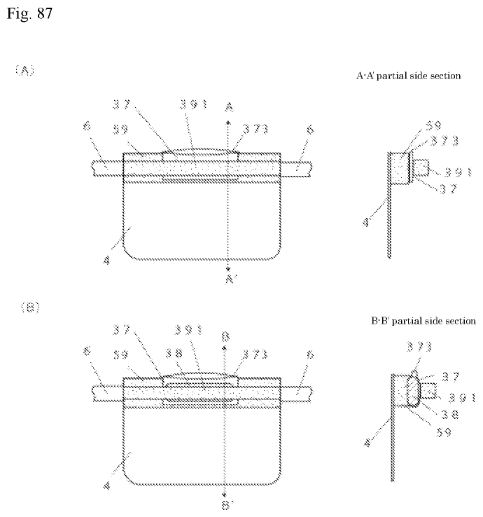

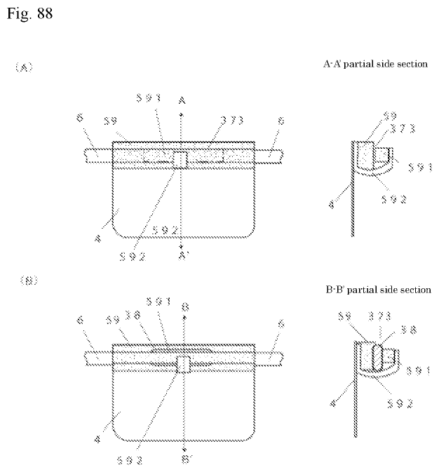

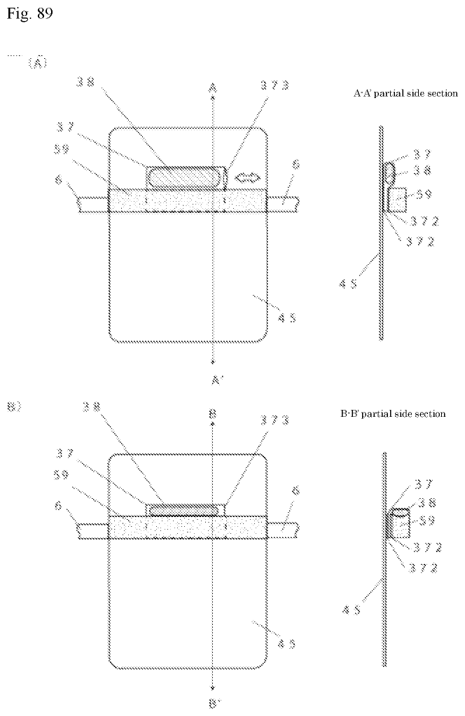

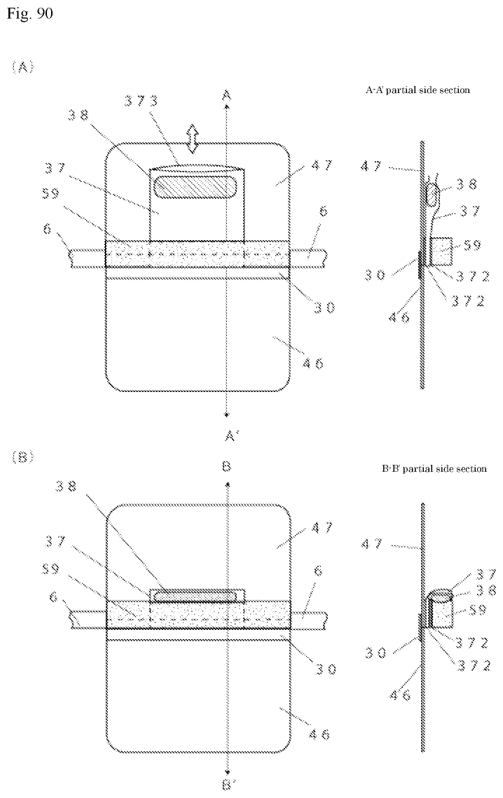

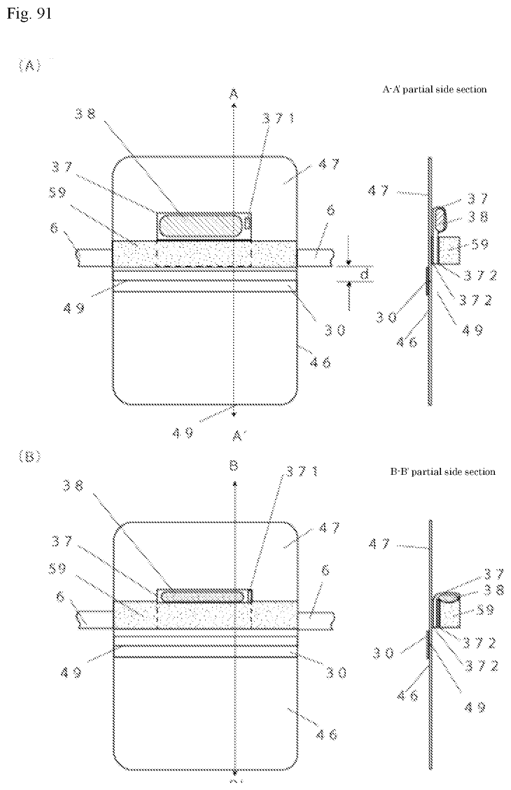

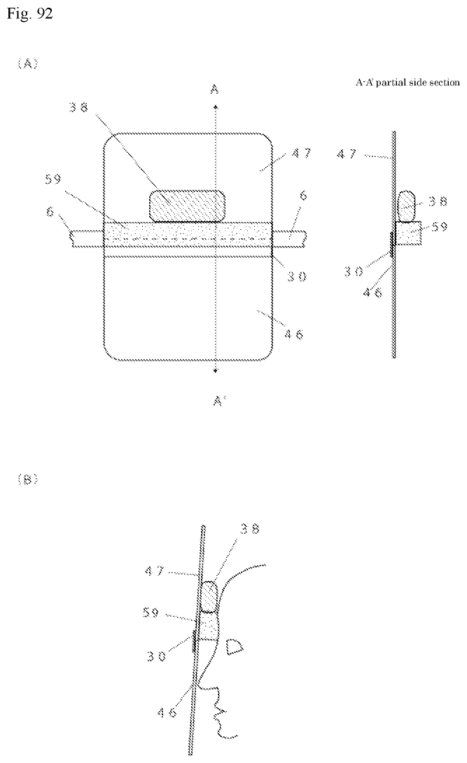

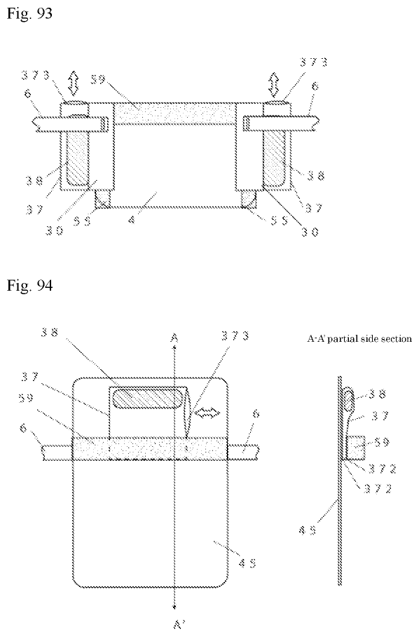

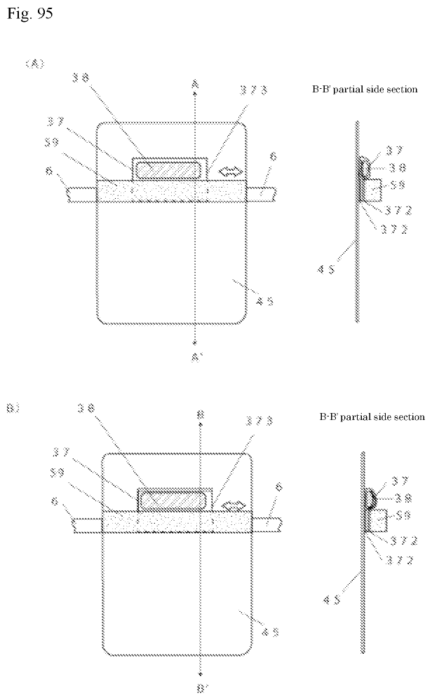

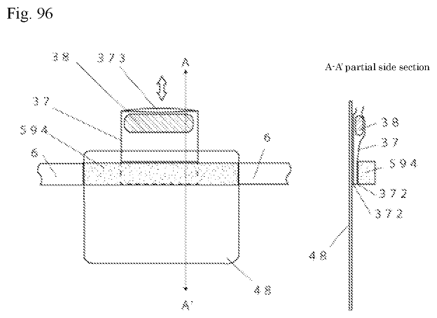

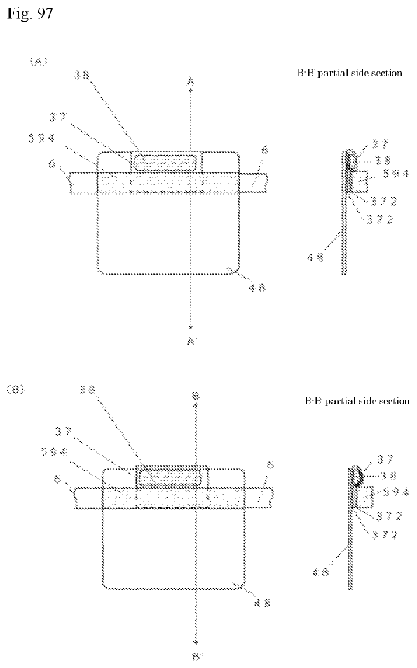

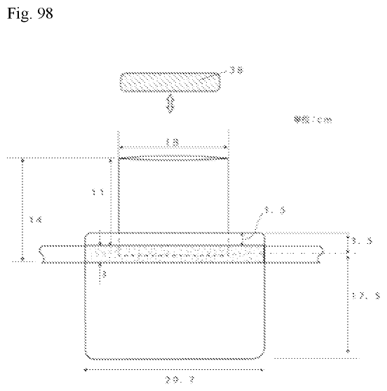

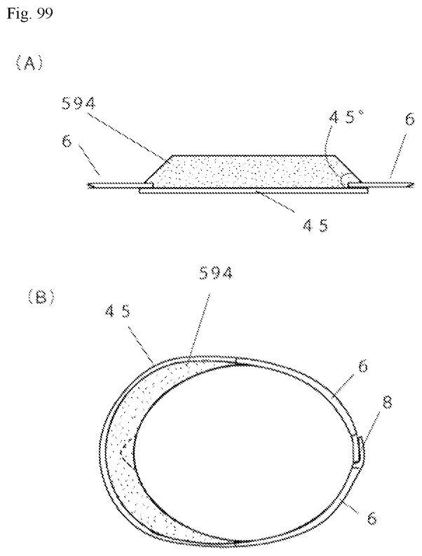

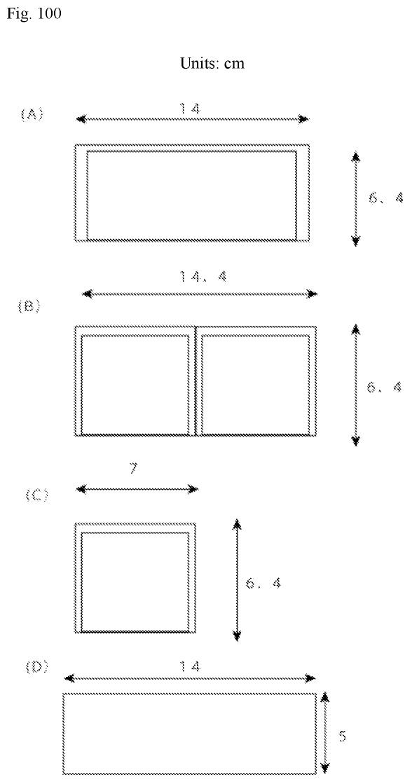

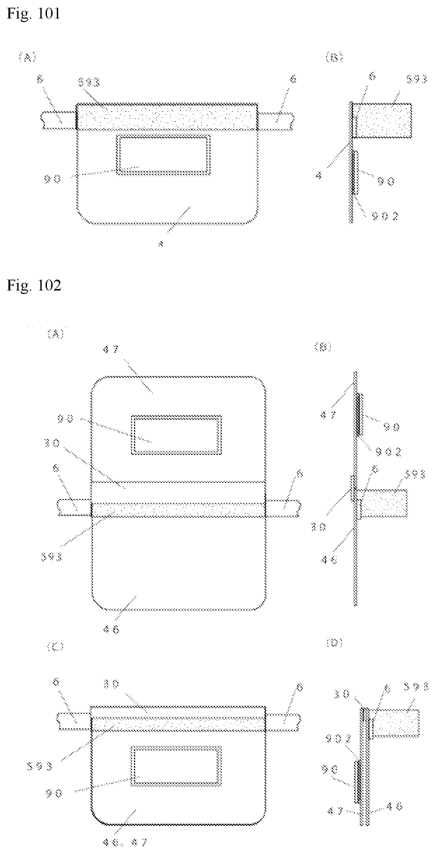

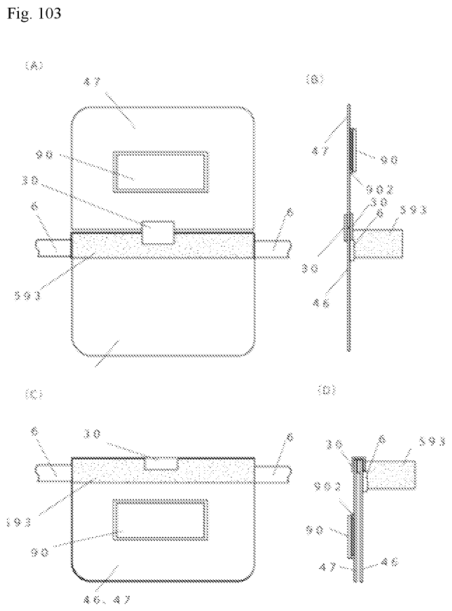

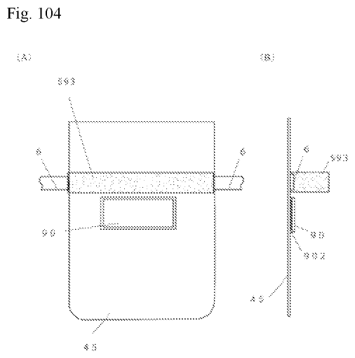

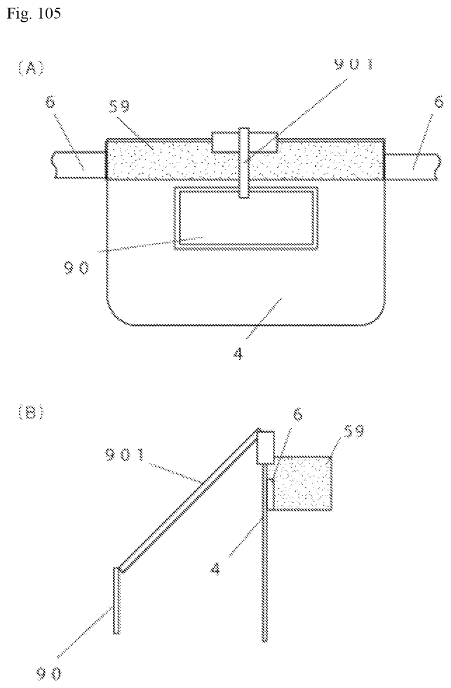

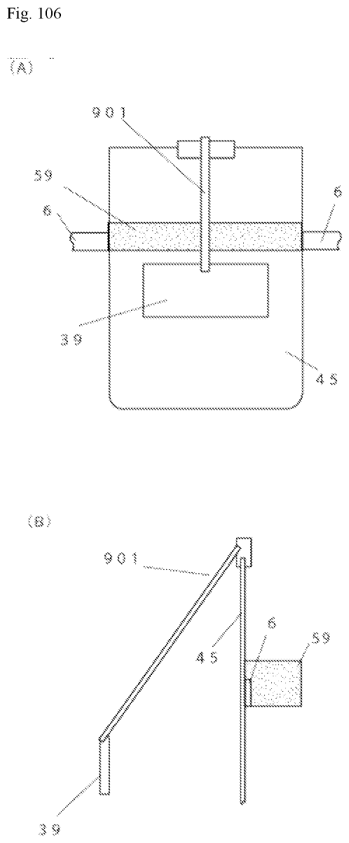

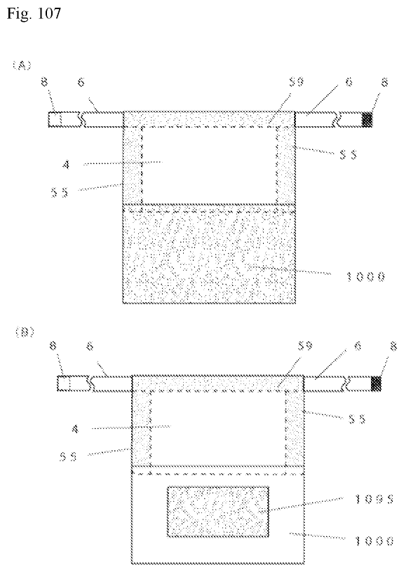

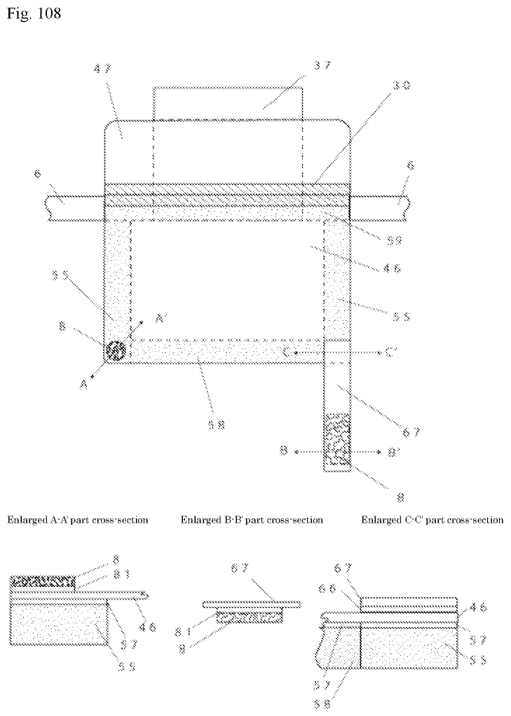

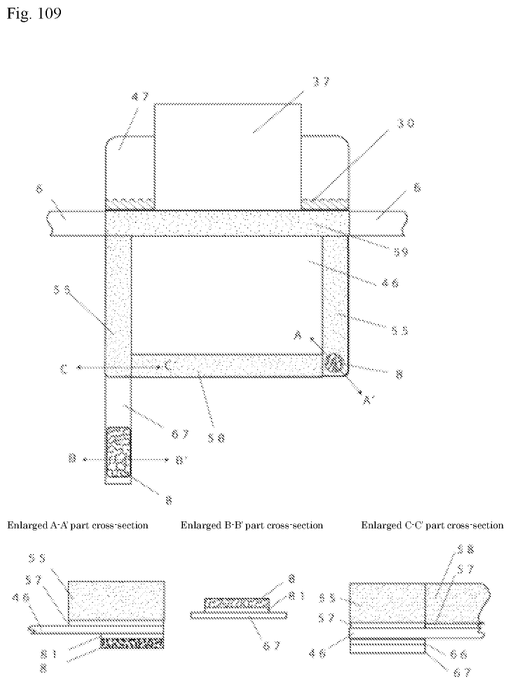

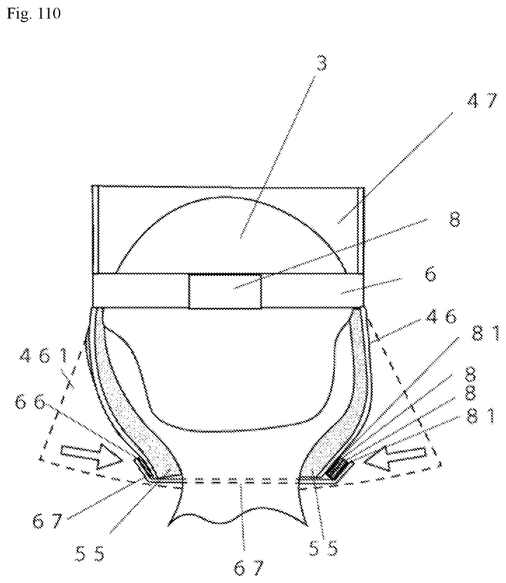

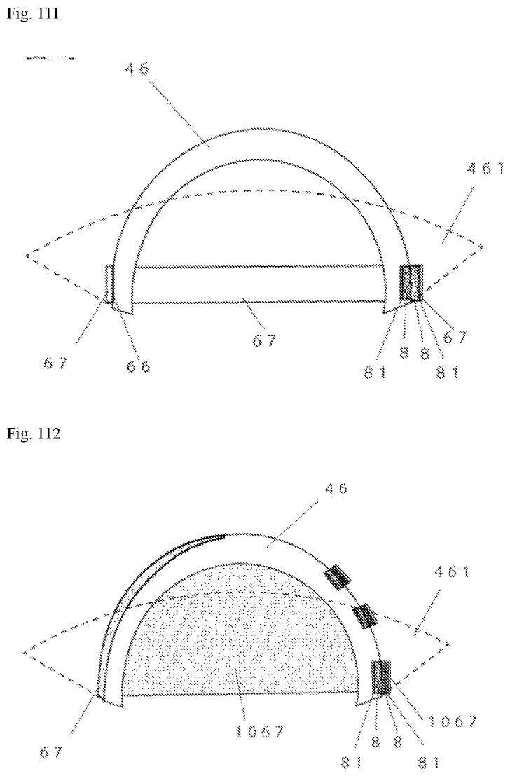

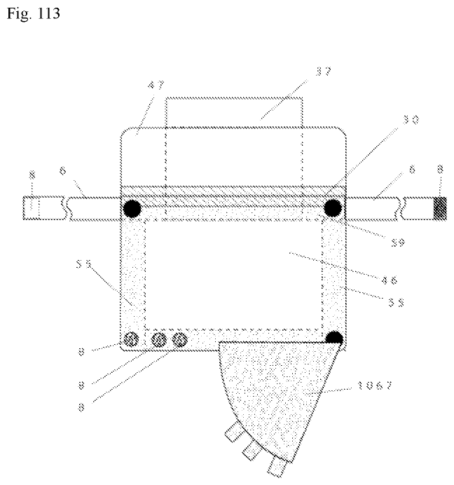

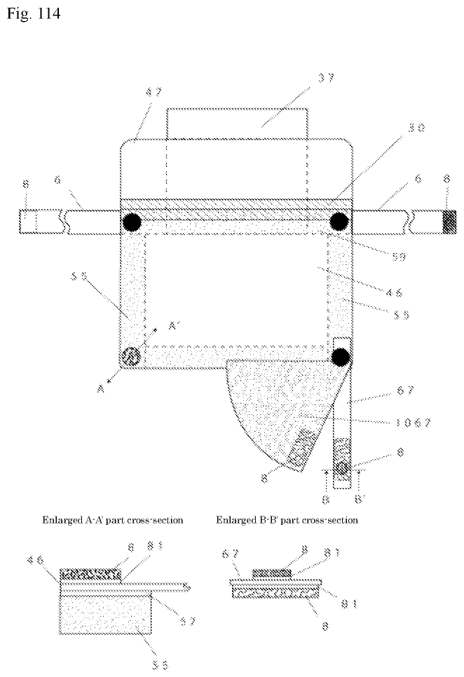

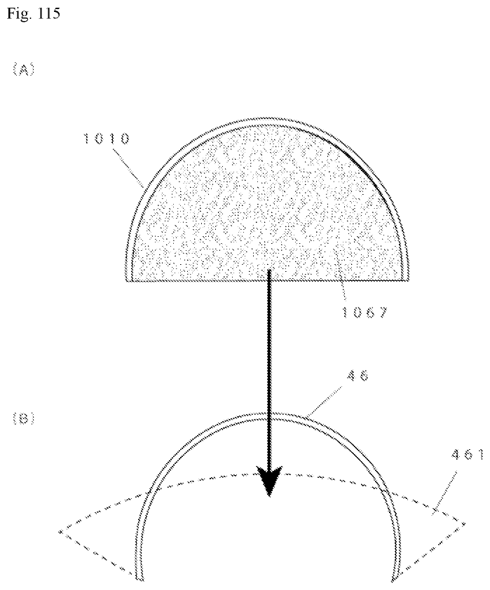

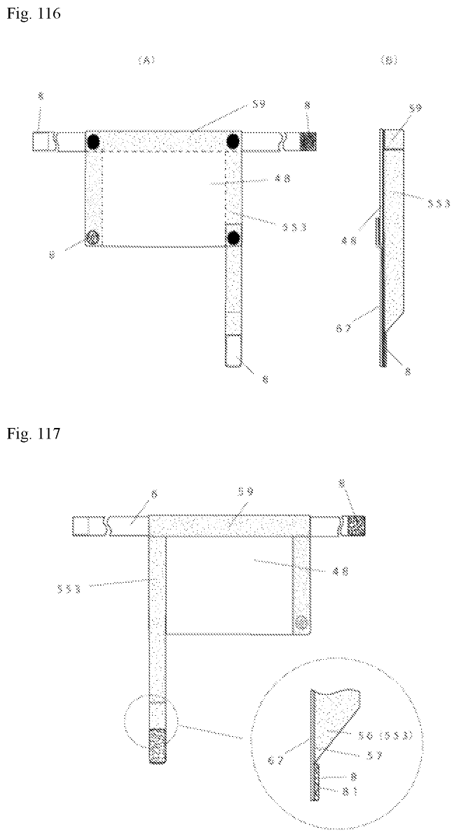

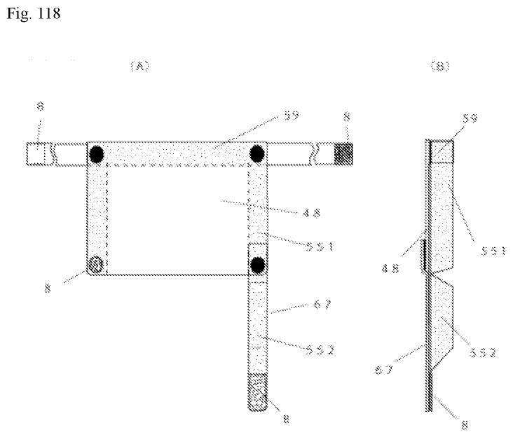

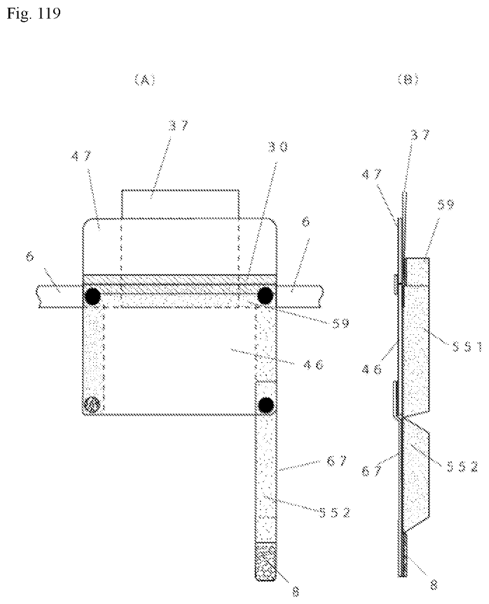

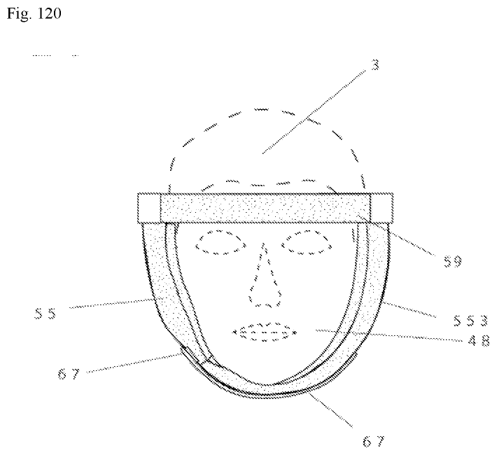

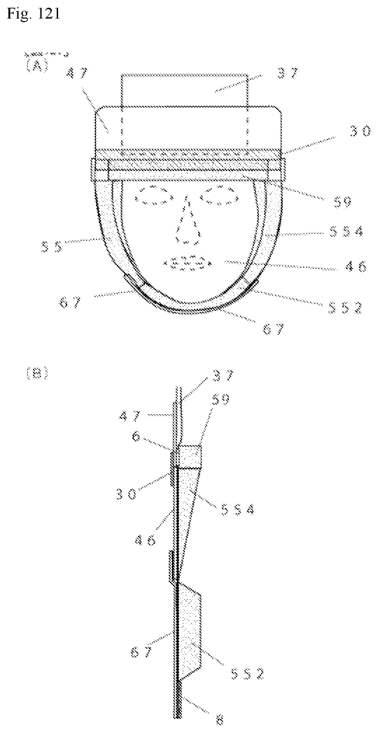

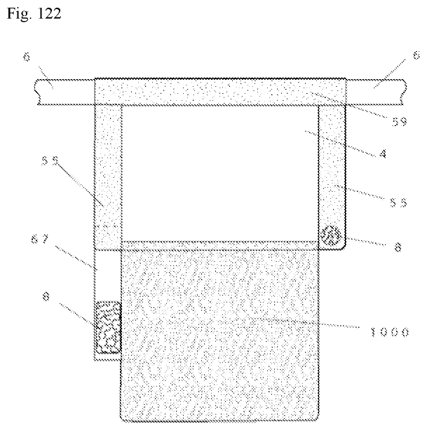

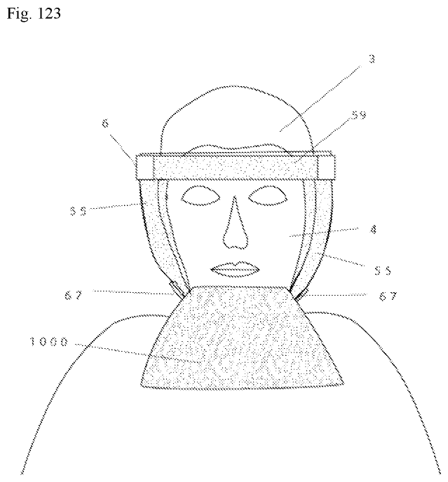

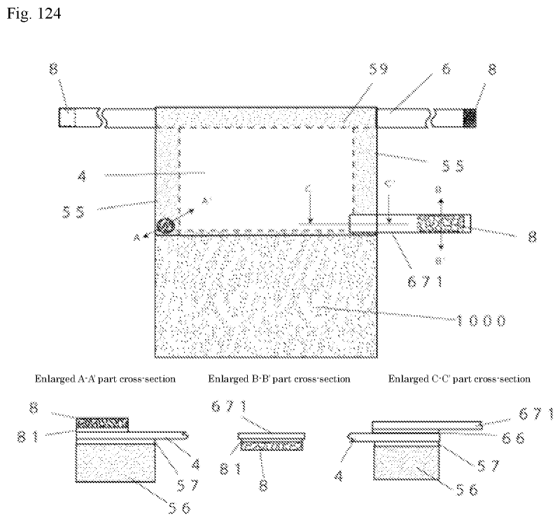

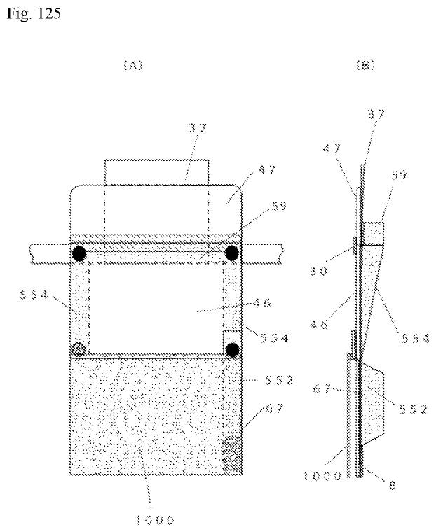

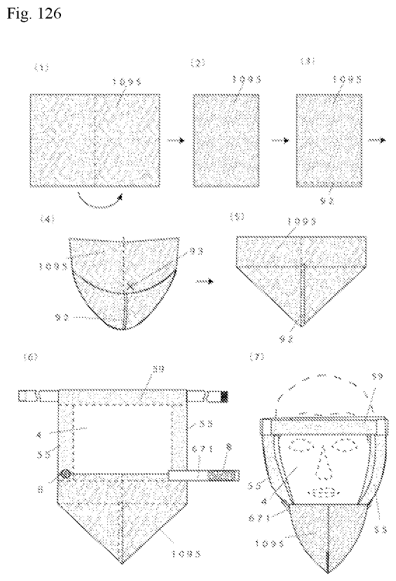

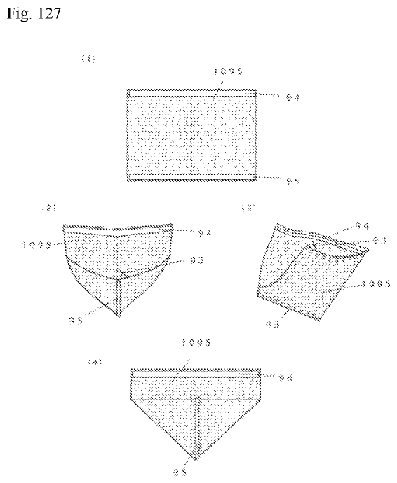

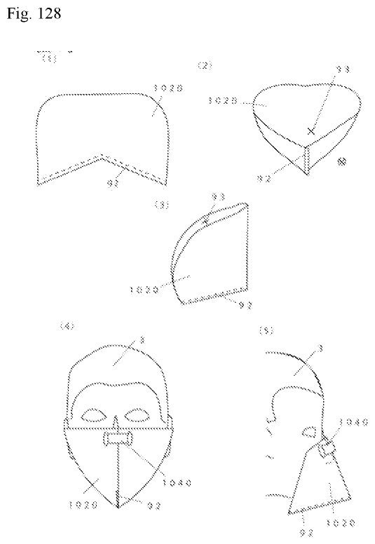

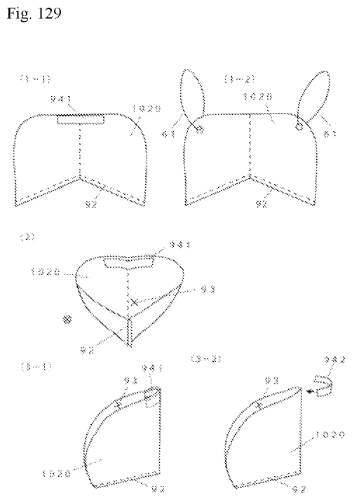

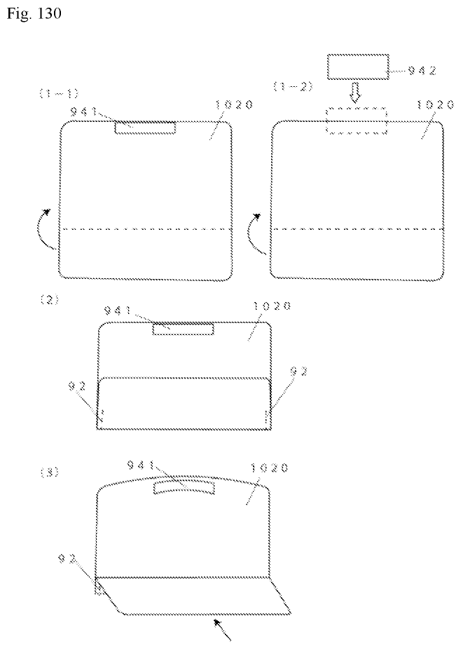

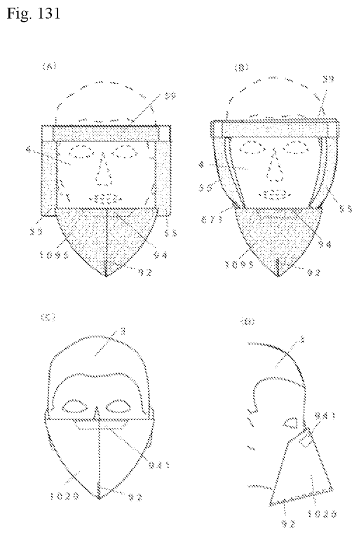

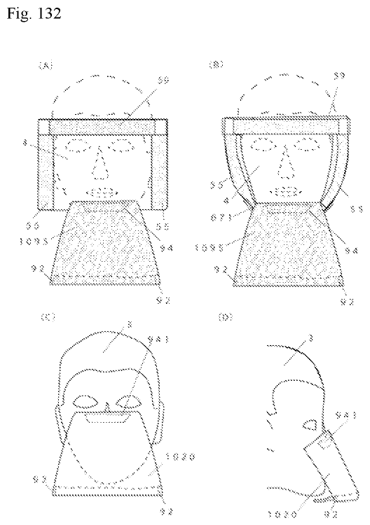

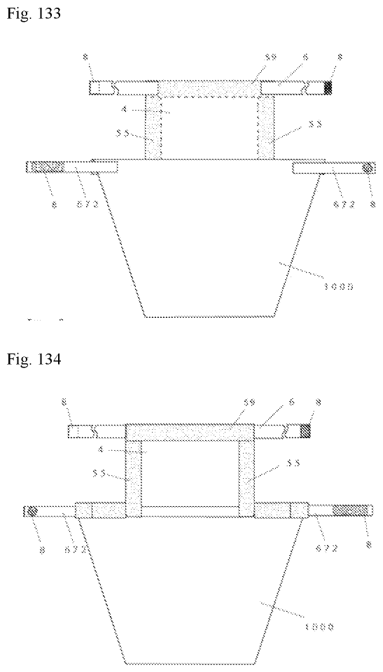

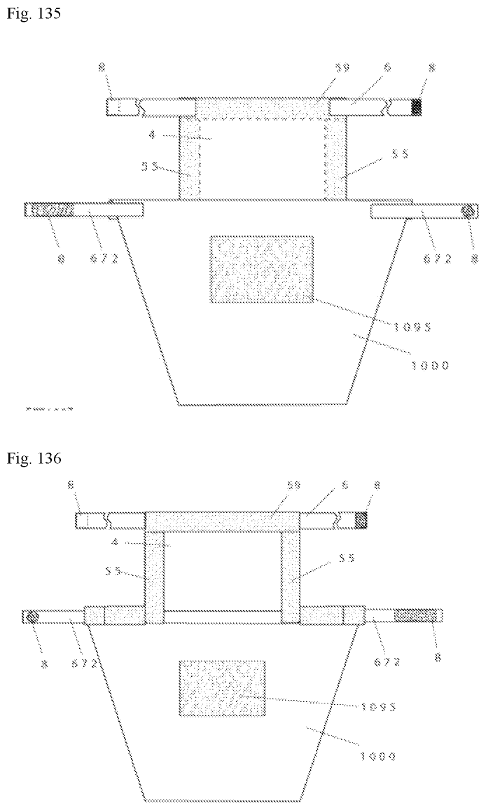

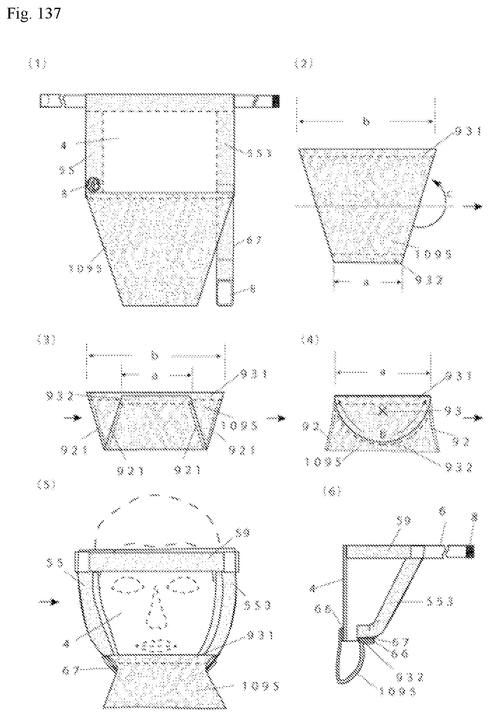

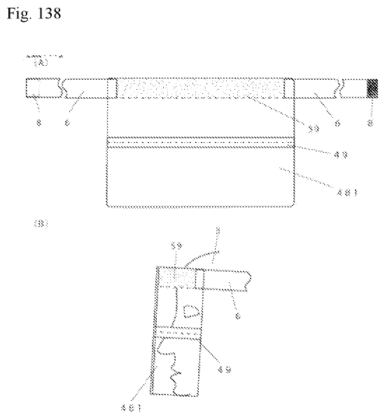

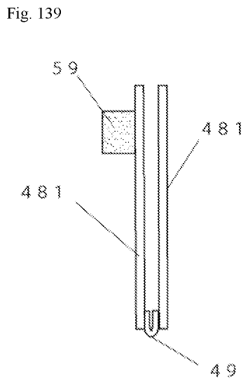

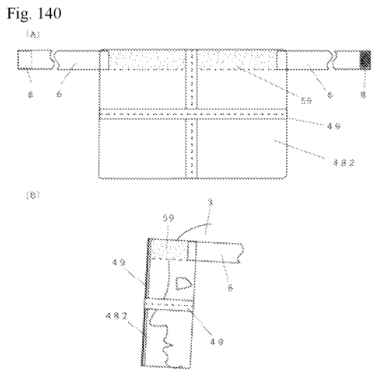

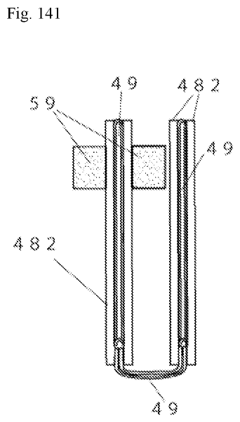

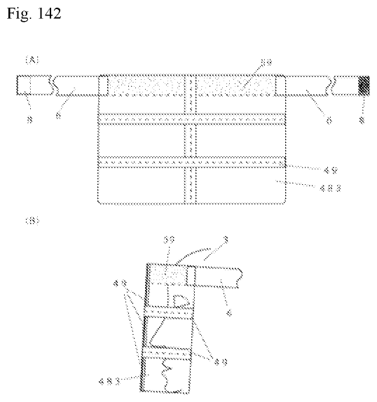

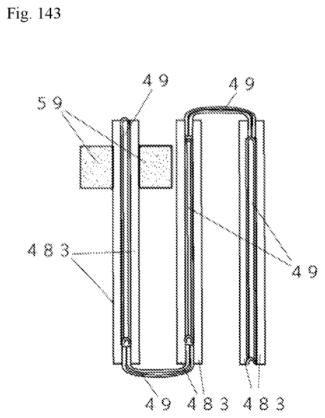

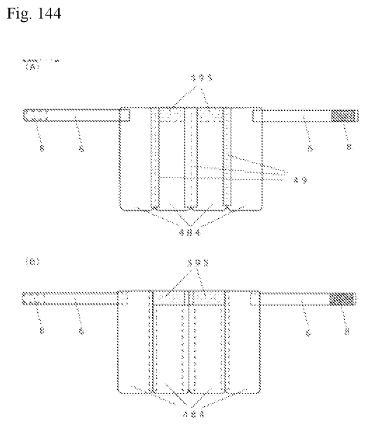

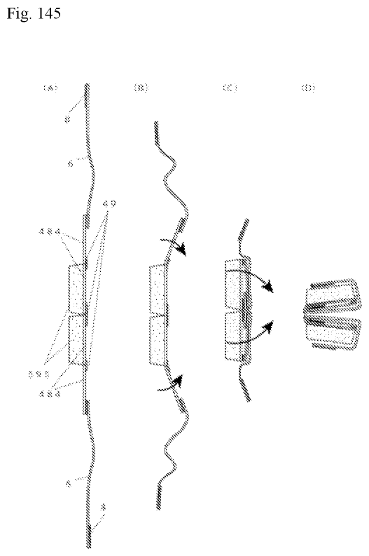

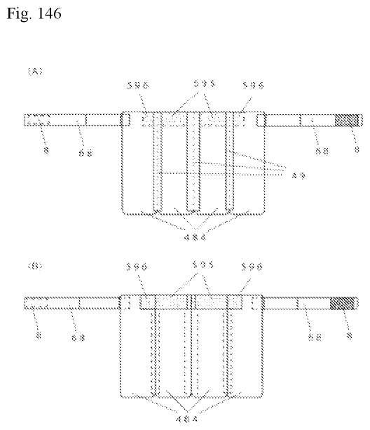

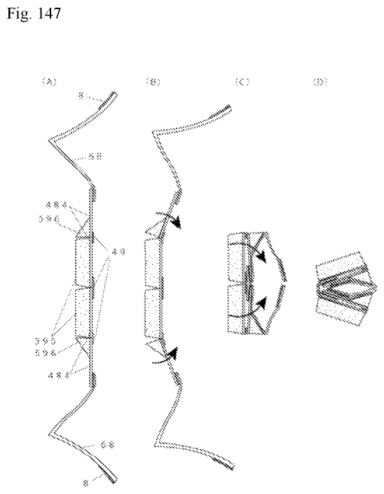

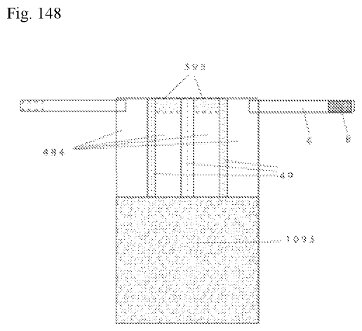

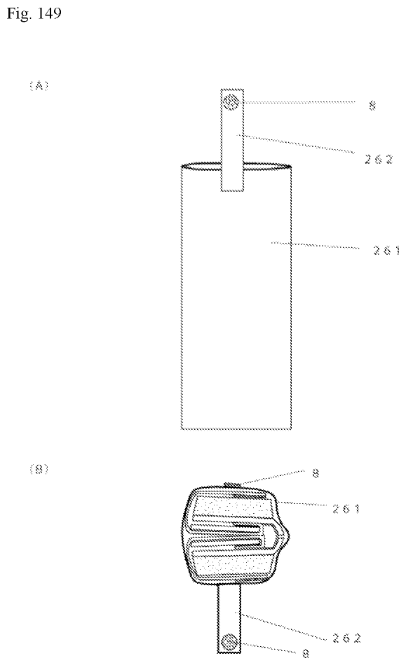

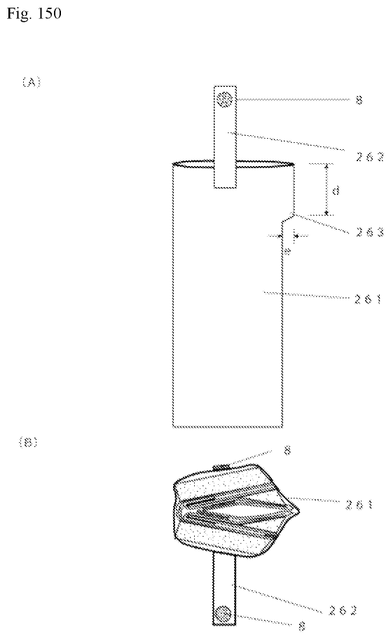

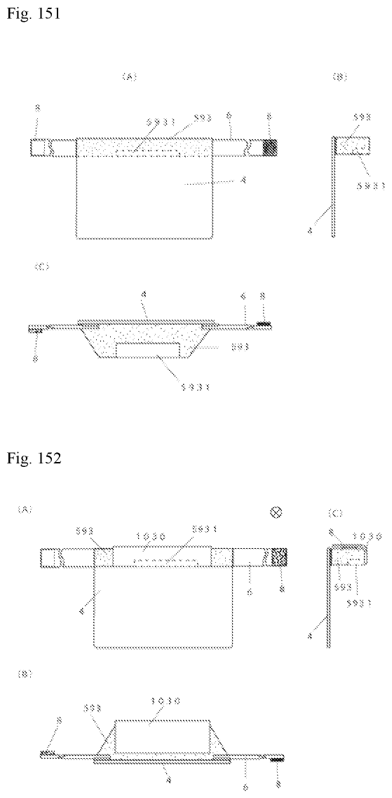

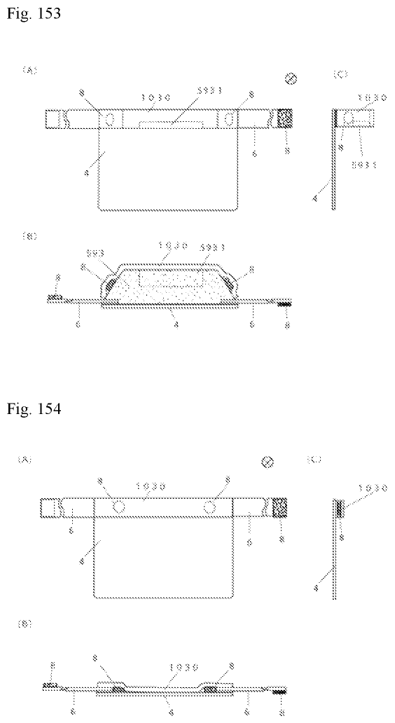

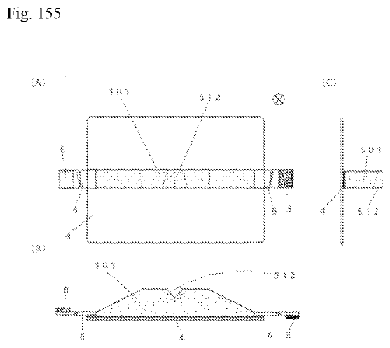

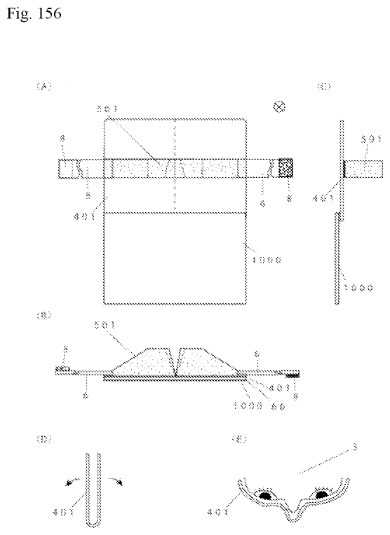

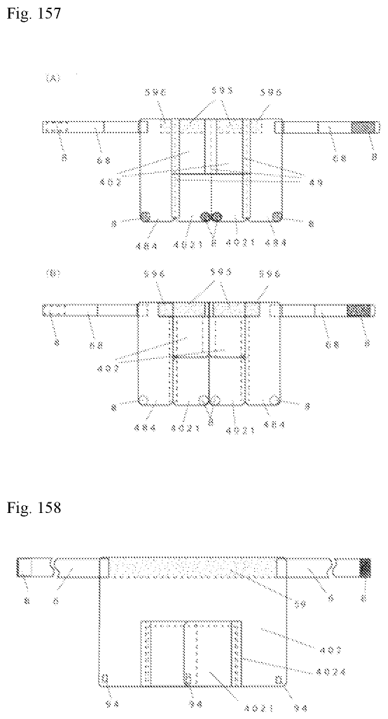

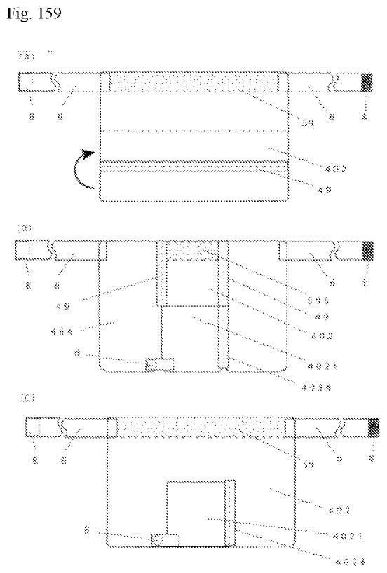

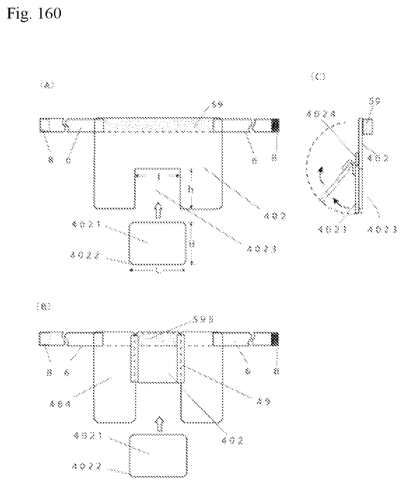

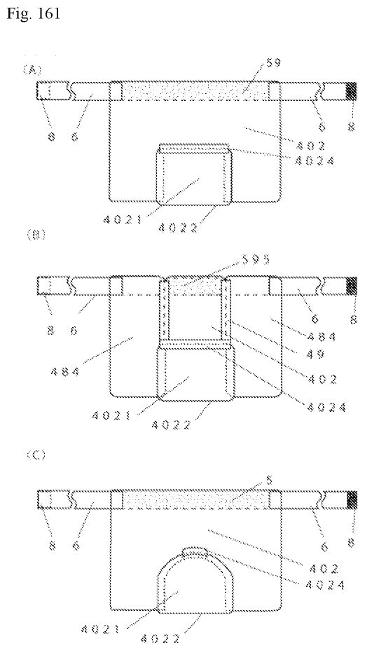

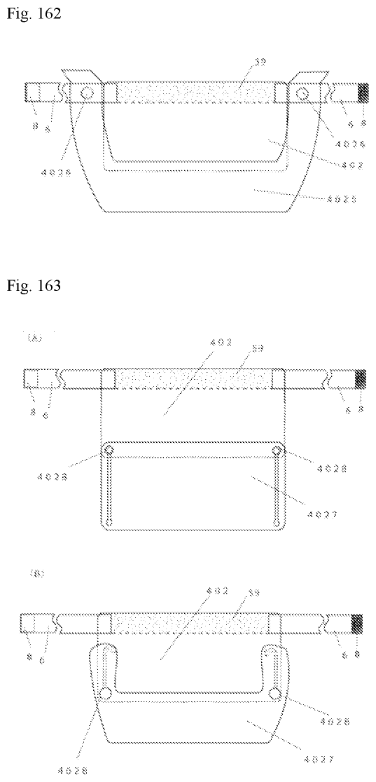

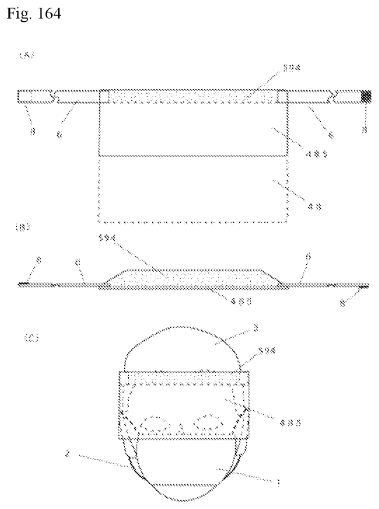

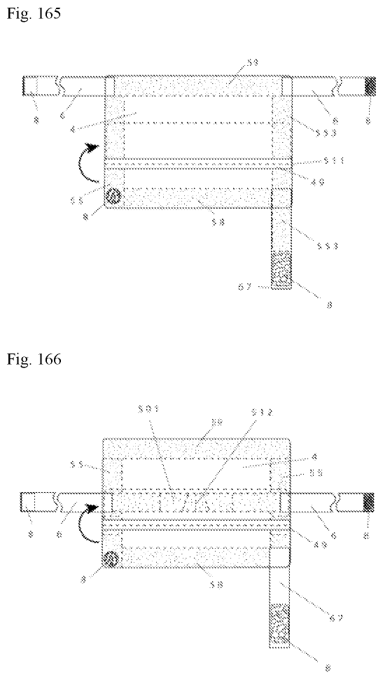

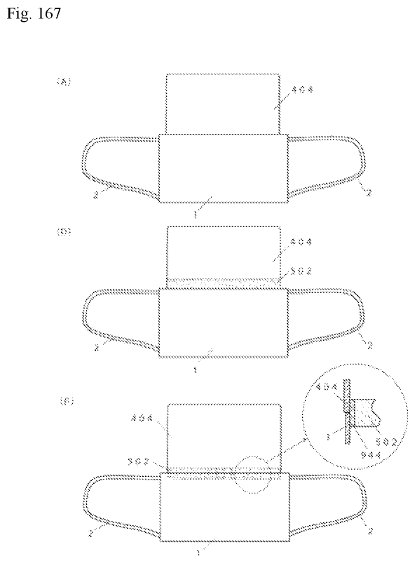

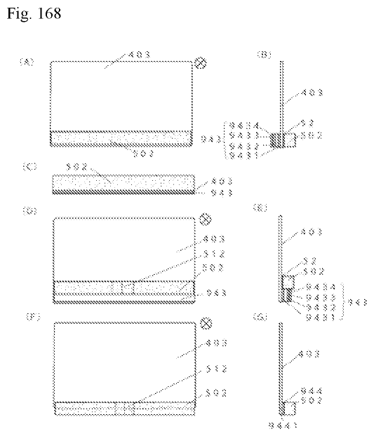

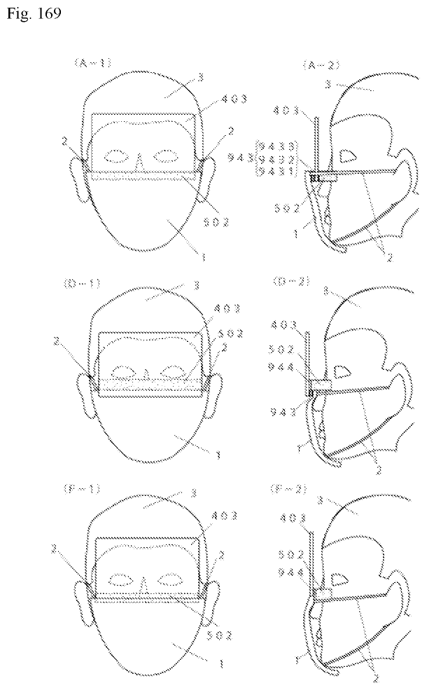

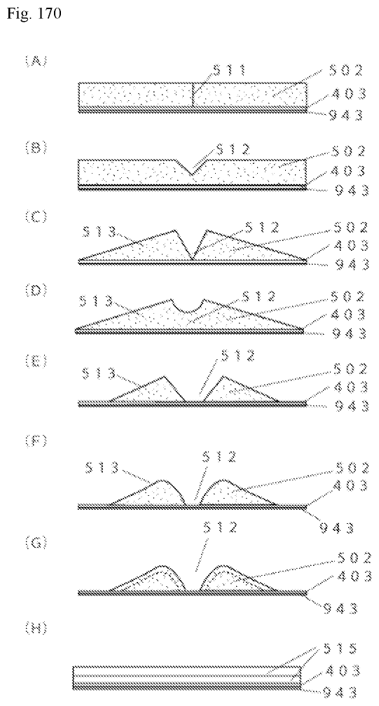

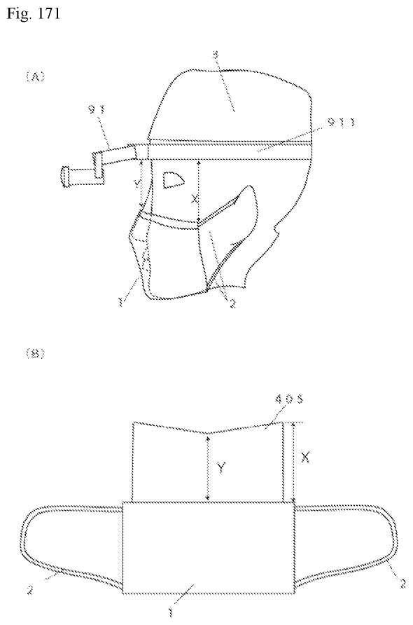

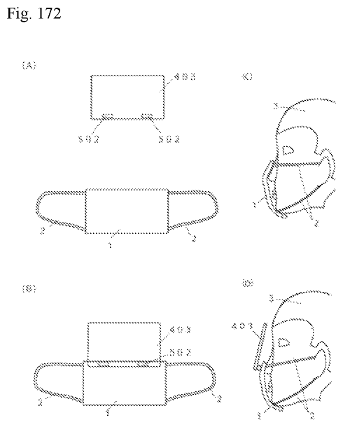

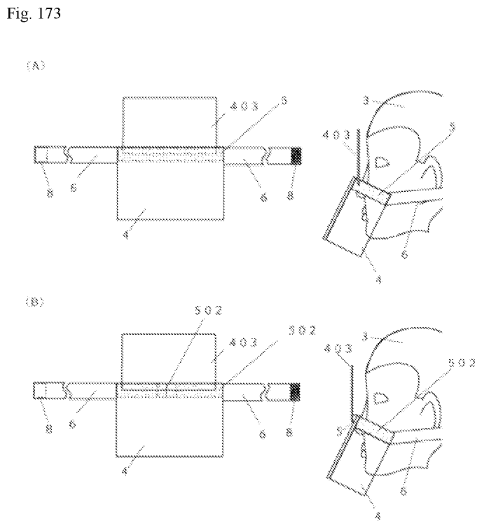

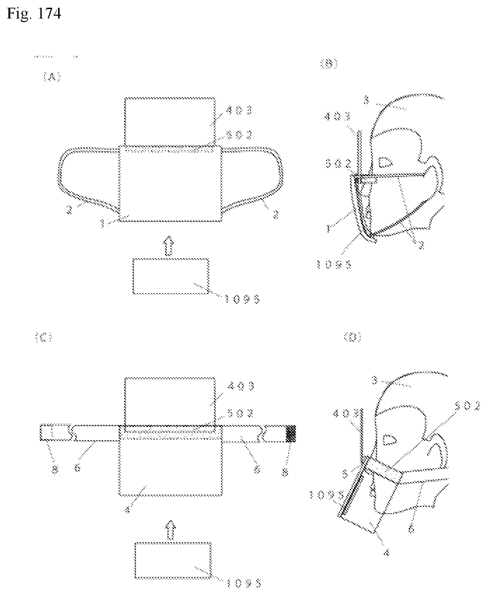

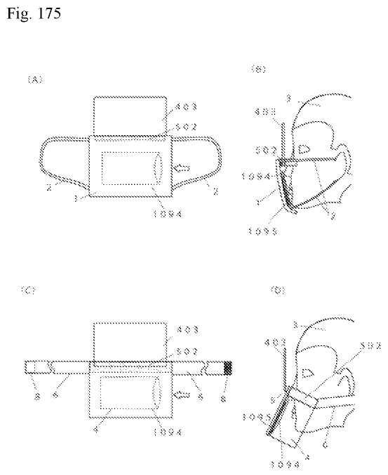

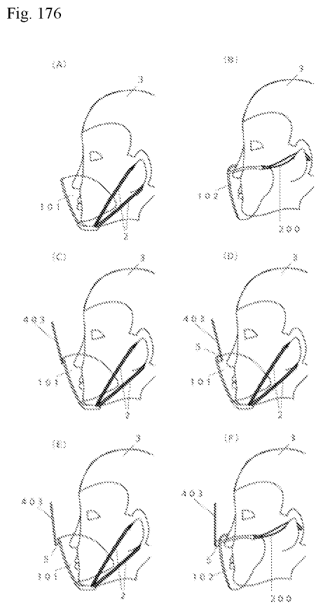

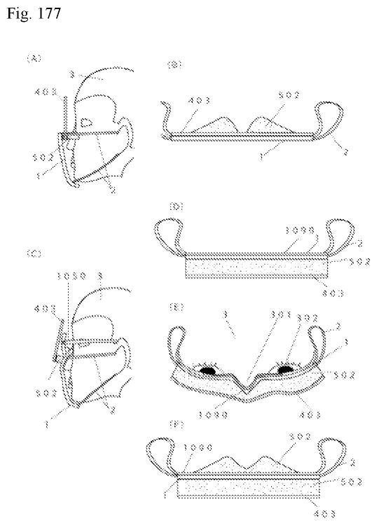

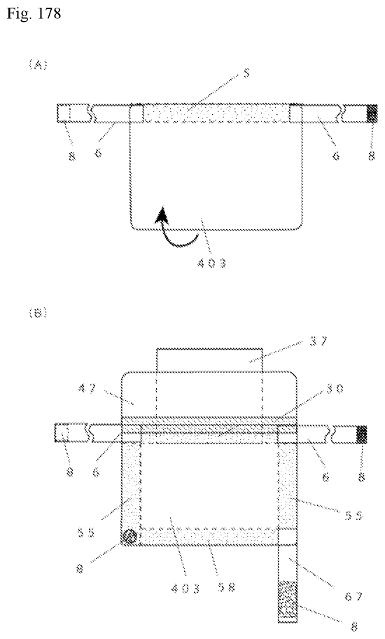

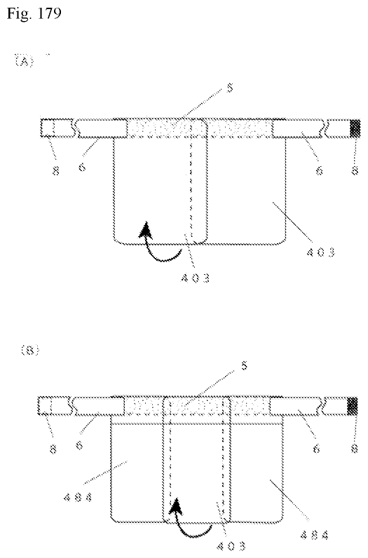

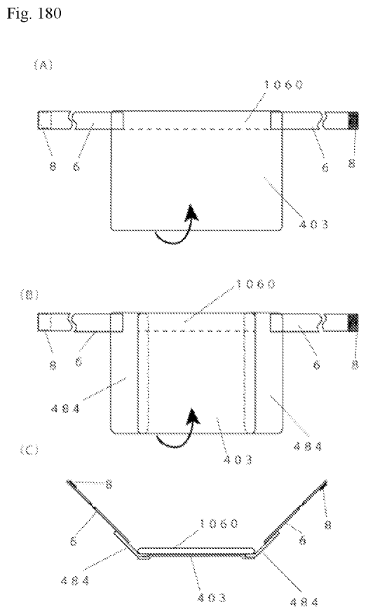

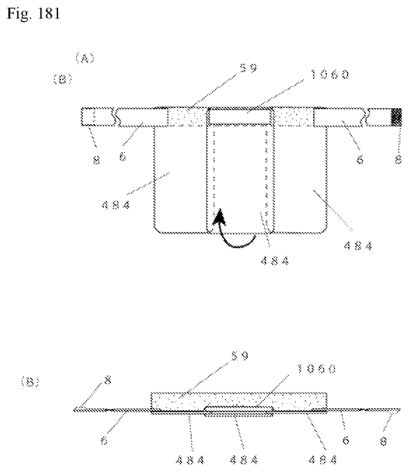

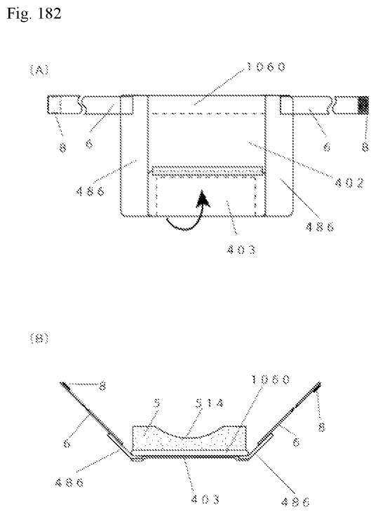

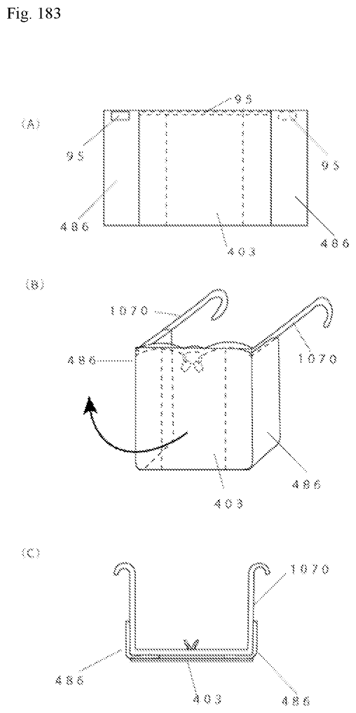

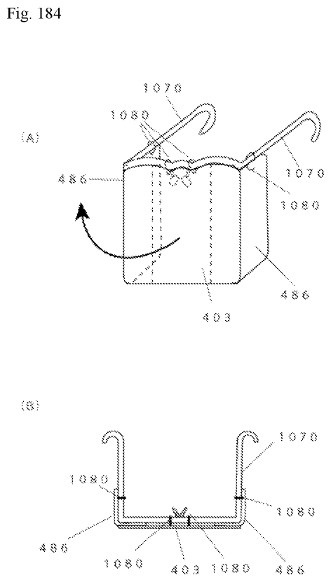

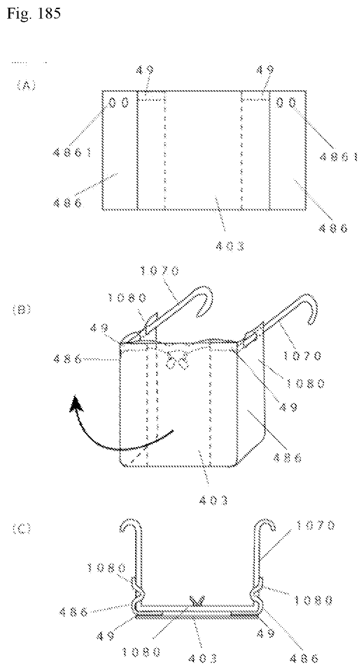

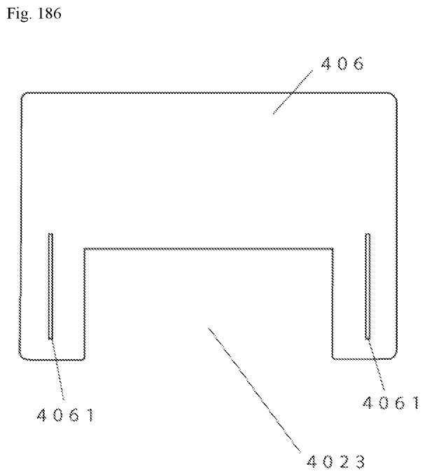

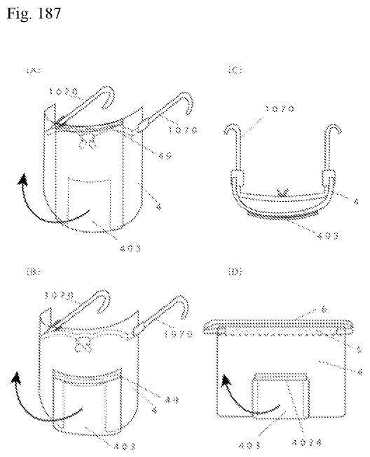

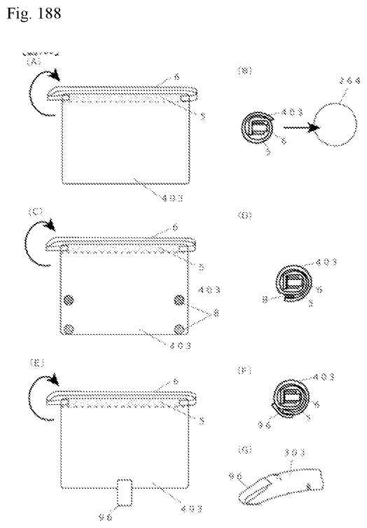

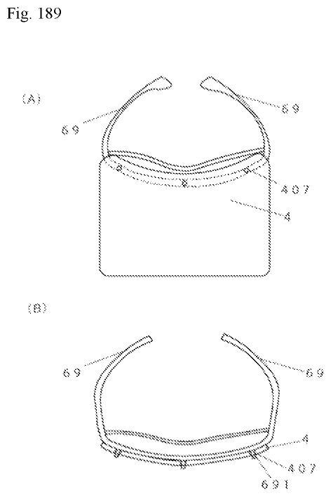

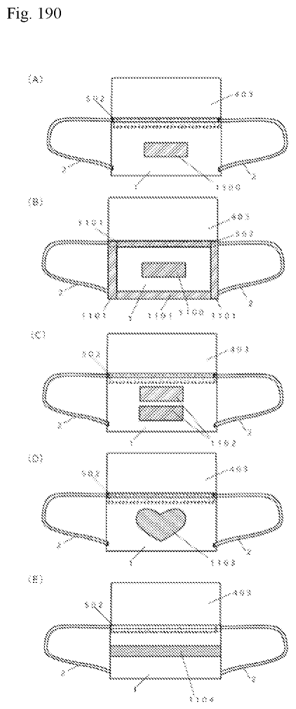

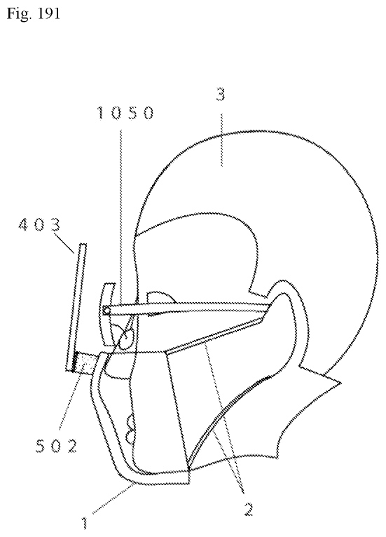

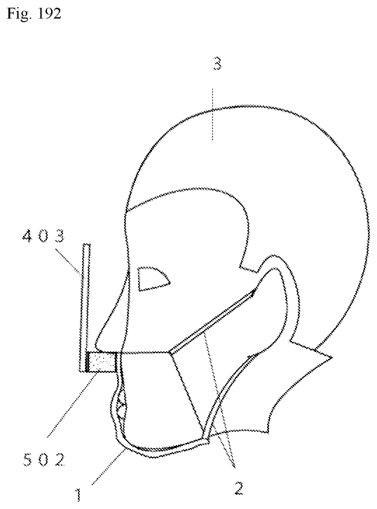

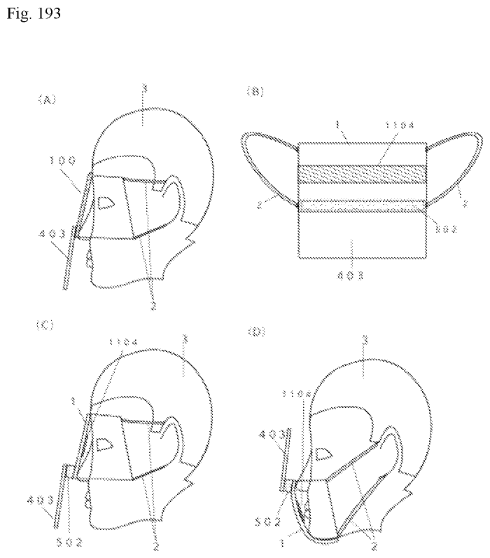

The 67th embodiment of the invention, as shown in FIG. 87, has foam material 391 in place of the aforementioned tetrafluoroethylene 39. This creates a space between the cooling material and the forehead because of the thickness of the foam, which further alleviates the cold air.

The 68th embodiment of the invention, as shown in FIG. 88, is an embodiment in which cooling or heating material 591 is provided inside the head cushion 59, an opening 373 is provided between the two, cooling or heating material 38 is inserted, and a bottom holding part 592 for the cooling or heating material is provided at the bottom thereof.

As shown in FIG. 89, the 69th embodiment of the invention is an embodiment in which a head or face contact area cushion 59 and an elastic band 6 are provided at about ⅓ of the length of a B4 vertical transparent sheet 45, and a cooling or heating material bag 37 is provided. Cooling material 38 are placed in the bag 37 and placed on top of the head or face contact part cushion 59.

The 70th embodiment of the invention, as shown in FIG. 90, consists of, for example, two B5 size transparent sheet, used horizontally, joined together with tetrafluoroethylene, polyimide (e.g. trademark name Kapton) or polyester (e.g. trademark name Mylar) PSA or other tape 30, which can be bent freely, and a cooling or heating materials bag 37 is provided at the location of the transparent sheet 47 for the head. Cooling material or the like is inserted through an opening 373 in the top of the bag 37 and placed over the head or face contact area 59. This has the effect of preventing the transparent sheet 46 for the face from fogging.

The 71st embodiment of the invention, as shown in FIG. 91, is an embodiment in which two transparent sheets are joined as in FIG. 90, a cooling or hearing material bag 37 is provided, and cooling material is inserted and placed over the head or face contact area 59 with the head or face contact area 59 being located farther (d) from the joint 49 of the transparent sheets. This reduces the length of the transparent sheet 47 in the cooling section for the head and increases the length of the face part, providing adequate coverage of the face and at the same time the cooling part reduces the portion of the transparent sheet 47 that is subject to fogging. However, this constitution is sufficient to protect against viruses.

The 72nd embodiment of the invention, as shown in FIG. 92, is an embodiment of two transparent sheets joined together as in FIG. 90, without a cooling or heating material bag, and with the cooling material 38 placed over the head or face contact area 59.

The 73rd embodiment of the invention, as shown in FIG. 93, is an example of a transparent sheet with a vertical side cushion 55 and a cooling or heating material bag 37 provided on the side of the transparent sheet 4.

The 74th embodiment of the invention, as shown in FIGS. 94-95, is a transparent sheet 45 of B4 size disposed vertically, with a cooling or heating material bag 37 (e.g., white non-woven fabric, black or other color-dyed non-woven fabric) for provided above the center of the transparent sheet 45 (FIG. 94), with a cooling or heating material 38 inserted into and wrapped in a bag 37, which is placed on the head or face contact area 59, and held in place by both the transparent pane 45 and head or face contact area 59 (FIG. 95). The degree of coldness or warmth can be adjusted by wrapping in the cooling or heating material 38 bag 37 according to the number of layers of any non-woven fabric as shown in FIG. 95(A) or in three pieces as shown in FIG. 95(B), according to how the bags are wrapped.

A 75th embodiment of the invention in shown in FIGS. 96 to 98, wherein an A4-size transparent sheet 48 with rounded corners is disposed horizontally, and a non-woven fabric or transparent plastic bag with a pattern such as black is provided as a cooling or heating material bag 37, in which cold or warm materials or other small items such as cards, business cards, bills, coins, documents, smart phones, cosmetics, or tissues can be stored. The size of the transparent sheet can be, for example, A4 disposed horizontally, and the transparent sheet can protrude above the head contact area by, for example, 15 mm to prevent dropping of the cooling or heating material. The standard width of the angled transparent sheet may be, for example, 297 mm, the standard height may be, for example, 210 mm, the standard thickness may be, for example, 0.5 mm, the standard distance from the top of the head or face contact area to the top of the transparent sheet may be, for example, 15 mm, the standard opening of the cooling or heating material bag may be, for example, 180 mm, and the standard length from the top of the head or face contact area to the top of the bag may be, for example, 110 mm, but these are not limited to these dimensions.

The cooling or heating material or object container (hereinafter referred to as cooling material, etc.) placed in the cooing material, etc. bag is rolled up and placed on the top of the cushion part and loosely contacts the wearer's forehead. The opening 373 of the cooling material, etc. bag can be sideways ((A), (B)) or facing upward ((C), (d)), as shown in FIG. 96. The size of the transparent sheet can be, for example, A4 disposed horizontally, and the transparent sheet can protrude above the head contact area by, for example, 15 mm to prevent dropping of the cooling or heating material.

FIG. 97 illustrates of the 75th embodiment of the invention, in which the bag 37 is inserted with cooling or heating material or small items 38, is rolled up and held against the transparent sheet 48 and the head or face contact area 594. Cooling material, etc. do not need to be secured on top of the cushion part, and when the mask is worn, the cushion is curved along the wearer's head so that the materials do not fall off. The cooling material etc. does not come into direct contact with the forehead, but rather with a partial gap, so the skin is not damaged by freezing or cold temperatures. The wearer can choose to wear the bag with one layer of non-woven fabric on the forehead side (A) for a greater cooling effect, or with three layers of non-woven fabric (B) for a gentler cooling effect.

FIG. 98 is a diagram of the 75th embodiment of the invention, showing specific dimensions in centimeters. Of course, dimensions other than these are also within the scope of the invention.

The 76th embodiment of the invention is shown in FIG. 99, in which the ends of the head or face contact part 594 are sloped for example at a 45° angle. As shown in FIG. 99(B), both edges of the transparent sheet 45 cover the head or face without gaps, preventing viruses and other contaminants from reaching the head or face, and preventing leakage of temperature, humidity, and air pressure control, controls that are a feature of the invention.

The 77th embodiment of the invention is illustrated in FIG. 100, which shows for example a rectangular or square cooling material, with specific dimensions. (A) is rectangular, e.g., approximately 14×6 cm. (B) is a rectangle consisting of two squares joined together, e.g., approximately 14×6 cm. (C) is rectangular, e.g., approximately 7×6 cm. (A) through (C) are solid granular cooling materials. (D) is rectangular, e.g., approximately 4×5 cm. (D) is a blue gel-like material. Experiments have shown that this gel-like material can provide long-term cooling. It is flexible and aesthetically pleasing.

This is the 78th embodiment of the invention is an embodiment in which two sheets of B5 size, for example, are connected with tape as illustrated in FIG. 92. However, here a single A4 size sheet is used vertically and, for example, the length above the elastic band is 7 cm. (Not shown)

The 79th embodiment of the invention, as shown in FIG. 101, is an example of a transparent sheet 4 with a lens 90 such as a Fresnel lens within the transparent sheet. The Fresnel lens is attached using double-sided transparent adhesive tape around the perimeter of the lens (FIGS. 101-104) or through an arm (see FIGS. 105 and 106) due to the focal length of the lens, and the cushion part 593 is thicker to increase the distance between the eyes and the Fresnel lens. The mask of the present invention enables medical personnel to see objects under magnification while protecting them from coronaviruses and other droplets, thereby preventing viral infections.

The 80th embodiment of the invention, as shown in FIG. 102, consists of a Fresnel lens or other lens 90 on the inside of the two transparent sheets 47 for the head. When the invention is used as a mask, the transparent sheet 46 for the face and the transparent sheet 47 for the head are curved on the same plane as shown in FIGS. 102(A) and 102(B), and when a Fresnel lens is used, the transparent sheets 46 for the face 46 and for the head 47 are folded as shown in FIGS. 102(C) and 102(d).

The 81st embodiment of the invention, as shown in FIG. 103, is designed to narrow the width of the joint between the two transparent sheets so that the transparent sheet 47 for the head can be folded over the transparent sheet 46 for the face while the mask of the invention is being worn. The tape is attached to the front and back of the transparent sheet to provide strength as the connection tape 30 is attached only to the center of the transparent sheet. In addition, the transparent sheets 46 and 47 are affixed with a gap between them, making them easier to fold over and increasing the distance between the eyes and the Fresnel lens.

The 82nd embodiment of the invention, as shown in FIG. 104, is a B4 vertical transparent sheet 45 with a head or face contact part 592 above the center of the transparent sheet 45 and a lens 90 such as a Fresnel lens in the center thereof. By using a B4 size in the vertical orientation, the transparent sheet is disposed that increases the distance between the Fresnel lens and the transparent sheet, allowing the lens to focus.

The 83rd embodiment of the invention, as shown in FIG. 105, is to install a Fresnel lens attachment 901 at the upper end of the transparent sheet 4 and a Fresnel lens or other lens 90 in front of the transparent sheet 4. The Fresnel lens attachment 901 is a movable lens arm that is clamped onto a transparent sheet or otherwise attached.

The 83rd embodiment of the invention, as shown in FIG. 105, is to install a Fresnel lens attachment 901 at the upper end of the transparent sheet 4 and a Fresnel lens or other lens 90 in front of the transparent sheet 4. This allows Fresnel lenses to be used over a wider area and also makes it easier to focus the lens.

The 85th embodiment of the invention is shown in FIGS. 10 and 11 and is characterized by the fact that the lower part of the transparent sheet is curved toward the chin to reduce air and water resistance. (Not indicated in the drawing; see FIGS. 10, 11)

The 86th embodiment of the invention, shown in FIGS. 10 and 11, is a mask characterized by extending the transparent sheet over the entire face and providing a cushion or other forehead support when the transparent sheet makes contact with the forehead (not shown; see FIGS. 10, 11)

This is the 87th embodiment of the invention, and is a mask characterized by the elimination of the cushion and other forehead support parts of the 86th embodiment (not shown). see FIGS. 10, 11)

The 88th embodiment of the invention is characterized by the provision of a bib-shaped sheet (made of vinyl sheet, fabric, non-woven fabric, N95 filter, etc.) 1000 at the bottom edge of the transparent sheet 4, as shown in FIG. 107.

(A) is a front view of the bottom edge of the transparent sheet with the bib-shaped sheet 1000 bonded to the full width of the transparent sheet 4, and (B) is a front view of the bib-shaped sheet 1000 with a window in part of it and an N95 filter 1095 attached thereto. The bib-shaped sheet 1000 may be bonded to the bottom edge of a transparent sheet, for example, with double-sided tape to a width of about 5 mm. The size of the bib-shaped sheet 1000 should be about the same width as that of the transparent sheet, and the length should be about the same as the length of the transparent sheet so that the gap between the transparent sheet and the throat at the lower part of the chin is covered when the invention is worn. Specifically, assuming a B5 size, a non-woven fabric sheet with a width of approximately 250 mm, a length of approximately 200 mm from the bottom edge of the transparent sheet to the bottom edge of the bib-shaped sheet 1000, and a thickness of approximately 1 mm would be suitable for the 1000 bib-shaped sheet.

The material of the bib-shaped sheet 1000 can be a flexible material that does not transmit air, such as vinyl sheet, or an air-permeable material, such as cloth or non-woven fabric, or even a filtering material such as an N95 filter among other air-permeable materials. It is preferable that all or part of the bib-shaped sheet 1000 constitute a filter. The bib-shaped sheet 1000 may be draped over the front of the wearer's clothing or tucked into a jacket. According to (A) in embodiment 88 of the invention, breathing is rendered comfortable through the use of a material that transmits and filters air and the gap between the transparent sheet and the throat at the lower part of the chin through which air can drift in is covered, thus preventing airborne transmission of the novel coronavirus. Moreover, the use of air-impermeable materials can block cold air from circulating around the neck in winter thus keeping the wearer's neck warm. In addition, by tucking the filter inside a jacket or similar item, the filter is kept out of the way while maintaining the seal. According to (B) of the 88th embodiment of the invention, breathing is rendered comfortable and airborne transmission of the novel coronavirus can be prevented, and the neck area is kept warm and protected from the outside air.

The 89th embodiment of the invention is characterized by the narrowing of the curvature of the transparent sheet to prevent aerosol airborne transmission of the novel coronavirus from the side of the face and chin, as shown in FIGS. 108˜111.

As shown in front view 108 and 109 (back view), the transparent sheet 46 for the face is made of A4 size, for sheet, in the horizontal direction, and a horizontal transparent sheet 47 for the head which is one-half the size of the short side of the A4 size, is attached to the top of the transparent sheet 46 for the face using folding connection tapes 30, and an elastic band 6 is secured at both ends of a cushion 59 contacting the forehead, using staples and adhesive material to secure the cushion 59 and transparent sheet 46 together. Between the transparent sheet 47 for the head and the cushion part 59, there is a cooling material bag 37 made of black non-woven fabric or the like, so that mask can keep the wearer cool in the summer. A forehead contact cushion 59, a vertical side cushion 55, and a bottom cushion 58 are provided at the top, side, and bottom of the inside of the transparent sheet 46. A strap 67 is secured to the outside of the bottom side of the transparent sheet 46 with double-sided adhesive 66, and at the other end of the strap 67, a long, thin piece of Velcro is attached with the soft side up in one place or several places if it is round Velcro. On the other hand, a round Velcro 8 is attached to the other bottom side of the transparent sheet 46 with the paired hooked side up. The strap 67 keeps the side of the transparent sheet 46 close to the side of the face and chin, preventing airborne infection of the novel coronavirus as an aerosol from entering through the side of the face or chin area. The role of the 67 strap is not only as described above, but also to halt airborne infection from below and to support the transparent sheet under the chin to prevent it from shifting upward.

FIG. 110 shows the 89th embodiment of the invention, looking backward at the wearer when the invention is worn. Normally, when the transparent sheet is affixed to the head 3 with an elastic band 6 or the like, the curvature of the transparent sheet 46 for the face is widened, and as indicated by the dotted line 461, it is separated from the sides of the face and chin and widens into a fan shape. This creates a large gap between the side of the wearer's face or chin and the transparent sheet 46. In the 88th embodiment of the invention, a strap 67 is provided to narrow the spread below the transparent sheet, and the lower ends of the left and right sides of the transparent sheet are pulled by said strap 67, as shown in FIG. 110. This eliminates the gap between the side of the face or chin and the side of the transparent sheet 46, thereby preventing the novel coronavirus from becoming an aerosol and causing airborne infection.

FIG. 111 shows the 89th embodiment of the invention, looking from above at the wearer when the invention is worn.

This is the 89th embodiment of the invention in which the strap 67 is secured to the bottom of the transparent sheet or near the bottom of the transparent sheet, for a condition in which there is a widening of the curvature of the transparent sheet 46 and the bottom edge of the side thereof is widened as shown in the dotted line 461. The effect is that the gap between the transparent sheet and the face is eliminated on the wearer's face, cheeks, and chin, thus preventing coronavirus infection, The strap 67 has a Velcro 8 joint position that can be changed, so the length of the strap can be adjusted to fit the size of the wearer's face.

According to the 89th embodiment of the invention, it is possible to prevent aerosol airborne transmission of viruses such as the novel coronavirus from the side of the face by narrowing the lateral spread of the transparent sheet. In addition to the effect of being able to offer protection from airborne transmission of viral droplets such as the novel coronavirus horizontally at the strap portion from below, the strap has other positive, such as acting as a chin rest and making the fixation of the transparent sheet 46 to the face more secure.

This is the 90th embodiment of the invention, characterized by the wide chinstrap 67 as shown for example in FIG. 108. The material of the strap 67 can be plastic, vinyl, nylon, non-woven fabric, filter material, etc. The size of the strap 67 can be any width, such as 10 to 150 mm wide, the length of the strap 67 can be, for example, 20 mm for the portion bonded to the transparent sheet, 170 mm for the total length including the bonded portion, and 50 mm for the length of the hook and loop fastener 8 bonded to the tip of the strap 67. The length of the hook and loop fastener 8 bonded to the tip of the strap 67 is 50 mm, and the shape of the strap 67 can be any shape, such as rectangular, trapezoidal, semi-circular, semi-elliptical, etc. These dimensions are examples and other dimensions are also acceptable. According to the 90th embodiment of the invention, the cushion can be pulled from various directions by the strap, so the cushion can make firm contact with the face, the area in contact with the outside air below the transparent sheet narrowed by the strap can be adjusted as desired, and the strength of the strap can be maintained to stabilize the transparent sheet and prevent it from wobbling.

FIG. 112 91st embodiment of the invention with a filter 1067 provided under the chin opening of the curved portion of the transparent sheet 46, viewed from above near the jaw. In this case, the filter 1067 doubles as a strap 67, the material is an elastic filter material, the size is 150 mm wide, and all the curved inner openings below the transparent sheet are covered by the filter 1067 in this embodiment.

FIG. 113 illustrates the 91st embodiment of the invention and is an expanded view of the front view of FIG. 112. One side of the fan-shaped filters 1067 is bonded to the bottom edge of the transparent sheet 46, and a claw-like projections are formed on the arc portion of the fan-shaped filter 1067, which also serves as a strap 67. A hook and loop fastener is provided on the back of the arc projection of the fan-shaped filter 1067 to join the hook and loop fastener 8 on the bottom edge of the transparent sheet 46 with the claw-like projections mentioned above (not shown). In FIG. 112, the aforementioned projections are joined to the hook and loop fastener 8 at the bottom edge of the transparent sheet, and the filter is placed below the transparent sheet without leaving any gaps.

In FIGS. 112 and 113, there are three claw-like projections on the arc portion of the fan-shaped filter 1067 and the locations where they are joined by the hook and loop fastener 8, but the number and locations of these projections is not so limited. According to the 91st embodiment of the invention, the filter is installed at the lower end of the transparent sheet under the chin to prevent aerosols of viruses such as the novel coronavirus from being inhaled by breathing, and the filter does not stick to the mouth. Moreover, it has the effect of dramatically easing respiration because the filter has a large surface area.

The 92nd embodiment of this invention, as shown in FIG. 114, is characterized by having the strap 67 and the under-the-chin filter 1067 provided separately at the bottom edge of the transparent sheet 46. The Velcro 8 fasteners on the strap 67 narrow the lower edge of the transparent sheet as shown in FIG. 111, and the Velcro 8 fasteners on the strap (surface side) and the under-the-chin filter 1067 are used to pull and secure the filter so that it snugly contacts the lower opening of the transparent sheet without gaps. By separating the strap and the filter, it is possible to separately adjust the bonding of the strap 67 and the lower end of the transparent sheet under the chin and the adhesion of the under-the-chin filter 1067, which has the effect of preventing gaps between the filter and the transparent sheet, regardless of the shape of the jaw or face of the wearer.

The 93rd embodiment of the invention, as shown in FIG. 115, is an invention characterized by a horseshoe-shaped sleeve 1010 with a filter 1067 bonded to it, which is fitted into the lower end of the transparent sheet similar to dentures, so that the lower curvature of the transparent sheet is tightened and the filter 1067 seals the lower opening of the transparent sheet. When the transparent sheet is placed on the wearer's head, the bottom edge of the transparent sheet is positioned away from the sides of the face and chin due to the expansion of the mask's curvature. The sleeve 1010 with the filter 1010 of this invention attached is inserted the same way that dentures are inserted into a user's mouth so that the curvature of the bottom of the transparent sheet becomes stronger. The structure, weight, and materials are calibrated to prevent the sleeve from slipping off the bottom edge of the transparent sheet or easily falling out of the curved transparent sheet by the force of expanding the transparent sheet outward and the frictional force between the horseshoe-shaped sleeve and the transparent sheet. The inner curved surface of the sleeve should be made of a material such as rubber or adhesive that adheres well to the transparent sheet. According to the 93rd embodiment of the invention, the filter is attached with a sleeve, which allows for easy filter replacement and the ability to match the horseshoe shape to the size of the wearer's face.

The 94th embodiment of the invention, as shown in FIGS. 116, 117, and 120, is an invention characterized by a vertical side cushion part 553 that also serves as a chin rest with a sloped end face, extending the side vertical cushion of the A4 transparent sheet 48 to the chinstrap 67. FIG. 116 shows (A) a front view and (B) a side view, with a portion of the chinstrap 67 bonded to the side surface of the transparent sheet 48. Of the two vertical cushions on the sides of the transparent sheet 48, the vertical side cushion part to which the chinstrap is bonded is the cushion part 553, which extends to the end of the hook and loop fastener 8 at the end of the chinstrap.

FIG. 117 shows the back of the 94th embodiment of the invention and also shows an enlarged view of the lowest part of the longitudinal side cushion part 553 of the chinstrap 67, which is formed at an angle. When the chinstrap 67 is secured to the transparent sheet with the hook and loop fastener 8, the end of the vertical side cushion part 553 is sloped 45 degrees, for example, so that the end of the vertical side cushion part 553 and the ends of the other vertical side cushion parts make contact without gaps. The angle of inclination is not limited to 45 degrees. The angle should be adjusted to match the wearer's chin shape shape so that the cushion edge contacts the chin without gaps.

FIG. 120 is a front view of the invention when worn by a user. According to the 94th embodiment of the invention, the face is brought into contact with the cushion part 59 on the forehead and the vertical side cushion parts 553 and 55 without any gap between the wearer's face and the transparent sheet 48, which has the effect of preventing sheet that would permit novel coronaviruses from entering the space between the face and the transparent sheet. Furthermore, by inclining the end of the vertical side cushion part 553 when worn by a wearer, the vertical side cushion comes into contact with the wearer's face without gaps, which prevents viruses such as the novel coronaviruses from entering the space between the wearer's face and the transparent sheet. The chinstrap also has a cushion to prevent injury to the chin. The embodiment also has the effect of simplifying the process of manufacturing the invention.

The 95th embodiment of the invention, as shown in FIG. 118, is an invention characterized by an A4-size transparent sheet 48 with a vertical side cushion 551 with a sloping end face and a sloping cushion 552 on the chinstrap 67. The slopes of the end faces of the vertical side cushion part 551 and the sloped cushion part 552 are sloped by 30 degrees, for example, to prevent excessive pressure on the wearer's chin when the chinstrap is worn, as shown in FIG. 120. The other end face of the sloped cushion part 552 is sloped by 45 degrees, for example, as in embodiment 94 of the present invention. These angles of inclination are single examples and can be varied as needed to fit the chin. According to the 95th embodiment of the invention, when the invention is worn, there is no extra pressure on the chin and the gap between the chinstrap and the area under the chin can be eliminated thereby.

The 96th embodiment of the invention, as shown in FIG. 119, is an invention characterized by a vertical side cushion 551 with a sloping end face, two transparent sheets 46, 47 which are joined by a sloping cushion 552 to the chinstrap 67, and a cooling and heating material bag 37. FIG. 119 shows (A) a front view and (B) a side view. A portion of the chinstrap 67 is bonded to the surface of the side of the transparent sheet 46, and on the back side of the chinstrap (the side that contacts the chin when worn), a cushion part 552 for the chin pad is bonded to the chinstrap with double-sided adhesive. Both end faces of the cushion part 552 for the chin rest should be sloped. A transparent sheet 47 is connected to the top of the transparent sheet 46 with 30 tapes such as tetrafluoroethylene, polyimide, or polyester PSA, and a cooling or heating material bag 37 is disposed between the transparent sheet 47 and the cushion 59. In the 96th embodiment of the invention, the effect is to cool the heat on the face by installing a cooling or heating material bag 37 on the upper part of the transparent sheet 46.

The 97th embodiment of the invention, as shown in FIG. 121, is an invention characterized by joining two transparent sheets 46 and 47, providing a longitudinal side cushion 554 with a large, sloped end face, and narrowing the lower end of the transparent sheet 46 with a chinstrap 67 with a cushion 552. FIG. 121 shows cross-sectional views (A) as worn by a wearer and (B) a side view, with the end of the vertical cushion part of the transparent sheet 46 sloping significantly toward the bottom edge from the top edge, with a vertical side cushion part 554. A chin cushion 552 is bonded wot the chinstrap. According to the 97th embodiment of the invention, the cushion 552 can make contact with the concave area under the chin when worn, further reducing the gap between the face and the cushion and preventing viruses such as the novel coronavirus from entering between the face and the transparent sheet.

The 98th embodiment of the invention, as shown in FIGS. 122 and 123, is characterized by a chinstrap and a bib-shaped sheet 1000 (made of vinyl sheet, cloth, non-woven fabric, N95 filter, etc.) at the lower end of the transparent sheet 4. For example, a bib-shaped sheet 1000 is bonded to the bottom edge of a B4 size transparent sheet 4, approximately 5 mm wide on the surface, and is provided along the inside width on the vertical side cushion of the transparent sheet. The chinstrap 67 is separated from the bib-shaped sheet 1000, and when worn, the chinstrap passes through the back of the bib-shaped sheet 1000 and the 8 hook and loop fasteners are joined.

FIG. 123 is a diagram of the 98th embodiment of the invention as worn by a wearer, in which the bib-shaped sheet 1000 covers the bottom edge of the transparent sheet narrowed by the chinstrap 67. The bib-shaped sheet 1000 may be draped over the front of the wearer's clothing or tucked into a jacket. According to the 98th embodiment of the invention, the bib-shaped sheet 1000 covers the bottom edge of the transparent sheet, which has the effect of completely preventing viruses such as the novel coronavirus from entering from outside under the chin, and the large area of the bib-shaped sheet allows easy breathing and provides protection against the cold in winter.

The 99th embodiment of the invention, as shown in FIG. 124, is an invention characterized by the provision of a chinstrap 671 on the side of the transparent sheet 4 in the horizontal direction and the bib-shaped sheet 1000 bonded to the full width of the transparent sheet 4. The strap (chinstrap) 671, which narrows the horizontal curvature, is bonded to the surface of the transparent sheet 4 at one end and has a hook and loop fastener bonded to the back of the other end. A round hook and loop fastener 8 is bonded to the bottom edge of the transparent sheet 4. The chinstrap hook and loop fasteners 8 and the hook and loop fasteners 8 of the transparent sheet 4 are joined when worn. The bib-shaped sheet 1000 is bonded to the bottom rear of the transparent sheet 4. According to the 99th embodiment of the present invention, since a chinstrap 67 is provided in the horizontal direction, a bib-shaped sheet can be provided across the entire width of the transparent sheet without interfering with the chinstrap, which has the effect of preventing viruses such as the novel coronavirus from entering from outside under the chin or from the side of the chin.

The 100th embodiment of the invention, as shown in FIG. 125, is an invention characterized by a vertical strap 67 on a transparent sheet, a bib-shaped sheet 1000 bonded to the full width of the transparent sheet 4, a transparent sheet 47 connected on top of the transparent sheet 46 and a cooling and heating material bag 37 disposed between the transparent sheet 47 and the cushion 59. The bib-shaped sheet 1000 is separated from the chinstrap 67 to which the cushion 552 is bonded and is bonded to the bottom edge of the transparent sheet 46. The transparent sheet side vertical cushion is a large sloped vertical side cushion part 554 . . . is the structure [sic] According to the 100th embodiment of the invention, the cushion 552 and the vertical side cushion 554 adhere to the wearer's face when the mask is worn, preventing viruses such as coronaviruses from entering from the sides, and by providing a cooling and heating material bag 37 on the head, it has the effect of cooling the face and preventing perspiration.

The 101st embodiment of the invention, as shown in FIG. 126, is characterized by an N95 filter 1095, which is a square or rectangular filter that is folded and joined at the ends to form a bag shape (bowl shape) and attached to the transparent sheet 4 to cover the opening of the transparent sheet under the chin in a bowl shape.

The method of making the N95 filter 1095 is as shown in (1), for example, a rectangle that is horizontally long and folded in half at the dotted line to form the shape shown in (2), with a heat seal 92 which is 1 to 5 mm from the bottom edge of the folded filter. The two overlapping filters are folded to form the shape shown in (3), and the the overlapping filters are opened to form a bag shape (bowl shape) as shown in (4). (4) shows a diagonal view from the wearer's side, and the X-mark indicates the mouth of the bag made of N95 filter 1095. The three-dimensional shape in (4) is then pushed in form a flat shape in (5). By using the N95 filter 1095 in the shape of (5), the mask can is rendered portable without being bulky when the transparent sheet is deployed. (6) shows a developed drawing of the invention in which a flat N95 filter 1095 is bonded to a transparent sheet 4 with a vertical side cushion 55 and a chinstrap 671. One straight edge of the N95 filter 1095 (the upper edge in (5) of the drawing) is bonded to the bottom edge of the transparent sheet surface with a width of about 1 to 10 mm, for example with double-sided tape. (7) shows the invention of (6) as it is worn. The N95 filter 1095 becomes a three-dimensional shape along the curved bottom edge of the transparent sheet 4 narrowed by the strap 671, and the transparent sheet opening at the lower part of the wearer's chin is covered by the bag-shaped (bowl-shaped) N95 filter 1095, as shown in (4). According to the 101st example of the invention, the invention is flat, and the filter can be folded for ease of carrying when the invention is not worn. In addition, the bowl-shaped filter at the lower end of the transparent sheet has the effect of preventing coronaviruses and other viruses from entering the space by making breathing less difficult and preventing the incursion of outside air through the lower end opening of the transparent sheet 4.

The 102nd embodiment of the invention, as shown in FIG. 127, is an invention characterized by making the bag-shaped (bowl-shaped) N95 filter 1095 that is bonded to the transparent sheet in FIG. 126(6) a bag-shaped (bowl-shaped) N95 filter 1095 that can be removed from the transparent sheet and replaced.

FIG. 127(1), for example, shows a rectangular N95 filter 1095 joined with PSA double-sided tape 95 on the bottom edge of the filter to make it bowl-shaped, and removable PSA tape 94 on the top edge of the transparent sheet to make the filter it removable and replaceable. (2) shows a diagram of the filter folded in half and the bottom edge bonded to form a bag (bowl shape). The X-mark indicates the mouth of the bag made with N95 filter 1095. Double-sided removable PSA tape 94 is applied to the top edge with release paper on one side thereof (3) is a perspective view of (2) as viewed from the side. (4) shows the three-dimensional shape of (2) as pushed into a flat shape. The N95 filter 1095, which has a flat shape, is attached to the transparent sheet with removable PSA tape 94, as shown in FIG. 126(6). According to embodiment 102 of the invention, the N95 filter 1095 is attached to the transparent sheet with removable PSA tape 94, so the filter can be easily replaced, and the filter remains sanitary and free from secondary contamination such as viruses from the filter. Also, as in (4), only a filter with a flat shape need be manufactured, so there is no cost involved. Further, it has the effect of making the mask conveniently portable.

In the 103rd embodiment of the invention, the mask as shown in FIG. 128 is fixed to the nose with a nose clip 1040. (1)˜(3) show the procedures for fabricating the product, (4) is a front view of the product attached to the face with a nose clip 1040, and (5) is a side view of (4). (1)-(3) are illustrations of a nose and mouth sheet 1020 that may be transparent, opaque, or translucent, or fabricated of an opaque material such as nylon, plastic, PE, PP, or a permeable material such as a filter, nonwoven fabric, piece of cloth, N95 filter, or the like, joined by heat sealing or the like at the joining portion 92 to form a bowl, where the “X” portion is the mouth part 93 of a bowl-shaped pouch. (4) is a front view of the invention as worn on the face, with the nose pinched from both sides by a nose spring 1040, and (5) is a side view of (4). According to the 129th embodiment of the invention, the nose spring is used to attach the product to the face without adhesion, which is less stressful to the skin and causes no bruises or rashes. In addition, by changing the position of the nose spring, the height at which the invention is worn can be freely adjusted, which has the effect of preventing viruses such as the novel coronavirus from entering through the mouth or nose.

As shown in FIGS. 129 and 131, the 104th embodiment of the invention is characterized by the fact that the filter of the 101st and 102nd embodiments (FIGS. 126 and 127) is made into a nose and mouth sheet 1020, which is rectangular, square or other shape, bag-shaped (bowl-shaped) and can be removed and replaced on the transparent sheet or the face. FIG. 129 (1-1) shows removable medical PSA double-sided tape 941 on the top edge of the 1020 nose and mouth sheet, and (1-2) shows elastic bands on the top left and right edges of the 1020 nose and mouth sheet, which can be medical tape or elastic bands or strings (including loops) that loops over the ears, when placed on the face.

FIG. 129(2) shows an oblique view of this nose and mouth sheet 1020 in a bag shape (bowl shape), and FIGS. 129(3-1) and (3-2) show a side view of (2). (3-1) shows removable medical PSA double-sided tape 941 on the inside, which is applied directly to the nose area of the person's face or from the outside bottom edge of the transparent sheet. (3-2) shows removable medical PSA double-sided tape 941 applied on the outside, from inside the bottom edge of the transparent sheet. In the case of a bowl shape with elastic bands or string (including loops), only the nose and mouth are covered by hooking the invention to the ears of the human body and curving it into a bowl shape to enclose the chin. The generally rectangular or square sheet can be made into a bag not only by heat-sealing 92 but also through the use of double-sided tape, adhesive bonding, sewing, or other such methods. The nose and mouth sheet 1020 is placed below the eyes and may be transparent, opaque, or translucent. The material can be curved and may be made of impermeable materials such as nylon, plastic, soft plastic, PE, PP, etc., or permeable materials such as non-woven fabrics, fabrics, or N95 filters that have filtering effects.

FIG. 131 is a 104th embodiment of the invention as worn by a wearer. (A) shows the invention attached with PSA double-sided tape 941 to the bottom edge of a transparent sheet with a vertical side cushion 55, for example. (B) illustrates the invention as attached to a transparent sheet with, for example, a chinstrap 671, which narrows the lateral curvature of the transparent sheet. (C) shows the invention attached to the base of the nose on the wearer's craniofacial surface with removable medical PSA double-sided tape 941. (D) is a side view as viewed from (C). In FIGS. 129 and 131, removable medical PSA double-sided tape 941 was used as the tape for attaching, but not only double-sided tape but also single-sided tape may be used, and removable PSA tape 94 may be used for the transparent sheet.

As shown in FIGS. 129 and 131, the 104th embodiment of the invention is characterized by the fact that the filter of the 101st and 102nd embodiments (FIGS. 126 and 127) is made into a nose/mouth sheet 1020, which is rectangular, square or other shape, bag-shaped (bowl-shaped) and can be removed and replaced on the transparent sheet or the face. FIG. 130 (1-1) shows removable medical PSA double-sided tape 941 on the top edge of the nose/mouth sheet 1020, and (1-2) shows removable medical PSA single-sided tape 942 on the top edge of the 1020 nose/mouth sheet. When removable medical PSA single-sided tape 942 is used, a portion of the tape is applied to the 1020 nasal mouth sheet as shown by the dotted line and affix the unapplied portion to a transparent sheet or the to base of the nose on the face itself. In (1-1) or (1-2), the sheet is folded upward from the dotted line position, and as shown in (2), a portion of both sides of the sheet (dotted line part) may, for example, be joined by heat sealing to make a saucer shape as shown in (3). (3) shows a perspective view of the sheet when it is slightly curved, as seen from the arrow on the wearer's side. N95 or other filters as well as saucer or bowl-shaped filters can be installed, removed, or opened.

FIG. 132 shows the 105th embodiment of the invention as worn, where (A) is the bottom edge of a transparent sheet with a vertical side cushion 55, for example; (B) is a transparent sheet 4 with a chinstrap 671 that narrows the curvature; (C) is worn at the base of the nose with removable medical PSA double-sided tape 941; (D) is a side view of (C). N95 or other filters as well as saucer or bowl-shaped filters can be installed, removed, or opened.

In the 104th and 105th embodiment of the invention, the length of the tape for attaching to the transparent sheet or to the face may be the entire length of the upper side of the nose/mouth sheet 1020, or especially for attaching to the face, it may be approximately 10 mm wide at two locations on either side of the base of the nose.

According to the 104th and 105th embodiments of the invention, a bag-shaped (bowl-shaped) or dish-shaped sheet is removable and replaceable, making the filter inexpensive and always sanitary. When applied to the face, the invention is flat and compact, so it is very convenient to carry and can be worn immediately.

As shown in FIGS. 132 and 133, the 106th embodiment of the invention is characterized by the provision of a bib-shaped sheet (made of vinyl sheet, cloth, non-woven fabric, N95 filter, etc.) 1000 at the lower end of the transparent sheet 4 and the attachment of a neck strap 672 at both ends of the bib-shaped sheet 1000.

FIG. 133 shows a front view, where the bib-shaped sheet 1000 is in the shape of an inverted stepladder, bonded to the bottom edge of the transparent sheet 4, with a neck strap 672 to be wrapped around the neck facing horizontally at the top of both sides of the sheet. A hook and loop fastener 8 is provided at the end of the neck strap 672, which is fastened at the back of the neck to narrow the area below the transparent sheet 4 when the mask is worn.

FIG. 134 is a back view of a 106th embodiment of the invention, in which a cushion is also provided at the upper end of the 1000 bib-shaped sheet to eliminate gaps on the sides of the chin. When wearing the invention, it is secured to the head with the elastic band 6, and the hook and loop fastener 8 of the neck strap 672 is joined at both ends of the bib-shaped sheet 1000 by narrowing the bottom of the transparent sheet 4 behind the neck and pulling it backward so that there are no gaps between the cushion part 59, 55, and the cushion of the bib-shaped sheet upper part and the surface of the wearer's face. According to embodiment 106 of the present invention, the lower part of the transparent sheet 4 is narrowed behind the neck without using a chinstrap, making it easier to join and talk, etc. because there is no chinstrap. The effect is also that the bib-shaped sheet 1000 can be used as a substitute for a thermal muffler. Since the 1000 bib-shaped sheet prevents gaps between the transparent sheet and the face, it has the effect of preventing viruses such as the novel coronavirus from entering the body while facilitating easy breathing.

In the 107th example of the present invention, FIGS. 135, 136 show a bib-shaped sheet (made of vinyl sheet, cloth, non-woven fabric, N95 filter, etc.) 1000 with a window at the bottom edge of the transparent sheet 4 and N95 filter 1095 attached thereto. FIG. 135 shows an N95 filter 1095 provided near the center of the bib-shaped sheet 1000 of FIG. 133. The N95 filter 1095 is placed in such a position that the invention reaches the space under the chin when worn. Since N95 filters are costly, the size can be as small as needed, but of course it is acceptable to use an N95 filter for the entire bib-shaped sheet. N95 filters can be attached by gluing, sewing, or other known methods. FIG. 136 is a rear view of FIG. 135. In embodiment 107 of the present invention, since an N95 filter is provided, even if the material of the bib-shaped sheet is made of an impermeable material such as vinyl sheet, for example, the effect is to prevent viruses without making it difficult for the wearer to breathe.

The 108th embodiment of the invention, as shown in FIG. 137, is an invention characterized by an N95 bag-like filter 1095 provided at the lower end of the transparent sheet 4 and covering the area near the chin in a bowl shape. FIG. 137 shows the method of forming and the structure of the bag-shaped N95 filter 1095, which is provided at the bottom end of the transparent sheet that is narrowed downward when worn by a user. (1) is an overall view of the invention when deployed, e.g., the chinstrap 67 is shown with the chinstrap 67 of the 94th embodiment. B5 or A4 size transparent sheets are used in the horizontal direction. One side of the inverted stepladder-shaped N95 filter 1095 is bonded to the transparent sheet 4 with, for example, double-sided tape 66. (2) shows the size of the N95 filter 1095 as it opens on its own, which is the shortest distance when curved, b is the length of the width of the transparent sheet, c is the direction in which the N95 filter is bent, (3) shows the dotted line in (2) bent in the direction c and heat sealed 92 on both ends, (4) is a diagram of (3) with the bag shape with mouth 93 open at the top due to the difference in length between a and b. The area marked with an “x” surrounded by the ends of the N95 filter indicates the mouth 93 of the bag made with N95. (5) shows a front view when mounted, and (6) is a cross-sectional view thereof. One side of the N95 bag filter 1095 is bonded to the surface of the transparent sheet, and the opposite side thereof is bonded to the underside of the attached chinstrap 67, for example, with double-sided tape 66. The size of the N95 bag filter 1095 is the inverted stepladder shape (trapezoidal shape) illustrated in FIG. 137, but the shape may be set so it is larger than the minimum distance and the width b of the transparent sheet when the lower edge of the transparent sheet is narrowed and curved. In the 108th embodiment of the invention, covering the filter with a bag-shaped (bowl-shaped) filter has the effect of preventing aerosols of viruses such as the novel coronavirus from entering the air to the maximum extent possible, and the large area of the filter makes breathing less effortful.

The 109th embodiment of the invention, as shown in FIGS. 138 and 139, is characterized by a transparent sheet 481 divided horizontally into two parts and joined by a joint 49 such as polyester or other transparent adhesive tape. The size of the transparent sheet before it is divided may be B5 or A4 transparent sheet disposed horizontally that is divided into two parts, top and bottom. As shown in FIG. 139, when not in use, the cushion can be folded so that the side having viruses such as the novel coronavirus adhering to it is on the inside (cushion 59 is on the outside). In embodiment 109 of the invention, by folding the contaminated side of the transparent sheet inward, the invention is easy to carry and effective in preventing secondary contamination.

The 109th embodiment of the invention, as shown in FIGS. 138 and 139, is characterized by a transparent sheet 481 divided horizontally into two parts and joined by a joint 49 such as polyester or other transparent adhesive tape. As shown in FIG. 140, on the outside of the divided transparent sheet 482 (outside of the transparent sheet when worn), a joint 49 is installed horizontally across to the left and right edges of the transparent sheet, and vertically, a joint 49 which divides the sheet in the horizontal direction is installed therein. As shown in FIG. 140, when the divided transparent sheet 482 is worn by a user, the eye position is higher than the joint which divides the transparent sheet in the horizontal direction, so the joint 49 does not obstruct the wearer's field of vision. As shown in FIG. 141, the invention is folded horizontally and then vertically. In FIG. 141, for easy understanding, the joints are long and the gaps between the transparent sheets 482 are shown schematically, but the transparent sheet 482 are flexible, so each transparent sheet 482 is joined by a joint without gaps such that they can be folded horizontally and vertically. In to the 110th embodiment of the present invention, the size of the product is, for example, ¼ of an A4 size sheet when it is carried, making it convenient to carry around. In addition, the effect of this structure is that the view when wearing the device is not obstructed by the joints 49, which do not align with the eyes and do not interfere with the wearer's view.

The 111th embodiment of the invention, as shown in FIGS. 142, 143, is an invention characterized by a transparent sheet 483 divided vertically into two parts and horizontally into three parts and joined together with a transparent joint 49 such as polyester or other transparent adhesive tape. As shown in FIG. 143, the sheet is folded in half horizontally, and then folded twice vertically. In the 11th embodiment of the present invention, the size of the product is ⅙ of an A4 size sheet when it is carried about, making it very small and portable.

The 112th embodiment of the invention, as shown in FIGS. 144 and 145, is an invention characterized by a transparent sheet 484 which is divided vertically into four sections and joined together with joints 49 such as polyester or other such transparent adhesive tape. Each of the transparent sheets 484 has rounded corners. The radius of the corners is an arc with a radius of 1 mm to 6 mm. The size of the entire transparent sheet of the invention is, for example, A4 size, with four transparent sheets 484 connected together, but the size of the entire transparent sheet can be B5 or any other size. The forehead cushion 595 is provided on each of the two central transparent sheets 484, and an elastic band 6 that secures the mask to the wearer's head is provided on the upper edge of the two outer transparent sheets 484.

FIG. 145 shows the sequence in which the 112th embodiment of the invention is folded. When the invention in its stretched form (A), the two outer transparent sheets 484 are folded so that the cushion part 595 faces outward (B), the elastic band 6 is folded at the same time (C), and the two center transparent sheets 484 are folded so that the cushion part 595 faces outward (D). FIGS. 144 and 145 are divided vertically into four sections, but vertical folds into two, three or five sections are also within the scope of the invention. In the 112th embodiment of the present invention, for example, the width of the entire A4 size invention is approximately 74 mm, which has the advantageous effect that it can be folded to a size that can be inserted even into a breast pocket. In addition, all corners of the transparent sheets 484 are rounded off, which has the effect of preventing injury from the corners and making the mask safer.

The 113th example of the invention, as shown in FIGS. 146 and 147, is characterized by a transparent sheet 484 divided vertically into four sections, with a folded plastic band 68 for mounting the mask on the user's head and a small triangular-shaped 596 cushion in the forehead contact area. A forehead cushion 595 is provided on each of the two central transparent sheets 484 only. Additionally, the two outer transparent sheets 484 are provided with small triangular-shaped cushions 596 that contact the edge of the central cushion 595, so that when the invention is mounted on the wearer's forehead, there will be no gaps between the head and the transparent sheets when viewed from above. The plastic band 68 should be bendable, thin, and strong, and may be made of Teflon, vinyl, PE, PP, or PET, even if it is not elastic. The plastic band should have a thickness between 50 and 300 microns and width of 10-30 mm. As indicated by the dotted line in the plastic band 68 in FIG. 146, the band is bent near the bonded area with the transparent sheet and at about ½ of its length to facilitate folding.

FIG. 147 shows the sequence in which the 113th example of the invention is folded. When the invention in its stretched form (A), the two outer transparent sheets 484 are folded so that the cushion part 595 faces outward (B), the plastic band 68 is folded at the same time (C), and the two center transparent sheets 484 are folded so that the cushion part 595 faces outward (D). In the 113th embodiment of the invention, in addition to the effect that the product can be folded and placed in a breast pocket, the right-angled triangular-shaped small cushion 596 allows the forehead and the transparent sheet to adhere closely when worn, and the plastic band 68 reduces the size of the mask when folded, and the plastic band 68 is scored to facilitate folding.

The 114th embodiment of the invention, as shown in FIG. 148, is an invention characterized by an N95 filter 1095, for example, disposed at the bottom edge of the transparent sheet 484. This makes it foldable for portability and makes it possible to take the mask out immediately to prevent viruses from entering the mouth, nose, and eyes with the N95 filter 1095 covering the area below the chin area of the transparent sheet.

The 115th embodiment of this invention is characterized by having a case 261 that can hold the inventions of FIGS. 144 to 145, as shown in FIG. 149. The opening of the storage case 261 has a strap 262 with a hook and loop fastener 8 that is bonded to the storage case to prevent the item stored within from falling out. The material of the storage case 261 is a flexible material less than 300 microns thick, such as plastic, Teflon, vinyl, PE, PP, PET, etc. In the 115th embodiment of the invention, it is possible to carry the invention of the 112th embodiment (FIGS. 144 and 145) without contaminating others with viruses such as the novel coronavirus.

The 116th embodiment of the invention, as shown in FIG. 150, is characterized by having a case 261 with a protruding portion 263 corresponding to the folded-over cushion part that can accommodate the invention of the 113th embodiment (FIGS. 146, 147). FIG. 150 e shows the expanded width of the protrusion and d is the depth of the protrusion. The opening of the storage case 261 has a protruding portion 263 with a depth e of about 40 mm and an expanded width d of the opening of about 10 mm, for example, to correspond to the depth of the cushion of about 30 mm. In the invention of the 113th embodiment (FIGS. 146, 147), the top of the folded transparent sheet 484 is partially thickened due to the small triangular-shaped cushion 596 in the forehead contact area. Therefore, the opening of the storage case may get torn when placed in the storage case of the invention in the 115th embodiment (FIG. 149). However, in the 116th embodiment of the invention, the 113th embodiment of the invention can easily be carried (FIGS. 146 and 147), in which the thickness of the cushion part increases when the mask is folded, without contamination from viruses such as the novel coronavirus, without tearing the case.

The 117th embodiment of the invention, as shown in FIG. 151, is characterized in that the cushion part has a thick cushion part 593 with sloping ends, and the cushion part has a recess 5931 that can accommodate a portion protruding forward from the forehead such as a scope or other lens. This invention is suitable when using scopes such as for dentistry, anesthesiology, etc., and the part of the scope and glasses located at the base of the nose has a thicker overall cushion and recessed notches so as not to interfere with the wearing of the invention. The thick cushion part 593 is 40 mm thick, for example, and can be made as needed between 10 and 60 mm to correspond to the thickness of the eyeglasses or scope adjustment part. The width of the thick cushion can be 30 mm, and the cushion should be 20 to 40 mm wide to stabilize the product it is worn on the head so that it does not wobble. Polyurethane foam is the preferred cushioning material, but surface treatment to reduce dust emissions or a gel-like substance may also be used. The transparent sheet is A4 or B5 size in the landscape orientation. To impart strength, the recesses 5931 are not cut all the way through on both ends of the cushion. The step of the recess 5931 should be such that the step does not interfere with the aforementioned scope or eyeglasses. In the 117th embodiment of the invention, the thick cushion and concave portion of the cushion allows the invention to be properly attached to the head and the transparent sheet to be mounted perpendicular to the face, without blurring or distortion of the wearer's field of vision. In addition, since the scope or eyeglasses are not in the way, the invention does not wobble and can be worn stably.

The 118th embodiment of the invention, as shown in FIG. 152, is an invention characterized by having a sheet 1030 such as a cooling absorbent sheet in the thick cushion part 593. (A) is a back view (to clarify the distinction in the following drawings, an X in a circle indicates the direction in which the invention is viewed from the wearer's side and indicates that this is a back view of the invention), (B) is a top (plan) view, and (C) is a side cross-sectional view. A sheet 1030, such as a cooling water absorption sheet, is provided on the top and sides of the cushion with the exception of the sloped portion of the thick cushion 593 with forehead pad that has sloped ends. Here, the cooling water-absorbent sheet or other sheet 1030 does not need to be bonded or anchored to the cushion. Because the sheet 1030, such as a cooling water-absorbent sheet, is sandwiched between the cushion 593 and the wearer's forehead when worn, the sheet will not fall out. However, for safety, multiple hook and loop fasteners 8 may be provided at the top of the cushion 593 (e.g., two at the left and right ends), as shown in the cross section in (C). For example, a hook-shaped hook fastener (male) is attached to the cushion surface with double-sided adhesive tape, and the hook fastener (male) 8 is directly bonded to the cooling water-absorbent sheet or other sheet 1030. If the surface of the cooling water-absorbent sheet is too smooth, a looped hook and loop fastener (female) should be affixed to the cooling water-absorbent sheet. The cooling water-absorbent sheet should be made of nylon or other fibers that have a cool-to-the-skin feel and a breathable structure that quickly absorbs, diffuses, and evaporates perspiration. As shown by dotted lines in (A) and (C), a recess 5931 for a scope or other lens may be provided, as in embodiment 117. The invention is suitable for wearing when working in anesthesiology, for example. If the invention has a recess 5931 for a scope or other lens, it is suitable for wearing when working in dentistry, for example. In the 118th embodiment of the invention, the effect is to enable efficient work by dentists, anesthetists, etc. while preventing viruses such as the novel coronavirus. In other words, even if the wearer perspires while wearing the mask, the cooling water-absorbent sheet absorbs water to provide a cooling sensation, allowing the wearer to work comfortably. In addition, since the cooling water-absorbent sheet is removable, it can be kept sanitary, and the cushion part will not be damaged.

The 119th embodiment of the invention is illustrated in FIG. 153 and is characterized in that a cooling water absorption sheet 1030 is provided only on the side of the thick cushion part 593, which is in contact with the head. (A) is rear view, (B) is a top (plan) view, and (C) is a side view. The cooling water-absorbent sheet etc. 1030 is provided only on the sides of the thick cushion part 593. Both ends of the cooling water-absorbent sheet etc. 1030 face a hook fastener 8 (male), which is attached to the sloping portion of the cushion part with double-sided adhesive, and the cooling water-absorbent sheet 1030 and thick cushion 593 are joined together thereby. The hook and loop fastener prevents the cooling sheet from dropping out of the cushion. When worn by the user, the invention brings not only the forehead but also the sides of the head into contact with the cooling water-absorbent sheet. The cooling sheet 1030, for example, is approximately 30 mm wide and 300 mm long in the A4 horizontal size transparent sheet and it is replaceable. In FIG. 153, only two hook fasteners 8 (male) are provided on the cushion and no hook fastener is provided on the cooling sheet 1030. Instead, loop-shaped hook fasteners 8 (female) may be provided depending on the type of surface of the cooling sheet 1030. The 8 hook and loop fasteners are circular or semi-circular, about 20 mm in diameter, and may be installed in three or more locations. If the cooling sheet 1030 and cushion are joined and secured in only two locations at both ends of the cooling sheet 1030, such as the cooling water-absorbent sheet described above, the cooling sheet 1030 may sag when the transparent sheet is curved. However, if it is secured with a plurality of hook and loop fasteners, the invention will not feel comfortable against the skin when worn. Therefore, it is preferable to provide 8 hook and loop fasteners in four or fewer locations. As shown by dotted lines in (A) and (C), a recess 5931 for a scope or other lens may be provided, as in embodiment 117. The invention is suitable for wearing when working in anesthesiology, for example. Moreover, if the invention has a recess 5931 for a scope or other lens, it is suitable for wearing when working in dentistry, for example. In the 119th embodiment of the invention, when the invention is worn, there is a sheet 1030 such as a cooling water-absorbent sheet not only on the wearer's forehead but also on the sides of the head, which has the effect of absorbing sweat over a wide area and providing a cooling effect. In addition, since all parts of the sheet, including the cooling water-absorbent sheet, are in contact with the head, the sheet can be used very efficiently and cost-perfectly.

The 120th embodiment of the invention, as shown in FIG. 154, is an invention characterized in that only a sheet 1030 such as a cooling water-absorbent sheet is provided on the transparent sheet making contact with the head, meaning there is no head cushion part. (A) is a rear view, (B) is a top (plan) view, and (C) is a side view. An elastic band 6 with a hook and loop fastener 8 for fastening the mask to the wearer's head is secured to the upper ends of both sides of the transparent sheet 4, and circular hook and loop fasteners (male) 8 are bonded further inside the transparent sheet at the ends of the elastic band. A sheet 1030, such as a cooling water-absorbent sheet, is provided on top of the transparent sheet so that it also covers the ends of the elastic band which is secured to the upper edges of both sides of the transparent sheet 4. A sheet 1030, such as a cooling water-absorbent sheet, is bonded to hook and loop fastener 8 (male), which is attached to the transparent sheet, so it does not drop off when attached. In FIG. 154, there are two hook and loop fasteners 8 (male) bonded to the transparent sheet, but multiple fasteners may be provided depending on the deflection (sagging) of the sheet 1030, such as a cooling water-absorbent sheet. The width of the cooling water-absorbent sheet 1030 is 10 to 50 mm, but the same width as the elastic band is preferred. The thickness of the cooling water-absorbent sheet 1030 should be 0.2 to 5 mm, but in the present invention, where there is no forehead or other contact cushion, so 1 mm or more is preferred. The invention is suitable for wearing otolaryngology, for example. After the invention is placed onto the wearer's head, a concave mirror can also be affixed to the head and on the transparent sheet of the invention to perform the work in a sanitary condition. If the wearer's nose is in contact with the transparent sheet in the invention, a non-foam cushioning material or the like which is in contact with the nose may be provided in the center of the transparent sheet. In the 120th embodiment of the invention, the cushion remains sanitary because it is not made of foam. It also has the effect of absorbing water and providing a cooling sensation when the user is sweating. Furthermore, even when a large-sized object such as a concave mirror needs to be worn on the user's head, it is possible to wear such a large object after putting on the present invention.

The 121st embodiment of the invention, as shown in FIG. 155, is an invention characterized by the provision of a thick cushion 501 for the nosepiece in the center of the transparent sheet indented in a V shape or the like. (A) is a rear view, (B) a top (plan) view, and (C) a side view. In the 87th embodiment, the mask is a transparent sheet that covers the entire face and is held in place by a nose pad. In this invention, a thick cushion 501 with a groove that corresponds to the shape of the nose and a slope (e.g., 15-degree slope) at the cushion end is provided in the center of an A4-size transparent sheet 4 disposed horizontally so as to be worn at the base of the wearer's nose. The thickness of the thick cushion 501 may be 40 mm. It should have a thickness of at least 20 mm, although it can be set arbitrarily between 10 and 60 mm to avoid contact with the forehead. The width of the cushion should be 20 to 40 mm, with a width that allows for stable positioning when worn on the nose. As shown by the dotted line in the center of the thick cushion for nose support 501 in FIG. 155, the groove in the thick cushion for nose support 501 is shaped to conform to the shape of the base of the nose by making the groove wider at the bottom and deeper than the groove width and depth at the top thereof to equalize the pressure of the cushion on the face. It is also acceptable to make the groove into a simple V shape groove. To put on the invention, the user pulls the right and left sides of the transparent sheet with the elastic band 6 with hook-and-loop fasteners 8 to ensure that the sheet makes snug contact with the cushion from the nose to the cheeks. The transparent sheet is then put on and secured the head. The elastic band may be a string (including loops), as in the 10th embodiment, and the material of the thick cushion for the nosepiece, which is indented into a V shape or the like, may be selected as needed. In the 121st embodiment of the invention, the nose, mouth, and eyes are divided into upper and lower sections by the cushion, so that the inhaled air is also blocked and does not enter the wearer's eyes. The air between the upper transparent sheet and the face is heated by the heat emitted by the face which flows upward, making it difficult for outside air to enter the gap between the upper transparent sheet and the wearer's face. In addition, the gap between the lower transparent sheet and the face has the effect of preventing viruses such as coronaviruses from entering due to the heat of exhaled air.

The 122nd embodiment of the invention, as shown in FIG. 156, is an invention characterized by attaching a transparent sheet 401 folded in two while pushing the sheet open. (A) is a rear view, (B) is a top view, and (C) is a side view. (A), (B), and (C) are views of the transparent sheet 401, which is folded at the center dotted line, and the bottom edge of the transparent sheet is provided with a bib-shaped sheet 1000. (D) is a schematic (top view) showing how the transparent sheet is pushed open to put it on, and (E) is a schematic (top view) of the invention on the wearer's face, (D) and (E) shows the invention with the bib-shaped sheet 1000 omitted. The invention is such that the transparent sheet is plastically deformed so that the nose-contacting thick cushion 501, rubber strap 6, bib-shaped sheet 1000, etc. are provided and the transparent sheet is bent into two folds along the dotted line in the center of the transparent sheet as shown in (D), and when the transparent sheet is opened in the direction of the arrow in (D), the force to recover the sheet in the folded direction is applied. (E) schematically illustrates that the face of the wearer's head 3 is sandwiched between the transparent sheet 401 by the recovery force toward the folded side. The nose pad thick cushion 501 has a larger cut in the center so that the transparent sheet does not inhibit bending of the mask. The thickness is also adjusted depending on the resilience of the transparent sheet. An elastic band 6 is not required if the recovery force to press the transparent sheet to the side of the wearer's face is strong enough, and an elastic band or the like may be used. (It is worn like a mask, so to speak.) In the 122nd embodiment of the invention, the wearer's head does not feel tightness cause by an elastic band because the mask is spread out and attached to the wearer's head. In addition, the gap between the wearer's face and the transparent sheet can be reduced, which has the effect of preventing outside air from entering, and since a bib-shaped sheet 1000 is provided, the area under the chin is sealed with a filter, which has the effect of protecting against coronaviruses and other viruses.

The 123rd embodiment of the invention comprises a transparent sheet of the part which is in contact with the mouth that can be opened and closed when the device is worn. The two central transparent sheets 484 are divided vertically into four sections having a door 402 consisting of a transparent sheet that can be opened and closed. (A) is a front view and (B) is a rear view. This invention has an opening and a cover at the bottom of the transparent sheet which can be opened and closed vertically or horizontally so that food can be inserted through the opening and eaten safely even during the COVID-19 pandemic. For example, in FIG. 156, a door 4021 that can be opened and closed in the transparent sheet is provided and is secured with hook and loop fasteners 8 for fastening.

The 124th embodiment of this invention, as shown in FIG. 158, is a single transparent sheet with an opening at the bottom center, and a pair of double doors 4021. The size of the door should be such that the opening of the transparent sheet 402 and the door 4021 partially overlap. This eliminates gaps in the front and protects against droplets containing coronaviruses and other viruses. Removable PSA tape 94 is provided at the edge of the door 4021 and at the edge of the transparent sheet 402, and the removable PSA tape 94 allows the door to be easily secured or removed with minimal force.

The 125th embodiment of the invention as shown in FIG. 159, wherein a door that can be opened and closed is provided in the transparent sheet of the part corresponding to the position of the wearer's mouth when the device is worn, so that food can be ingested. Embodiment (A) is characterized by the lower part of the transparent sheet 402 being folded upward. To fold, if the transparent sheet is thick (e.g., 300 microns or more), the mask is removed and the transparent sheet 4 is flattened and then the bottom of the transparent sheet 402 is folded outward and upward along the solid line so that the dotted line becomes the bottom edge of the transparent sheet. Then, the transparent sheet is curved again and put on. If the transparent sheet is thin (e.g., less than 100 microns), the transparent sheet is slightly deformed so that the lower portion of the transparent sheet can simply be lifted up. The transparent sheet is curved so that the folded portion is secured to the main part of the transparent sheet. This allows the wearer to eat, etc. The transparent sheet 4 is joined to the transparent sheet portion which is folded and to the other transparent sheet portions by joints 49 consisting of polyester or other transparent adhesive tape or the like. The invention (A) has a simple structure in which the lower portion of the folded transparent sheet is secured and opened, which has the effect of enabling lower cost production. In addition, the sides of the transparent sheet also open when the device is worn, making it easier to take meals. The invention (B) is characterized by the provision of a door 402 with an openable/closeable portion on one transparent sheet in the center of the transparent sheet which is divided vertically into three parts. The openable portion is secured with a hook and loop fastener 8 or the like. The invention (C) has a door 402 that can be opened and closed in the lower center of one transparent sheet 4. The doors of the transparent sheets that open and close are secured with hook and loop fasteners 8 or the like. In the 123rd, 124th, and 125th embodiments of the invention, the transparent sheet opening and closing portions are secured with hook and loop fasteners, double-sided tape, and the effect of curvature, so that they can be easily opened and closed for eating while wearing the device.

As shown in FIGS. 160 and 161, the 126th embodiment of the invention is characterized by the fact that the cover is attached to the transparent sheet and can be flipped up. By overlapping the transparent sheet and the transparent cover, when the cover is first flipped up, the flipped-up transparent sheet is not visible. Second, the bottom or both ends can be used as a spring-loaded grip for left- or right-handed users. Third, this constitution has the effect of closing gaps between the mask and the door. As shown in FIGS. 160(A), 160(B), 161(A), 161(B), if the dimensions of the width and height of the opening 4023 of the transparent sheet 402 are 1 and h, respectively, and the dimensions of the width and height of the transparent lid 4021 are L and H, respectively, then 1<L and h<H. L should be longer than the length between one end of the wearer's eyes when the mask is worn, and L and H should be opened long enough for food to pass through. The transparent sheet 402 and the lid 4021 should overlap and align on the vertical side of the transparent sheet opening 4023 by (L−l)/2, and the top of the transparent sheet opening 4023 should overlap the lid 4021 by (H−h)/2. tape or other transparent sheet joint 4024 to join the transparent sheet 402. The bottom edge of the cover 4021 is extended below the bottom edge of the transparent sheet 402 by the length (H−h)/2 to serve as a grip. The overlap between the transparent sheet 402 and the cover 4021 on the vertical side of the transparent sheet opening 4023 should be about 2 mm to 20 mm, but it is preferable for the overlap to be about 10 mm. The length of the bottom edge of the lid 4021 protruding from the bottom edge of the transparent sheet 402 should be 0 to 20 mm so that the sheet can be easily lifted by hand at the bottom, or both ends of the transparent sheet, and 10 to 5 mm is preferred because too much protrusion will interfere with opening. As shown in FIG. 160(B), the 126th embodiment is a transparent cover on three transparent sheets 402, which are connected horizontally, and can be folded, carried in a pocket, and taken out at mealtime for instant use. As shown in FIG. 160(C), when the mask is put on, the lid 4021 is grasped at its bottom edge and the lid 2021 is rotated around the center of the transparent PSA tape or other such joint 4024 as indicated by the dotted line in the direction of the arrow, the transparent sheet 402 deformed and curves along the contours of the wearer's face. When the transparent sheet and the transparent lid are rotated to the top where they overlap, the lid does not rotate downwards and the transparent sheet 402 and the lid 4021 are integrated and fixed in the raised position, thus maintaining the opening. As shown in FIG. 161(C), the transparent lid may be made in any shape, such as a semicircle. The reason for this is that the length of the transparent sheet joint 4024 can be reduced, making it easier to raise and lower the lid 4021. According to the 124th embodiment of the invention, the effect of the mask is that it can be opened and closed instantly with one hand from either the left or right side, allowing safe eating during the pandemic, whereas with a normal mask, it is difficult to remove and put on each time food is put into the mouth.

The 127th embodiment of the invention is characterized by the fact that, as shown in FIG. 162, the transparent sheet 402, which has an opening and closing portion that is long enough to prevent the mouth from being covered, has a rotatable transparent sheet door 4026 with a fulcrum at the head securing elastic band 6 at the bottom thereof. When the transparent sheet door 4026 is installed in this invention, the pivot point of the transparent sheet door 4026 is disposed on the wearer's side, and when the wearer eats, the transparent sheet door 4026 can be lifted upward, allowing the wearer to bring the food to the mouth.

As shown in FIG. 163, the 128th embodiment of the invention is characterized by sliding the transparent sheet door to open and close the lower part of the transparent sheet. (A) is a transparent sheet 402 with an opening/closing portion with pins 4028 on both sides, connected by these pins to a sliding transparent door 4027 with provided with grooves, with holes at both ends of the groove to arrest the sliding, so that the transparent door 4027 can be slid upward to insert food into the wearer's mouth when eating. (B) connects the transparent door 4027 with a pin 4028 to the transparent sheet 402, which is grooved in a way that allows it to be fastened. When the wearer eats, the transparent door 4027 can be slid open to allow food to be inserted into the wearer's mouth. For example, as shown in FIG. 163, a groove is formed in the shape of an inverted J that is positioned on the side of the door when the mask is worn by the user so that the transparent door 4027 can be bent to prevent it from falling when it has been slid upwards.

In the 129th embodiment of the invention as shown in the front view of FIG. 164(A), the size of the transparent sheet 485 is not a B5 or A4 size as in other embodiment. Rather, the length of the transparent sheet 485 is reduced and the vertical length is about 105 mm, and the horizontal length is about 297 mm, for example. The width of the strap may be about 25 mm and the thickness of the cushion 594 may be 20 to 40 mm, as shown in the top view of FIG. 164(B), and is sloped at an angle, such as 45 degrees, at both ends thereof. FIG. 164(C) is a front view of publicly-known masks 1, 2 and masks 485, 594 of the present invention as worn by a wearer 3. For example, by using a cushion 594 about 40 mm thicker than usual, the mask will not fog up when used in combination with a mask of the prior art, and eyeglasses can also be worn. The 129th embodiment of the invention is effective in preventing the incursion of viruses such as the novel coronavirus through the eyes, which are not covered by masks of the prior art. Moreover, publicly-known face shields render it impossible to eat or drink, whereas this embodiment has the effect of making it possible to eat or drink. Furthermore, while publicly-known masks and face shields cause the face to become hot, the present invention has the effect of preventing the face from becoming hot. Moreover, while publicly-known face shields tend to shift or come off when the wearer's neck (face) is turned or when looking down, bumping into shoulders or clothing, this embodiment has the effect of not shifting or coming off because it does not bump into the wearer's body even when the neck is bent at a steep angle or when the wearer is looking down. Furthermore, the mask of this invention is half the size and half the weight of publicly-known face shields, making it compact and portable.

The 130th embodiment of the invention has a thick nose cushion 501, a head cushion 59, a vertical side cushion 553 that also serves as a chin rest, a vertical side cushion 55, and a lower cushion 58 which are provided on a transparent sheet 4, which is separated into two pieces, for example, at the bottom ⅓ of its length, and the two separated pieces can be freely rotated with a connector 49 as shown by the arrow in the figure. To use this embodiment when eating or drinking, the invention is removed from the face, the lower part of the transparent sheet 4, is folded at about ⅓ of the transparent sheet 4, like an arrow, and overlapped with half of the upper ⅔ portion thereof, and this embodiment is put on the face, the transparent sheet 4 and the folded ⅓ portion will be curved and secured with the ⅓ portion overlapped with the ⅔ portion. The vertical side cushion part 55 and the vertical side cushion part 553, which also serves as a chin rest, have a cut 511 in the cushions so that the cushions do not impede folding back at the separation position of the transparent sheet 4. When the invention is worn by a wearer, the chinstrap 67 is used to narrow the lower portion of the transparent sheet 4. However, only when eating, the lower portion of the transparent sheet 4 is partially opened by the procedures of the invention for eating and drinking.

Similar to FIG. 165, the 131st embodiment of the invention is shown in FIG. 166, with the elastic band 6 positioned in the center of the transparent sheet 4, rather than at the top of the transparent sheet 4 as in the 130th embodiment.

A thick nose cushion 501, a head cushion 59, a vertical side cushion 553 that also serves as a chin rest, a vertical side cushion 55, and a lower cushion 58 are provided on a transparent sheet 4, which is separated into two pieces, for example, at the bottom ⅓ of its length, and the two separated pieces can be freely rotated with a connector 49 as shown by the arrow in the figure. The thick nose cushion 501 has a nose-shaped indentation 512 that corresponds to the shape of the nose and adheres to the wearer's face without gaps. The thick nose cushion 501 is 20 to 40 mm thick, while the head cushion 59, the vertical side cushion part 55, the vertical side cushion part 553 that also serves as a chin pad, and the lower cushion part 58 are 10 to 30 mm thick. This allows the thick nose cushion 501 to conform closely to the wearer's nose and to separate the eyes from the nose and mouth when the invention is worn by the wearer 3 using the elastic band 6. The head cushion 59, the vertical side cushion 55, and the vertical side cushion 553 which also serves as a chin rest, make contact with the face to block outside air. In addition, the lower cushion part 58 and the chinstrap 67 can eliminate gaps between the transparent sheet and the face in the vicinity of the cheeks and the chin.

In the 130th and 131st embodiments of the invention, the transparent sheet 4 can block the outside air without gaps with the wearer's face and has the effect of preventing viruses from entering through the eyes and nose when eating or drinking. Furthermore, in the 127th example, the thick nose cushion separates the wearer's nose, mouth, and eyes from the space between the transparent sheet and the wearer's face, so the transparent sheet in the vicinity of the eyes does not fog up due to exhaled air.

The 132nd embodiment of the invention, as shown in FIG. 167, is characterized in that a publicly-known mask 1, for example, having a breathing part covering the nose and mouth with non-woven fabric or cloth, is provided with an ear loop elastic or string, and a film transparent member 404 with a thickness of about 100 or 75 microns which is attached to this mask as an integral part thereof, and the inside of the film transparent member 404 and cushion 502 and known mask 1 are secured by an adhesive part 944 for combined use as a cushion. FIG. 167 132nd embodiment of the invention: This is a front view of the transparent film transparent member 404 which is bonded to a mask of the prior art 1 wherein (A) is a front view of the transparent film transparent member 404 which is bonded and fixed to a mask of the prior art 1, (D) is a front developed view of the invention of FIG. 168(D) with the publicly-known mask 1 bonded and fixed, and (F) is a front developed view of the invention of FIG. 168(F) with the publicly-known mask 1 bonded and fixed thereto. The method of bonding and securing is not limited to this embodiment, in which an adhesive is used, but welding, sewing, bonding, or other methods to make a mask of the prior art 1 into an integral part can be used to bond and secure the contact [sic] transparent sheet 404, cushion 502, and publicly-known mask 1 into an integral whole by welding, sewing, bonding, or other methods. Since the 132nd embodiment of the invention is an integrated type, the eyes can be protected at the same time, just like wearing a conventional mask, and it can be folded for easy storage.

The 133rd embodiment of the invention, as shown in FIG. 168, features a film transparent member 403 with a nose cushion 502 at the lower end of the film transparent member 403, which can be attached to and detached from the mask 1, and is put onto the head 3 with an elastic band 2 of the mask 1 which is to be worn on the face. As shown in FIGS. 168(A), 168(B), and 168(C), a transparent member 403, which is a horizontal rectangular film about 100 microns or 75 microns in thickness, has a nose cushion 502 which contacts and is supported by the wearer's nose on inside of the film as worn, and a removable adhesive part 943 is provided on the film surface of the film transparent member 403 that is outside when worn and uses an adhesive 52. The removable adhesive part 943 which is bonded to the film transparent member 403 consists of permanent PSA tape 9431, a carrier 9432, a removable or permanent PSA tape 9433, and a release paper 9434, as shown in (B). As shown in (C), a nose cushion 502 and removable adhesive part 943 are provided from the left side to the right side of the film transparent member 403. In the 133rd embodiment, the removable adhesive section 943 consists of removable PSA tape 9433, and in the 132nd embodiment, the removable adhesive part 943 is bonded and secured using permanent PSA tape 9433. FIG. 168(d) shows other constitutions with different locations of the nose pad cushion 502 and removable adhesive part 943 in the 133rd embodiment, wherein the removable adhesive part 943 is provided on the interior edge of the film transparent member 403. FIG. 168(e) illustrates a cross-sectional view of FIG. 168(d). FIGS. 168(f) and 168(g) show a rear view (f) and a side cross-section (g) of another form of the 133rd embodiment. On the inner side of the transparent member 403, which is a horizontal rectangular film of about 100 or 75 microns in thickness, a nose cushion 502 is provided to protrude approximately half the width from the lower end of the transparent member 402 to contact and support the wearer's nose when worn. This nose cushion 502 is bonded to to the film transparent member 403 with cushioning adhesive 944 that adheres to the publicly-known mask 1. A release paper 9441 is provided in the cushioning adhesive part 944 in the portion of the film transparent member 403 that protrudes, for example, about half the width from the bottom edge of the film transparent member 403, as shown in (G). Similar to the removable adhesive part 943, the cushioning adhesive part 944 consists of a permanent PSA tape, carrier, removable or permanent PSA tape, and release paper (not illustrated). The inventive products shown in the 133rd and 132nd embodiments are attached to the top of the prior art mask 1, which is a known head attachment which covers the mouth and nose, after the release papers 9434 and 9441 have been peeled off, the nose cushion 502 and film transparent member 403 are bonded to the top of the mask 1 and put onto the wearer's face and head by means of temple tips 2 or the like. The film transparent member 403 of the 133rd embodiment is a very thin sheet, 50-200 microns in thickness, 100-210 mm in width, and 50-180 mm in height, and is made of a transparent material such as PP or PET. Its thickness should be about 100 or 75 microns to make the mask light in weight, and the width should be about 170 mm to correspond to the size of masks of the prior art, and its height should be about 100 mm, but the invention is not limited to these dimensions. The nose cushion 502 should be about 10 mm wide and about 20 mm thick, and its length should be equal to the length of the transparent sheet or shorter than masks of the prior art 1. The width should be 10 to 30 mm, as it should be adjusted according to the size of the wearer's face and nose, the degree of adhesion and comfort desired, and the presence or absence of eyeglasses. The thickness of the nose cushion 502 should be 10 to 40 mm to prevent contact with the eyes and eyeglasses. Although it is better for it to be thick, it is less than 40 mm because the mask can be jostled and become unstable when worn by the user when the cushion is narrow in width. The removable adhesive part 943 and the cushioned adhesive part 944 consist of double-sided adhesive tape that is wide enough to adhere to the top edge of the mask 1, not to peel off or interfere with the wearer's vision when the mask is worn, and has a width of 3 to 25 mm. A width of from 5-10 mm is preferable. Moreover, the cushion joined so the bonded film transparent member 403 and the publicly-known mask 1 can be freely attached and detached, so they be joined by pressing together of hooking with hook and loop fasteners, tape, clips, etc. The hook and loop fastener (male) may be provided on the film transparent member without hook and loop fastener on the publicly-known mask side. Also, the film transparent member 403 has an antireflective treatment on both sides thereof to make it easy to see since this member is provided in front of the eyes. In addition, antifogging treatment is applied to the inside of the film transparent member since humidity and exhaled air rise to the top through the gaps in the mask and humidity rises due to body temperature.

FIGS. 169(A-1) and (A-2) of the 133rd and 132nd Examples of the invention are front and side embodiments are views when the invention, in the form of (A) in FIGS. 167 and 168, is worn, and a publicly-known mask 1 is bonded with removable or permanent PSA tape 9433 on the outer lower edge of the film transparent member 403 after the release paper 9434 is peeled off, and worn so that the nasal cushion 502 contacts the wearer's nose area without gaps and the film transparent member 403 is provided in front of the wearer's eyes. FIGS. 169(A-1) and (A-2) of the 133rd and 132nd Examples of the invention are front and side embodiments are views when the invention, in the form of (A) in FIGS. 167 and 168, is worn, and a publicly-known mask 1 is bonded with removable or permanent PSA tape 9433 on the outer lower edge of the film transparent member 403 after the release paper 9434 is peeled off, and worn so that the nasal cushion 502 contacts the wearer's nose area without gaps and the film transparent member 403 is provided in front of the wearer's eyes. FIGS. 169(F-1) and (F-2) of the 133rd and 132nd embodiment of the invention are front and side cross-sectional views when the invention, in the form of (F) as illustrated in FIGS. 167 and 168, is attached to the wearer's head 3, with the transparent sheet 403, the nose pad cushion 502 and the top edge of the publicly-known mask 1 with adhesive 944, which is a cushioning adhesive, with release paper 9441 has been removed. In FIG. 169, the film transparent member was indicated by number 403 in the 133rd embodiment is the film transparent member 403 in FIG. 169 which is replaced by the film transparent member 404 which is the 132nd embodiment. The bonding of the removable or permanent PSA tape 9433 or cushioning adhesive 944 to the publicly known mask 1 is removably bonded in embodiment 133 and bonded and secured in embodiment 132, but the bonding to the publicly known mask is not limited to the adhesives mentioned above. The 133rd embodiment of the present invention has the effect of being easily attachable, removable, and interchangeable with publicly-known masks, and is easy to use. In the 132nd and 133rd embodiments, by separating the mouth, nose, and eyes with a cushion which is in contact with the nose, the exhaled air which is generated upward by publicly known masks is blocked by the cushion and does not enter the eyes. Moreover, the transparent sheet does not fog up and prevents viruses such as the novel coronavirus from entering the eyes from the outside. In addition, the cushion is fitted with indentations that conform to the shape of the wearer's nose, which has the effect of making the cushion adhere more closely to the wearer's nose. Moreover, costs are reduced by the use of an adhesive that also serves as cushioning material.

As shown in FIG. 170, the 134th embodiment of the invention is characterized in that the nose cushion 502 which is provided at the bottom of the film transparent member 403 is in a form that allows it to contact the wearer's nose without gaps in conformance with the shape of the nose. FIG. 170 (B) is a form with a V-shaped groove, a nose-shaped indentation 512, in the position (approximately in the center) of the nose pad cushion 502 that contacts the area near the bridge of the nose when the cushion is worn by the wearer. (C) is a form in which a deep groove dividing the V-shaped cushion in two is provided as a nose-shaped indentation 512 in the position (approximately in the center) of the nose pad cushion 502 that contacts the vicinity of the bridge of the nose when worn, and further, a slope 513 is provided in the thickness of the cushion from the left and right ends of the nose pad cushion 502 toward the center thereof. (D) is a form with a rounded indentation for the nose and a sloped shape. (E) is a form with a sloped shape where the cushion is separated into two parts at the part where the nose is contacted. (F) is a form of the nose pad cushion 502 with a rounded and sloped shape in the form of (E). (G) is the form of the nose pad cushion 502 that becomes smaller toward the tip of the nose in conformance with the shape of the wearer's nose and can effect further contact with the wearer's nose without gaps or spaces. (H) is a form of nose pad cushion 515 made of soft cloth such as a non-woven fabric to improve the feel of the cushion material This can prevent chafing of the skin of the wearer's skin nose.

The 135th embodiment of the invention as shown in FIG. 171 has a nose cushion part 502 is provided at the lower end of a transparent member 405 with the upper side of the film transparent member in the shape of a V which is placed upon the wearer's face. In FIG. 171(A), when wearing a publicly known mask 1, the top edge of the publicly known mask is higher in the area which makes contact with the nose and lower in the area which makes contact with the cheeks, relative to the horizontal plane of reference. By measuring the heights (X and Y in the figure) between the top of the publicly known mask to the strap 911, which is used to secure, for example, a scope used by medical personnel, and by setting the length X at the edge and Y at the center at the height from the top of the V-shaped film transparent member 405 and the top of the publicly known mask 1, as shown in FIG. 171(B), the invention can be applied without coming into contact the scope when a scope is being worn by a user. The specific specifications are as follows: the V-shaped film transparent member 405 is a horizontal rectangular film about 100 microns thick with a V-shaped top surface and is joined to a publicly known mask using removable or permanent PSA tape. The invention is attached to the mask by means of publicly known mask 1 ear loop elastics 2. The width of the V-shaped film transparent member 405 should be equivalent to that of publicly-known masks, and the height should be, for example, X=55 mm and Y=65 mm, with a difference of about 10 mm, but both X and Y should be set between 30 and 100 mm depending on the shape of the wearer's face. This embodiment suggests V shape, but the invention is not limited to this. The shape of the top edge of the film transparent member can be optimized to suit the product that is to be worn. Shapes in which the top edge shape of the film transparent member is non-linear are included within the scope of this invention. Although a nose cushion part 502 at the lower end of the transparent member 405 has thus far been described, the invention also includes a form in which there is no nose cushion and a V-shaped film transparent member 405 is bonded directly to the upper end of the publicly known mask. According to this 135th embodiment, even if there is a strap or the like to be secured to the wearer's head such as a scope, the invention can be used without making contact with such a device or obstructing the wearer's view.

The 136th embodiment of the invention, as shown in FIG. 172, is an example in which a cushion which is applied to the wearer's nose is partially provided outside the mask on the inside of the bottom edge of the film transparent member 403. FIG. 172(A) shows a cushion on the inner lower portion of the film transparent member 403. Removable or permanent PSA tape should be used for adhesion. As shown in FIG. 172(B), the film transparent member 403 is applied to the top edge of the mask 1. FIG. 172(C) is only for when a normal mask 1 is worn. If a film transparent member is provided with the mask 1 without a cushion, the surface of the mask 1 is tilted along the nose, and the film transparent member will come into contact with the upper part of the eyes and the forehead. However, as shown in FIG. 172(d), when the film transparent member 403 of the invention is worn, the effect is that it does not come into contact with the wearer's forehead or other parts of the wearer's body and can be worn in comfort. Cushions may be provided across the film transparent member 403 in addition to the two locations as shown in the embodiment. The cushion should be 5 mm to 30 mm high, as a low cushion height will come into contact with the forehead. About 10 mm is suitable. The cushion may be angled to further prevent contact with the forehead. The film transparent member 403 has an antireflective treatment on both sides thereof to make it easy to see since this member is provided in front of the eyes. In addition, antifogging treatment is applied to the inside of the film transparent member since humidity and exhaled air rise to the top through the gaps in the mask and humidity rises due to body temperature. According to this 136th embodiment, the cushion has the effect of making it possible to install the film transparent member away from the wearer's eyes.

The 137th embodiment of the invention is an invention with a film transparent member 403 on a transparent sheet of this patent application with a nose cushion (e.g., 5th embodiment, FIG. 10), as shown in FIG. 173. (A) is a developed front view and side view of the transparent sheet 4 with the film transparent member 403 disposed between the cushions 5 of the transparent sheet 4 and a side view of it when the device is worn; (B) is a developed front and side view of the transparent sheet 4 with the film transparent member 403 with a cushion on the outside thereof When providing a film transparent member 403 on the inside as in (A), the nosepiece cushion 5 is already provided on the transparent sheet, so it can be inserted between the cushion 5 and the transparent sheet 4 or bonded inside the cushion 5. If the height of the cushion 5 causes the film transparent member 403 to come into contact with the wearer's forehead when worn, it should be bonded diagonally into the cushion as shown in the figure. When providing a film transparent member 403 outside the transparent sheet 4, as in (B), the film transparent member 403 may be directly bonded to the transparent sheet 4, but preferably, a film transparent member 403 with cushion 502 should be used. In the 137th embodiment, it is possible to provide detachable features on the transparent sheet of the invention to provide further protection to the eyes.

The 138th embodiment of the invention is provided with a non-woven fabric on the inside of the transparent sheet or mask corresponding to the location of the wearer's mouth and nose, as shown in FIG. 174. FIG. 174(A) is a front view of the mask 1, with the film transparent body 403 with the cushion 502 bonded to it, and the nonwoven fabric 1095 provided on the inside of the mask 1. (B) is a side view of the invention as worn. The nonwoven cloth may be, for example, an N95 filter, and the width of the nonwoven cloth should be smaller than the width of the mask 1 and larger than the width of the wearer's mouth. The vertical height should be sufficient to cover the wearer's mouth and nose. FIG. 174(C) is a front view of the invention with a film transparent member 403 on a transparent sheet 4 with a nose cushion 502 place on the wearer's head with an elastic band with the nonwoven fabric 1095 inserted into the product and (D) is a side view as worn by a user. N95 or other non-woven fabric 1095 is bonded to the inside of transparent sheet 4 with a removable adhesive. Since the transparent sheet 4 is sloped when mounted on the wearer's nose, the film transparent member 403 is bonded to the outside of the transparent sheet 4 by inserting a sloped cushion 5 or similar material into the film transparent member 403 to prevent it from contacting the wearer's forehead. In the 138th embodiment, the insertion of the 1095 non-woven fabric has the effect that the transparent sheet 4 and the film transparent member 403 do not fog up and the wearer's own droplets do not reenter the mouth.

The 139th embodiment of the invention is in the form of a bag 1094 with a non-woven fabric inserted therein, as shown in FIGS. 175. (A) and (C) are front views with the bag deployed; (B) and (D) are side views with the bag attached. The bag 1094 is bonded to the inside of the mask 1 and transparent sheet 4. The bag 1094 is inserted, if necessary, from the side, as indicated by the arrow, with a non-woven fabric 1095 such as N95. According to the 139th embodiment, since the non-woven fabric is inserted into the bag, it is easy to insert and remove the non-woven fabric, and the effect is that a clean non-woven fabric can always be provided.

The 140-1st embodiment of the invention, as shown in FIG. 176(A), is a mask 101 for the novel coronavirus, etc., formed of plastic, covering the nose and mouth, having a chin pad at the chin area, and held to the chin by temple tips. The 140-2 embodiment of the invention is shown in FIG. 176(B) and is a mask 102 for the novel coronavirus and other viruses which is formed of plastic, covering the nose and mouth, without a chin rest, and held in place by temple tips 200. At the top of the side of the cheek, although the cheeks make contact with the temple tips 200 of this mask, there are gaps between the nose and mouth and the mask, so there is no contact with the mask. The 140-3 embodiment of the invention is shown in FIG. 176(C) and consists of a transparent part 403 at the top of the mask 101. The 140-4 embodiment of the invention is shown in FIG. 176(D) and consists of a transparent film 403 which is provided inside the mask 101 with a cushion 5 interposed therebetween. The 140-5 embodiment of the invention is shown in FIG. 176(E) wherein a cushion 5 is provided on the outside of the mask 101 and furthermore, a transparent film 403 is provided on the outside of the cushion. The 140-6 embodiment of the invention is shown in FIG. 176(E) wherein a cushion 5 is provided on the outside of the mask 101 and furthermore, a transparent film 403 is provided on the outside of the cushion. This constitution has the effect of providing a wide range of protection for the eyes from viruses and other droplets.

In the 141st embodiment of the invention, the nose cushion 502 is made thick enough not to interfere with wearing the invention with eyeglasses, as shown in FIG. 177. FIGS. 177(A) and 177(B) show a wearer who is not wearing eyeglasses and the cushion in FIG. 170(F) is a top view of the invention of embodiment 134. For individuals who are not wearing eyeglasses, the shape of the upper end of the mask 1 with the film transparent member 403 does not need to conform to the shape of the nose, and the shape of the nose cushion 502 can be changed to closely match the nose, but for a wearer who wears eyeglasses . . . [sic—incomplete sentence] If a film transparent member with a cushion is provided inside, the 502 nose-rest cushion will become much thicker, and the mask 1 covering the mouth and nose can be easily separated from the face, creating gaps. Therefore, a film transparent member 403 with a cushion 502 is provided on the outside of the mask 1 as shown in FIG. 177(D), and a nose fitting 1090 such as a wire is used to make the cushion conform to shape of the nose when worn. The nose cushion 502 should be thick enough to maintain the shape of the nose with the metal fitting and to allow the shape of the lower part of the film transparent member 403 to be deformed by the shape of the nose and to prevent adhesion of the cushion and the film transparent member 403 from peeling off. Specifically, when a mask 1 with metal fittings 1090 is used as shown in FIG. 177(D), the metal fitting 1090, which is shaped to conform to the shape of the nose, is fitted into the nose cushion 502 when worn, as shown in FIGS. 177(C) and (E), and the transparent film (film transparent member 403) outside the cushion does not form large waves or irregularities. The cushion 502 should be 10 to 30 mm thick to allow the nose part to be indented. About 20 mm is suitable. Transparent films of 100 or 75 microns in thickness are suitable. In addition to wire, the metal fitting to conform to the shape of the wearer's nose can also be plastic-type materials that are able to maintain their shape. Cushion thickness and hardware should be determined according to the ease of curvature of the transparent sheet. FIG. 177(f) is another example of the invention in which a cushion 502 is provided at the top of both the front and back sides of the mask 1, and a film transparent member 403 is bonded to the front of the cushion. In other words, a cushion 502 is also provided on the inside of the mask in FIG. 177(D) above, with a cushion 502 bonded to the top of both the outside and inside sides of mask 1. The cushion 502 on the outside of the mask is a thick cushion with the film transparent member 403 bonded to the outside, and the cushion 502 on the inside of the mask is a grooved cushion that conforms to the shape of the wearer's nose. FIGS. 177(D), (C), and (E) show the metal fitting 1090 on the mask 1. However, metal fitting can be provided on the cushion 502 and bonded to the mask 1, or as in FIG. 177(F), without the metal fitting 1090. In the 141st embodiment, the use of a thick cushion allows even a wearer who wears eyeglasses to use the invention without making contact with it, and also reduces the gap between the face and the invention.

The 142nd embodiment of the invention, as shown in FIG. 178, is an embodiment in which the transparent sheet with the head attachment is a film-like transparent member 403 which is curved when worn by a wearer, and when the wearer eats, the film-like transparent member 403 can be lifted upwards (see arrow). FIG. 178(A) shows the transparent sheet of the 9th embodiment (FIG. 15(B)) as a film transparent member 403 of about 100 microns in thickness. FIG. 178(A) shows the transparent sheet of the 9th embodiment (FIG. 15(B)) as a film transparent member 403 of about 100 microns in thickness. When worn, the chinstrap can be removed and the film transparent member 403 can be raised to convey food to the mouth. According to this 142nd embodiment, the effect is that the film transparent member 403 can be raised from below to convey food to the mouth while wearing the mask of this invention.

The 143rd embodiment of the invention is an example embodiment 142 (FIG. 178(A)) in which a plurality of transparent sheets 484 or film transparent members 403 are provided so that they partially overlap, as shown in FIG. 179. FIG. 179 (A) shows a front view of a cushion with two transparent members of, for example, 300 microns in thickness overlapping each other, and (B) shows a front view of a cushion with two transparent sheets of, for example, 300 microns at the right and left ends of the cushion 5 and a transparent member 403 of, for example, 100 microns in the center. The invention is secured to the head with an elastic band 6, and the transparent sheet and film transparent member are curved and overlapped without gaps to protect against coronavirus and other viral droplets. When eating, as shown by the arrow, the bottom edge of the film transparent member 403 is grasped, bent, and raised upward to convey the food to the mouth. The film transparent member 403 is not limited to 100 microns and can be 75 microns as a thin transparent member with a thickness of less than 100 microns. The effect of the 143rd embodiment in (A) is that either the side or bottom edge of the film transparent member 403 can be grasped for lifting when eating, and by changing the order of the overlap of the film transparent member 403, the mask be used by both right- and left-handed people. In (B), the side transparent sheets are about 300 microns thick, and when the mask is worn, the two transparent sheets 484 and the film transparent member 403 are curved, so there is no gap even though the respective transparent sheets and the film transparent member 403 are not joined in the front. This makes it easier to convey food to the mouth from the center.

The 144th embodiment of the invention is an has a film transparent member 403, as shown in FIG. 180, where the wearer's head contacting part is a non-curved sheet or rod-shaped transparent sheet support material 1060, where (A) is a front view in which the transparent sheet is a film transparent member 403 and a columnar or flat transparent sheet support material 1060 is used in place of the cushion 5. Since the transparent sheet support material 1060 does not bend, the film transparent member 403 is flat when the mask is worn, enabling the user to easily raise the film transparent member and convey food to the mouth. (B) is a front view of the film transparent member 403 joined to the transparent sheet support material 1060, with a folded transparent sheet 484 on the left and right sides of the wearer's face so that only the center part can be raised. The transparent sheet support material 1060 is a straight, flat panel 1 to 10 mm thick and 5 to 30 mm wide, or a round bar 3 to 10 mm in diameter. The material should be synthetic so as not to bend when the mask is worn on the wearer's head, and can be wood, plastic, metal, hard sponge, resin, etc. The head contact area should be protected with a soft material. In this 144th embodiment, the film transparent member 403 on the transparent sheet support material 1060 is flat, and the effect is that the film transparent member can be easily raised when the wearer eats while wearing the mask.

In the 145th embodiment of the invention as shown in FIG. 181, the head contacting part consists of a shallow-curved transparent sheet support and a cushion part. (A) is a front view of the film transparent member 403 bonded to the slightly curved sheet support 1060, with the transparent sheet bonded to the cushion on the left and right sides of the wearer's face, and (B) is a top view thereof. Only the center of the transparent sheet 484 is made of a film transparent member which is 100 microns in thickness and is bonded to the transparent sheet support material 1060 so that it partially overlaps the transparent sheet 484 on the left and right sides to which the cushions 59 are bonded. When the invention is worn by a user, the side transparent sheets are curved while the center transparent sheet remains flat and is not curved, so that the center transparent can be raised to convey food to the user's mouth. The width of the center transparent sheet and the side transparent sheets can be as needed.

The 146th embodiment of the invention as shown in FIG. 182 is an example having an opening with a film transparent member 403 at the bottom of the transparent sheet, and the head contacting part consists of a shallow-curved transparent sheet support and a cushion part with an indentation; (A) is a front view and (B) is a top view.

A transparent sheet 402 with an opening at the bottom is bonded to the center of the transparent sheet support material 1060, and a cushion part 514 which is indented to fit the shape of the wearer's forehead is bonded to the back of the transparent sheet support material. On both sides of the transparent sheet 402, a transparent sheet 486 which is bent into an L-shape is bonded to the transparent sheet support material 1060 so as to cover a portion of the side and front of the wearer when worn. A film transparent member 403 is attached with PSA adhesive tape or other means so as to cover the lower opening of the transparent sheet 402. When the invention is worn by a user, the transparent sheet 402 and the film transparent member 403 flatten out. Since the film transparent member 403 is only in the area corresponding to the wearer's mouth, the effect is that food can be easily raised and conveyed to the user's mouth. In addition, the cushioning that conforms to the shape of the wearer's forehead has the effect of making the transparent sheet support material 1060 less curved. Moreover, the transparent sheet 486 with its sides bent into an L-shape and the elastic band 6 connected to its sides has the effect of reducing the force that pulls the transparent sheet support material backward and causes it to curve when it is worn on the wearer's head.

In the 147th embodiment of the invention as shown in FIG. 183, the head fixture is in the form of an eyeglass frame with loops to support a transparent sheet 486 and a film transparent member 403. (A) is a front developed view of the transparent sheet; (B) is a perspective view of the transparent sheet bonded to an eyeglass frame 1070 with loops, and (C) is a top view thereof. PSA tape 95 is applied as double-sided adhesive to bond the transparent sheet to an eyeglass frame having temple tips, and as shown in (B), a transparent sheet 486 which covers a portion of the sides and front and a film transparent member 403 is overlaid thereon. The transparent sheet 486 has right-angled corners in accordance with the shape of the eyeglass frame. The product is put on by hooking it over the ears the temple tips, and when eating, the transparent film shade (film transparent member 403) can be raised to insert food or drink.

The 148th embodiment of the invention, as shown in FIG. 184, is characterized by the use of the hook 1080 in embodiment 147 (FIG. 183) to connect the eyeglass frames having temple tips to the transparent sheet and the film transparent member. (A) is a perspective view and (B) is a top view. As shown in (A), the temple tips of the eyeglass frame 1070 and hooks 1080 are turned away from the inside so that their tops do not injure the wearer's face are secured to the eyeglass frame 1070 which is in the center thereof. This allows easy attachment and removal of the transparent sheet 486 and film transparent member 403.

The 149th embodiment of the invention as shown in FIG. 185 uses the joining method in embodiment 148 in which holes are made in the upper part of the transparent sheet and hooks are passed through them. (A) is a front view of the deployed transparent sheet, (B) is a perspective view of the transparent sheet fixed to the eyeglass frame 1070 with the hooks, and (C) is a top view. The two holes 4861 on each side are sized to allow the temple tips of the eyeglass frame to pass through, and the distance between the two holes should be about 20 mm apart, since the transparent sheet 486 is about 300 microns. Furthermore, the transparent sheet 486 and the film transparent member 403 are joined at the upper overlapping portion by the transparent sheet connecting tape 49, so the film transparent member 403 will not fall off. This makes it possible to easily attach a transparent sheet or film transparent member to an eyeglass frame or other frame without damaging the eyeglass frame or other frame.

As shown in FIG. 186, the 150th embodiment of the invention is characterized by being provided with slits 4061 in the transparent sheet 406 with an opening at the bottom for attaching a mask, inserting the mask, and integrating it with the transparent sheet. A mask (e.g., a publicly-known mask made of non-woven fabric with ear loops) is inserted into the opening 4023 in the transparent sheet 406, which has an opening for mask attachment and through holes, and the ear loops of the mask are passed through the slits 4061 to integrate the mask and the transparent sheet 406. The transparent sheet 406 has the ear loops of the mask which pass through the slits 4061, so the mask it does not fall off and makes contact with the mask without forming gaps. A mask is then used to protect against infection by droplets from the mouth or nose, and a transparent sheet 406 is used to protect the wearer's eyes. The thickness of the transparent sheet 406 may be about 300 microns, or a thickness of about 100 microns to render it bendable. The width of the transparent sheet should be about the width of the face so as not to interfere with placing the ear loops of the mask over the wearer's ears. The opening 4023 in the transparent sheet should be narrower than the width of the mask so that the transparent sheet and the mask overlap. The size and position of the aperture should be such that the top edge of the aperture also overlaps the transparent sheet and the top of the mask. The overlap should be about 5˜10 mm. The slits 4061 should be wide enough to allow the mask ear loops to pass through and should be provided so that the mask fits into the opening for the transparent sheet. To integrate the components, the mask is lined up inside of the transparent sheet 406 and inserted into the slits on the left and right sides thereof. The position of the mask is aligned with the position of the opening in the transparent sheet, and the ear loops are disposed on the outside of the transparent sheet and attached to the wearer's ears. This allows the mask to be integrated with publicy-known masks without the use of adhesives or extra tools, and has the advantages of being low in cost, portable, and disposable.

The 151st embodiment of the invention, as shown in FIG. 187, is an example in which the head attachment is an eyeglass frame with a temple tips, a curved, transparent sheet 4 of about 300 microns in thickness having an opening in the lower center thereof, and a film transparent member 403. (A) and (B) perspective views and (C) is a top view. By securing the sides of the transparent sheet 4 with the film transparent member 403 in the center to the temple tips of the eyeglass frame 1070, the transparent sheet is curved all the way around. (A) is a film transparent member 403 bonded to the top of the transparent sheet with transparent adhesive tape 49, and (B) is bonded about half the height from the bottom of the transparent sheet. For example, if the film transparent member 403 is about 50-100 microns and is, for example, about 75 microns in thickness, the entire transparent sheet is curved, so when the film transparent member 403 is lifted as indicated by the arrow, it can either be raised halfway and returned to its original position, or the film can be bent and stuck onto the upper transparent sheet without returning it to its original position, depending on how the film is raised. The overlap between the film transparent member 403 and the transparent sheet 4 is 5 to 20 mm, with 10 mm being suitable. The width of the transparent adhesive tape 49 should be 15-20 mm. The amount of overlap should be as small as possible to avoid double overlap, since double overlap reduces visibility. If the amount of overlap is too small, a gap will form between the film transparent member 403 and the transparent sheet 4, and droplets cannot be prevented. This invention has the effect of making it easier to convey food to the mouth at mealtimes. In (D), the head attachment is a single elastic band. A transparent sheet of 4 about 300 microns in thickness with a cushion 5 which is provided with an opening is provided with a film transparent member 403, which is connected with transparent PSA tape 4024 or other connection device and curved for use when worn. When the film transparent member 403 is raised during mealtime, the film transparent member 403 becomes unitized with the upper part of the transparent sheet 4 due to its curvature, and an opening can be created without having to hold it with the hand.

The 152nd embodiment of the invention is characterized by the fact that it can be rolled up and carried as a scroll, as shown in FIG. 188. (A) is a film transparent member 403 of about 100 microns in thickness with a cushion 5 and an elastic band 6 at the top thereof, which is the head contact area, and rolled up like a scroll with the cushion 5 as indicated by the arrow. The thickness of the film transparent member 403 should be 50-100 microns, which is the thickness that can be rolled. (B) is a cross-sectional view from the side when it is rolled up 264, and the mask can be inserted into the cylindrical case 264 as indicated by the arrow for the unique effect of being convenient for carrying. To make the mask ultra-light and round, the size of the film transparent member 403 should be B5 size disposed horizontally or A4 size disposed horizontally, the cushion 5 should be small, for example, 10 mm thick and 15 mm wide, and the elastic band 6 should also be 10 mm wide and 0.5 to 1 mm in thickness. The product is the lightest in the world at 8.9 grams, making it very light and portable. The sizes of the film transparent member 403, cushion 5, and elastic band 6 are not limited to the above, but any form in which the cushion can be rolled into a scroll-like shape around its axis is included in the scope of this invention. (C) is the invention in (A) with the male and female hook and loop fasteners 8 on the lower side of the film transparent member 403, separated by a distance of one film lap when rolled up. (D) is a cross-sectional view of the inventive product in (C) rolled up, with the hook and loop fastener 8 attached, and since it can be secured with the hook and loop fastener 8, it does not come apart and does not require a case, making it portable. (E) is the invention wrapped up and fastened with removable PSA tape 96 made of tetrafluoroethylene resin, which when rolled up is used as a clasp as shown in (F). It can also be separated and used as a clasp by attaching removable PSA tape 96 made of tetrafluoroethylene resin on a fingertip, from the nail to the pad of the finger, as shown in (G). When pressing a telephone button, for example, by touching the fingertip with the tetrafluoroethylene resin tape 96 affixed thereto, viruses such as the new coronavirus do not adhere to the fingertip, and the mask and the tape protect against both airborne and contact infection. The PSA tape mentioned above can be a sheet containing copper in addition to tetrafluoroethylene, and in this case the virus disappears in about two weeks. The objects that are used to wrap and hold the rolled-up invention may be elastic bands, string, other PSA tape, cellophane tape, etc., not limited to the hook and loop fasteners 8 or the tetrafluoroethylene resin removable tape 86. According to this 152nd embodiment, the product is rolled into a scroll shape, making it very convenient to carry, lightweight, and disposable. In addition, the product can be used in the GoTo Travel campaign and can be manufactured inexpensively enough to be distributed free of charge for airplanes, bullet trains, and by travel agencies, etc.

The 153rd embodiment of the invention, as shown in FIG. 189, is characterized in that the head attachment is a plastic or resin formed head attachment frame 69, and the transparent sheet 4 is attached to the head attachment in a removable manner. As shown in (A), the transparent sheet 4 is connected to a plastic head-mounting frame 69 via a hole 407 for supporting the head, which is the transparent sheet attachment part. The head-mounting frame 69 is not secured to the back of the head as in other examples but is either worn over the ears while it clasps the head from both sides or is wrapped around to the back of the head. As shown in (B), a protruding transparent sheet attachment portion 691 of the plastic head-mounting frame 69 is inserted into the hole 407 in the transparent sheet 4, and the transparent sheet 4 is secured thereby. In the 153rd embodiment, the transparent sheet can be easily replaced, and the wearing the mask is simple and it is lightweight.

The 154th embodiment of the invention, as shown in FIG. 190 and FIG. 29, is an invention characterized by having a film transparent member 403 connected to a breathing portion made of non-woven fabric, cloth, etc., which is attached to the ears, etc., with an elastic band or string on the mask, and those parts of the mask which make contact with the lips and face are remade of a cosmetics-resistant material such as ethylene tetrafluoride or the like. FIG. 190(A) is an unfolded back view of the inside (face-contacting side) of the mask 1, which is attached to the ears by a string, elastic, or ear-hooks 2 so as to cover the mouth and nose. The lips portion of the mask 1 is adhered with, for example, pressure-sensitive adhesive, e.g., 25 mm wide and 70 mm long tetrafluoroethylene (PTFE) tape, in the center portion of the mask 1 where the lips make contact, and the film transparent member 403 is bonded to the outer top of the mask 1 via a cushion 502. FIG. 190(B) shows the partial adhesion of tetrafluoroethylene (PTFE) tape 1100 and 1101 to the center portion of mask 1 and to the outer periphery of the mask where the forehead, cheeks, nose, chin, and other facial features come into contact therewith. FIG. 190(C) shows tetrafluoroethylene or similar tape 1102 applied to the center portion of the mask 1 where the upper and lower lips come into contact with the mask. FIG. 190(D) shows heart-shaped tetrafluoroethylene tape 1103 applied to the center of the mask 1. FIG. 190(e) shows tetrafluoroethylene PSA tape 1104, which is nearly as long as the width of the mask, applied to the center of the mask 1. By doing so, not only does lipstick not stick to the mask, but when the mask is reversed and used as an eye mask, the tetrafluoroethylene PSA tape section is at the wearer's eye level, so even a mask that is not light-shielding becomes light-shielding and can be used as an eye mask. The film transparent member 403 can also serve as a transparent sheet 4. This has the effect of protecting the wearer's mouth, nose, and eyes from viruses by means of the mask and the film transparent member, while the mask is sanitary and free from lipstick, etc., and the mask itself can be used multiple times instead of being disposed of. Furthermore, (B) has the effect that women's makeup and foundation do not adhere to the mask, so even if they are wearing makeup, the makeup does not peel off and they can wear the mask with peace of mind; (C) has the effect that breathing is easy because breathing is possible through the gap between the two tetrafluoroethylene tapes, and the two tapes are comfortable and free of dirt caused by adhesion because they contact the lips in an open state (breathing); and (D) has the effect of making the mask heart-shaped so women like to wear it.

The 155th embodiment of the invention, as shown in FIGS. 191 and 192, is an invention in which a transparent film 403 is joined to the top of a mask 1, for example, a mask that is breathable, made of non-woven fabric, cloth, or the like, through a cushion 502 or something thicker than the length of the nose, so that when worn, the nose extends over the top of the mask 1 and is positioned over a thick cushion 502 and a transparent sheet film covers the wearer's nose and eyes. FIG. 191 is a side cross-sectional view showing that by making the cushion thick when worn, as shown in FIG. 177(C) of Example 141, the transparent film 403 is positioned away from the face so that eyeglasses can also be worn, and the cushion 502 is thick enough that the transparent film 403 and eyeglasses 1050 do come into contact with each other. FIG. 192 shows a side cross-sectional view of the mask with a thick cushion 502, which is thicker than the length of the nose, with the nose positioned on the cushion above the mask 1, and the transparent film 403 covering the nose and other parts of the face. The thickness of the cushion 502 that does not contact the transparent film 403 on the nose, with the thickness of the cushion 502 being 10 mm or more, such as 30 mm, and the width being 5 to 30 mm, for example 10 mm, so that it does not cover the mouth position. This has the effect that the cushion and transparent film expel exhaled air and keep the virus out. The transparent film 403 can also serve as a transparent sheet 4.

The 156-1st embodiment of the invention is shown in FIG. 193(A), which is a side cross-sectional view of the invention when worn, in which a transparent film 403 is provided under a mask 100 having a light-shielding party consisting of non-woven fabric, cloth, or the like and an elastic band or string for the ears, and the transparent film 403 is placed in front of the mouth to serve as an eye mask.

FIG. 193(B) illustrates embodiment 156-2. This is an unfolded back view of a mask 1 with inadequate light shielding properties such as cloth, etc., with material such as tetrafluoroethylene, etc. 1104, that does not adhere to makeup such as lipstick, etc., and provided in the center of the mask almost horizontally. FIG. 193(C), a side cross-sectional view, shows the mask as worn. Since the cosmetic non-attachment part 1104 is positioned in front of the eyes, light does not enter the eyes and the mask does not need to be light-shielding. An embodiment of the invention 156-3 is shown in FIG. 193(d) in a side cross-sectional view. The mask in FIG. 193(B) is used as a face shield mask by inverting it. The mask 1 portion may be placed over the wearer's mouth and nose, the transparent film 403 may be placed in front of the eyes, the ear strings 2 may be placed over the ears, and the wire of the mask 100 may be used to fit the mask to the shape of the wearer's nose. This invention provides protection from coronaviruses for the eyes, mouth, and nose, and the transparent film 403 can be used as a fog-free face shield mask, doubling its utility. The transparent film 403 can also be installed with a cushion disposed therebetween.

According to embodiments 156-1, -2, and -3, the mask can be used as an eye mask to block out light for a good night's sleep, and as a face shield mask when not in use to protect the eyes, mouth, and nose from virus droplets.

The film transparent member 403 described in embodiments 133 to 156 (FIG. 168, etc.) can be made into a film transparent 404 in an integrated form that is combined with and secured to the mask in embodiment 132 (FIG. 167, etc.). Specifically, the film transparent member 403 is a form that is removably bonded using for example removable PSA tape, and the film transparent 404 is an integrated form that is bonded and secured to a mask, for example, using permanent PSA tape.

In the 157th embodiment of the invention, the head attachment is made by extending one side of the upper portion of the transparent sheet to form a strap and extending the upper portion of the opposite side to form two straps, each of which has holes for insertion of the straps. One of the straps is for forehead support and the other is for attaching the transparent sheet to the head, and a hole is provided in the other side of the strap for inserting the upper strap, and a hole is provided in the upper opposite end of the transparent sheet for inserting the lower strap.

For reference, Table 1 shows the general relationship between the claims and drawings.

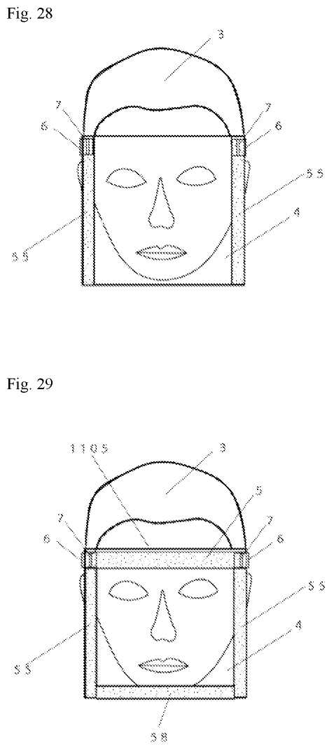

TABLE 1

| Claim number | Drawing number |
|---|---|
| Claim 1 | FIGS. 2~5, 60, etc. |
| Claim 2 | FIGS. 2~5, 60, etc. |
| Claim 3 | FIGS. 2~5, 9, 50, etc. |
| Claim 4 | FIGS. 28, 29, 30~34, etc. |
| Claim 5 | FIGS. 13, 15, 16, 183, 189, etc. |
| Claim 6 | FIGS. 2~5, etc. |
| Claim 7 | FIGS. 15~17, 19~27, 54~56, etc. |
| Claim 8 | FIGS. 4~7, 18, etc. |
| Claim 9 | FIGS. 9, 164, etc. |
| Claim 10 | FIG. 34, etc. |
| Claim 11 | FIGS. 12, 13, 14, 28, 29, 33, 51, etc. |
| Claim 12 | FIGS. 12, 13, 14, 29, 76, etc. |
| Claim 13 | FIG. 53, etc. |
| Claim 14 | FIGS. 43, 44, 61~62, 125, etc. |
| Claim 15 | FIG. 62, etc. |
| Claim 16 | FIGS. 176(A), etc., (E) |
| Claim 17 | FIGS. 175(C)~(F), etc. |
| Claim 18 | FIG. 17, etc. |
| Claim 19 | FIGS. 2~6, 18~27, etc. |
| Claim 20 | FIG. 19, etc. |
| Claim 21 | FIGS. 18~27, etc. |
| Claim 22 | FIGS. 18~27, etc. |
| Claim 23 | FIGS. 35~39, etc. |
| Claim 24 | FIGS. 40~42, etc. |
| Claim 25 | FIGS. 57~58, 59, etc. |
| Claim 26 | FIG. 60, etc. |
| Claim 27 | FIGS. 64~75, etc. |
| Claim 28 | FIGS. 64~66, etc. |
| Claim 29 | FIGS. 67~72, etc. |
| Claim 30 | FIG. 69, etc. |
| Claim 31 | FIGS. 67, 68, etc. |
| Claim 32 | FIGS. 67~72, etc. |
| Claim 33 | FIGS. 67~74, etc. |
| Claim 34 | FIGS. 178~185, 63, 159, etc. |
| Claim 35 | FIG. 74 |
| Claim 36 | FIGS. 69, 70, etc. |
| Claim 37 | FIG. 73, etc. |
| Claim 38 | FIGS. 77~98, 162~164, etc. |
| Claim 39 | FIGS. 11, 99, 116, 117, 121, 125, |
| | 148, 165, 166, 168, 170, etc. |
| Claim 40 | FIGS. 8, 28, 129, etc. |
| Claim 41 | FIGS. 101~106, etc. |
| Claim 42 | FIGS. 108~125, 178, etc. |
| Claim 43 | FIGS. 107, 122~125, 133~136, etc. |
| Claim 44 | FIGS. 126~132, 137, etc.. |
| Claim 45 | FIGS. 107, 135, 136, etc. |
| Claim 46 | FIGS. 138~150, etc. |
| Claim 47 | FIGS. 4, 144~148, etc. |
| Claim 48 | FIGS. 146, 147 |
| Claim 49 | FIGS. 149, 150 |
| Claim 50 | FIGS. 151~153 |
| Claim 51 | FIGS. 166, 155, 156 |
| Claim 52 | FIG. 158 |
| Claim 53 | FIG. (embodiment 158) |
| Claim 54 | Embodiment 164 |
| Claim 55 | FIGS. 167~177, 190~192 |
| Claim 56 | FIG. 171, etc. |
| Claim 57 | FIGS. 171, etc. |
| Claim 58 | FIGS. 191, 167~177, etc. |
| Claim 59 | FIGS. 171, etc. |
| Claim 60 | FIGS. 171, etc. |
| Claim 61 | FIGS. 186, etc. |
| Claim 62 | FIGS. 179~185, 187, etc. |
| Claim 63 | FIGS. 179~185, 187, etc. |
| Claim 64 | FIGS. 188, etc. |
| Claim 65 | FIGS. 174, 175, etc. |
| Claim 66 | FIG. 190, etc. |
| Claim 67 | FIG. 192, etc. |
| Claim 68 | FIGS. 190~193 |

As described above, this invention can completely block viruses and bacteria, cover the eyes, face, and mouth, and is lightweight, low in cost, easy to store, etc., and does not require much effort to transport.

### INDUSTRIAL APPLICABILITY

This invention completely blocks the novel coronavirus, which has spread worldwide and become a major issue, as well as bacteria, including blocking their entry into the eyes; it also allows people to speak clearly while wearing the mask; it does not fog eyeglasses; and moreover it presents no obstacles to industry or producers, and therefore has very significant industrial applicability.

### BRIEF DESCRIPTION OF SYMBOLS

1 Publicly-known mask
100 Light-shielding and breathable portion
101 Mask with chin rest and ear straps
102 Mask without chin rest and with ear straps
2 Ear loops
200 Temple tip
3 Head
301 Nose
302 Eyes
303 Finger
31 Ears
4 Transparent sheet
401 Folded transparent sheet
402 Transparent sheet with an openable/closeable portion
4021 Transparent cover that opens and closes
4022 Grips at both lower ends of transparent lid
4023 Opening part
4024 Hinge made of transparent PSA tape, etc.
4025 Transparent sheet door that rotates to open and close
4026 Pivoting fulcrum
4027 Transparent sheet door that slides open and closed
4028 Sliding pin and pin guide
403 Film transparent member
404 Film transparent member integrated with mask
405 Film transparent member with V-shaped or non-linear top edge
406 Transparent sheet with aperture for mask attachment and through hole
4061 Through hole for mask
407 Support hole for transparent sheet
41 Side of transparent sheet
42 Lower part of transparent sheet
43 Transparent sheet for small infants, such as B6
44 Transparent sheet with rounded corners
45 Transparent sheet in A4 or B4 size vertically, for example
46 Folded transparent sheet 1, e.g., transparent sheet for face
461 Widening of the curvature of a transparent sheet when the transparent sheet is mounted normally
47 Folding transparent sheet 2 (e.g., transparent sheet for head)
48 A4 horizontal transparent sheet
481 A4 transparent sheet in horizontal direction, with the transparent sheet split in two at the halfway point
482 A4 transparent sheet in horizontal direction, with the transparent sheet split in two at the halfway point then divided into 4 parts
483 A4 transparent sheet divided vertically at the halfway point horizontally and then in thirds to form six parts
484 A4 transparent sheet divided lengthwise into quarters or thirds to form four or three sections
485 Transparent sheet with a shorter length in the vertical direction
486 Transparent sheet bent in an L-shape to cover a part of the side and front of the wearer's face
4861 Holes in the transparent sheet through which the eyeglass frame's temple points pass
49 Transparent sheet joint, such as polyester, transparent PSA tape, etc., at the junction of two transparent sheets
5 Cushion part
501 Thick cushion part of nose pad
502 Cushion part for nose pad
51 Cushion material
511 Slit in cushion
512 Nose-shaped indentation (cut) in nasal pad cushion
513 Slope (may be long)
514 Indentation in forehead cushion
515 Cushion made of non-woven or other soft fabric
52 Adhesive
53 Horizontal left cushion
54 Horizontal right cushion
55 Vertical side cushion part
551 Sloped cushion part for vertical side
552 Cushion for chin rest
553 Vertical side cushion part with chin rest
554 Large sloped vertical side cushion part
56 Cushion material
57 Adhesive
58 Lower cushion part
59 Wide cushion part (head cushion)
591 Cushion for holding cold or warm material
592 Bottom holding section to prevent falling of cooling or warming material
593 Thick cushion for lens such as Fresnel lens
5931 Recessed portion for lens
594 Cushion for head or face contact with sloped ends
595 Small cushion part with a sloped end at the length of each of the divided transparent sheets
596 Right-angled triangular-shaped small cushion part
6 Elastic band
6R Elastic band (right)
6L Elastic band (left)
61 Loop-shaped elastic band
62 Elastic band 6 pulled out through length adjuster slit 641
63 Strap string
64 Length-adjusting device for fitting straps (base sheet such as urethane)
641 Slit in base sheet 64
65 Anti-fraying tape
66 Double-sided tape
67 Strap for narrowing curvature (chinstrap)
671 Strap for narrowing curvature (chinstrap) provided horizontally
672 Neck strap
68 Plastic band
69 Plastic or plastic head-mounting frame
691 Transparent sheet connection (adhesive part)
7 Staple (staple)
71 Staple head
72 Staple point
73 Crimped side of rivet
8 Hook and loop fastener, e.g. Velcro (registered trademark)
81 Adhesive for hook and loop fastener (Velcro (registered trademark))
10 Transparent bag
11 Hole
111 Round hole
112 Rhomboid hole
12 Adhesive on transparent sheet 4
13 Adhesive tape on transparent sheet 4
14 Hat, etc.
141 Brim of a hat
15 Heat generated from the face due to body heat
151 Heat reflected by plasma tape or aluminum tape
16 Breathing
161 Exhaled air flow
162 Flow of outside air
162-1 Flow toward the chin
162-2 Flow toward transparent sheet 4
162-3 Flow toward lower cushion 58
163 Moisture from the nose
164 Moisture from mouth
17 LEDs
18 Battery
181 Switch
19 Wiring
20 Reflector, reflective material, reflective tape or phosphorescent material
21 Safety hem
22 Plasma tape material or aluminum tape material
221 Booster (e.g. plasma tape laminated with glass cloth and aluminum)
222 Booster to connect two transparent sheets (connecting tape with silver surface and white reverse side)
23 Rubber or plastic support
24 Voice
25 Space formed between the transparent sheet 4 and the face
26 Packaging bag
261 Storage case
262 Strap of the storage case
263 Protruding portion of case
264 Cylindrical case
27 Protective sheet
271 Protective sheet
28 Reinforcing sheet
29 Peltier element device
291 Peltier element
292 Low temperature side
293 High-temperature side heat-dissipating fins
30 Tetrafluoroethylene or polyimide or polyester PSA, etc., tape, etc., fittings
32 Cup
33 Paper, etc. to be stored
34 Shielding, such as paper, filter, cloth, etc.
341 Opaque light shielding, e.g., paper
342 Filter that blocks passage of ultraviolet rays
343 Filter that does not block passage of infrared rays
344 Cloth such as a veil
345 Paper masks with holes for eyes
35 Shade for parasols (e.g., cloth or paper)
36 Brand labels
37 Bags (e.g., non-woven bags, plastic bags, etc.) for cooling or warming materials, storage of items, etc.
371 Zippers and other closures of bags for cold storage materials
372 Double-sided adhesive tape for securing bag containing cooling material
373 Opening for inserting cooling materials
38 Cooling materials, etc.
39 Head contact temperature moderator such as tetrafluoroethylene
391 Foam or other head contact temperature moderating material
90 Lens such as Fresnel lens
901 Fixture (lens arm) for Fresnel lens
902 Adhesive tape for mounting Fresnel lens, etc.
91 Medical scope
911 Scope straps (headgear) or ear-hooks
92 Joined by heat sealing, etc.
921 Glue joint for joining by heat sealing, etc.
93 Mouth of a bag made of N95 or other filter
931 Glue joint for bonding to transparent sheet
932 Glue joint for bonding to chin strap
94 Removable PSA tape
941 Removable medical PSA double-sided tape
942 Removable medical PSA single-sided tape
943 Removable adhesive section with liner
9431 Permanent PSA
9432 Carrier for double-sided tape
9433 Removable or permanent PSA tape
9434 Release liner
944 Cushioning adhesive (with liner)
9441 Release liner
95 PSA tape
96 Removable PSA tape of tetrafluoroethylene resin
1000 Bib-shaped sheet (materials include vinyl sheet, fabric wrap, non-woven fabric, N95 filter, etc.)
1067 Under-the-chin filter
1094 Non-woven bag for N95 or other filter
1095 N95 filter
1002 Air-impermeable vinyl or other sheet or non-woven fabric
1010 Horseshoe-shaped frame (e.g., plastic)
1020 Nose sheet (transparent, opaque, or translucent, made of impermeable materials such as nylon, plastic, PE, PP, etc., or permeable materials such as filters, nonwoven fabrics, pieces of cloth, N95 filter, etc.)
1030 Cold absorbent sheet or other sheet
1040 Nose spring
1050 Lens
1060 Cylindrical or flat low-curved transparent sheet support material
1070 Eyeglass frame with hinges
1080 Hook
1090 Wire or other nose fitting
1100 Tetrafluoroethylene PSA tape or other cosmetic non-adhering part
1101 Tetrafluoroethylene PSA tape or other tape on the periphery of the mask
1102 Tetrafluoroethylene tape, etc. in the vicinity of the upper and lower lips of the wearer
1103 Heart-shaped tetrafluoroethylene tape
1104 Tetrafluoroethylene tapes as long as the mask width
1105 Tetrafluoroethylene tapes on the cushion around the mask

1-68. (canceled)

69. A mask for the novel coronavirus, comprising:
a transparent sheet with a head holder,
which has no slit, grooves and recesses,
in order that the air between the transparent sheet and human face does not escape,
wherein the transparent sheet is flattened after carrying and storing.

70. A mask for the novel coronavirus, comprising:
a transparent sheet to cover eyes only or eyes, nose, and mouth, and/or foldable vertically;
a filter such as N95 attached to a bottom end of the above transparent sheet, or a non-woven fabric mask attached to a bottom end of the above transparent sheet, or inside of a down portion of the transparent sheet; and
a head holder attached to the transparent sheet, or the non-woven fabric mask.

71. A mask for the novel coronavirus, comprising:
a mask with a transparent sheet configured to cover nose, mouth and eyes,
connected to a filter including N95 or a mask made by non-woven fabric; and
a head holder provided proximate to the mask made by non-woven fabric or the transparent sheet.

72. A mask for the novel coronavirus, comprising:
a head holder including a transparent band that extends from a transparent sheet,
or an eyeglass-shaped frame with temple tips,
or a rubber band,
or a plastic or metal ring,
or a rubber band fixed to the transparent sheet with rivets or staples.

73. A mask for the novel coronavirus, comprising:
a head holder;
a transparent sheet, with a structure that increases temperature, humidity, and pressure in a space between the transparent sheet and the face, by attaching cushions at both side of the transparent sheet or by using a reinforcing materials configured by bending both side edges of the transparent sheet; and
a strap including a filter provided at lower corners of the transparent sheet on left and right sides of the transparent sheet, which maintains a predetermined distance between the face and the corners of the transparent sheet.

74. The mask of claim 69, further comprising:
heat-reflective materials comprising plasma tape or aluminum provided on the transparent sheets, and that reflects the body temperature of the face, and increases the temperature of the space between the transparent sheet and the face.

75. A mask for the novel coronavirus, comprising:
a transparent gear covering the nose and mouth; and
a lower part of the transparent gear configured to hold over the chin with a rubber band attach to the ears.

76. The mask of claim 69, further comprising:
a cushion with a V-shaped groove that conforms to the shape of the nose provided in the center of the transparent sheet.

77. The mask of claim 69, further comprising:
a forehead pad cushion whose length is shorter than a width of transparent sheet, or
a forehead pad cushion with an edge shape that is slanted.

78. A mask for the novel coronavirus, comprising:
a head holder formed by extending one side of an upper portion of a transparent sheet to form a first strap and extending an upper portion of another side of the transparent sheet to form a second strap,
wherein the first strap and second straps include holes to connect the first and second straps.

79. The mask of claim 69, further comprising:
a Peltier element, LED, cooling material, warming material, light material, and light reflective material, battery, switch, connecting wiring, and/or Fresnel lens.

80. A mask for the novel coronavirus, comprising:
an adhesive portion provided on a transparent sheet,
wherein the adhesive portion is configured to bond the transparent sheet to a brim or sides of a hat, so that the hat becomes a head holder.

81. A mask for the novel coronavirus, comprising:
a transparent bag with a hole in a back portion of the transparent bag, which makes it possible to breathe and exhaled carbon dioxide gas, and
wherein a bottom of the transparent bag is configured as a head holder

82. A mask for the novel coronavirus, comprising:
a transparent or a non-transparent film or a filter,
which covers nose and mouth, and
a gear attach to head or ear or nose.

83. The mask of claim 69,
wherein
the transparent sheet is foldable vertically or horizontally,
or a part of the transparent sheet is opened and closed with respect to the face,
or the entire transparent sheet is lifted with respect to the face to enable eating and configuring as a umbrella.

84. The method of using a mask for the novel coronavirus, comprising:
moving a transparent sheet configured on a head holder from an up position to a down position for proving as an eye mask; and
moving the transparent sheet configured on the head holder from the down position to the up position for eating and configuring as an umbrella.

85. The mask in claim 69, wherein the transparent sheet is bent and attached on the head or on the face with a space between the transparent sheet and the face, which is heated by body temperature of the face, breath, or sunlight, and
the temperature, humidity, and air pressure in this space are increased to prevent viruses and bacteria from entering from a bottom or sides of the mask.
